(19) United States
(12) Patent Application Publication
(10) Pub. No.: US 2026/0322832 A1
(43) Pub. Date: Oct. 15, 2026

(54) INTELLIGENT SEARCH NETWORK FOR DETECTION OF COMPROMISED NETWORK ENTITIES

(71) Applicant: Altana Technologies, Inc., Brooklyn, NY (US)

(72) Inventors: Evan Smith, New York, NY (US); Peter Swartz, New York, NY (US); Ian Cadieu, Stamford, CT (US); Vipul Pavan Gagrani, San Jose, CA (US); Arun Nemani, Potomac, MD (US); Christian Donnerer, London (GB)

(73) Assignee: Altana Technologies, Inc., Brooklyn, NY (US)

(21) Appl. No.: 19/647,785

(22) Filed: Apr. 14, 2026

Related U.S. Application Data
(60) Provisional application No. 63/789,254, filed on Apr. 15, 2025.

(51) Int. Cl. H04L 9/40

(52) U.S. Cl. CPC H04L 63/1416; H04L 63/1425

(57) ABSTRACT

Techniques are described for detecting compromised nodes in a computing device network using graph-based analysis of network relationships. A network graph stores nodes representing entities and edges representing network operations, each edge including a corresponding operation risk score. Attributes associated with an entity and risk scores of edges connected to the entity's node are aggregated to produce a composite network operation risk score. A model is executed using the entity attributes and the composite risk score to generate an entity risk score. As new network operations occur, new edges and associated risk scores are added to the graph and the composite risk score and entity risk score are updated. When an updated entity risk score exceeds a threshold, an alert is generated identifying the corresponding node as a potentially compromised network node.

### CROSS-REFERENCE TO RELATED APPLICATIONS

This application claims the benefit of priority U.S. Provisional Patent Application No. 63/789,254, filed Apr. 15, 2025, the entirety of which is incorporated by reference herein.

### BACKGROUND

Network vulnerability detection is an important security practice and may involve analyzing network operations performed across a network. The process can help identify potential security weaknesses that attackers might exploit. Such operations may also reveal the unauthorized transport of items between nodes of the network. A computer system may then use this information to initiate countermeasures that address these vulnerabilities, such as by isolating the affected network operation to prevent the threat from spreading.

### SUMMARY

Modern network environments are confronted with increasingly sophisticated threats, as malicious actors exploit the complexity and scale of legitimate network traffic to disguise illicit operations. Conventional security approaches that analyze network operations in isolation often lack the contextual awareness required to detect subtle and coordinated patterns of suspicious activity, resulting in both an overabundance of false positives and a failure to identify operations that have been deliberately structured to evade detection. Compounding this challenge, network operations frequently include unstructured data, such as text descriptions, which may contain critical indicators of compromise. However, existing security computing systems often struggle to extract actionable insights from such unstructured information and correlate it with the structured relationship data that defines network connectivity, leading to significant analytical blind spots that can be exploited by malicious actors.

The systems and methods described herein address these technical deficiencies by employing a graph-based approach that evaluates the relational context of network operations between nodes, enabling the identification of multi-hop relationships and complex patterns that are not discernible through operation-level analysis alone. In addition, the computer system leverages natural language processing techniques to convert unstructured text descriptions into mathematical embeddings, which are analyzed in conjunction with structural network data using an ensemble of models. This integrated analysis facilitates the detection of linguistic and relational patterns indicative of compromised operations. Based on the risk scores generated by these models, the system can automatically restrict or halt network operations deemed likely to be compromised, by transmitting control messages to relevant computing devices. This immediate, automated intervention capability reduces the window of vulnerability and enhances the effectiveness of network security by preventing the completion of malicious operations in real time.

At least one aspect relates to a system. The system can detect compromised network operations in a computing device network based on edges between nodes of the computing device network. The system can include one or more processors. The system can include one or more non-transitory computer-readable media storing instructions. The instructions, when executed by the one or more processors, can cause the system to receive a request comprising an identification of a network operation between an entity of a source node and an entity of a destination node. The network operation can comprise a transfer of one or more networked items from the entity of the source node to the entity of the destination node, and the request can comprise a text description of the one or more networked items and/or the entity of the source node and/or the entity of the destination node. The system can identify one or more sub-graph data structures of nodes corresponding to the source node or the destination node from a network graph data structure. The system can query one or more edges of the sub-graph data structures to identify nodes connected to the source and destination nodes. The system can retrieve node data from the source node, destination node, and connected nodes. The system can generate an embedding of the text description using a model. The system can execute one or more models using the embedding and node data to generate a network operation risk score. The system can restrict the network operation by transmitting a message to the computing device when the risk score exceeds a threshold.

In some implementations, the system can generate the embedding using a transformer-based neural network model comprising multiple attention layers. In some implementations, the system can train the transformer-based neural network model on labeled network operation descriptions to produce semantic representations in a fixed-dimensional feature space.

In some implementations, the system can retrieve historical network operation data for the source node and the destination node from the network graph data structure. In some implementations, the system can incorporate the historical network operation data into the node data used by the one or more models to generate the network operation risk score.

In some implementations, the system can execute a deterministic rule-based classifier configured to compare identifiers of the source node and destination node against a restricted agent list stored in a lookup table. In some implementations, the system can increase the network operation risk score by applying a predefined weight adjustment if a match is detected.

In some implementations, the system can generate a multi-dimensional feature vector comprising the embedding and node data attributes including geographic location, network operation history, and node connectivity metrics. In some implementations, the system can execute a classification model using the multi-dimensional feature vector to generate the network operation risk score.

In some implementations, the system can identify multi-hop relationships between the source node and the destination node. In some implementations, the system can retrieve metadata from intermediary nodes of the multi-hop relationships. In some implementations, the system can include the metadata in the node data used to generate the network operation risk score.

In some implementations, the system can determine whether the entity of the source node or the entity of the destination node has previously participated in a compromised network operation. In some implementations, the system can modify the network operation risk score based on the previous participation.

At least one other aspect relates to a method. The method can be performed, for example, by one or more processors coupled to non-transitory memory. The method can include receiving a request comprising an identification of a network operation between an entity of a source node and an entity of a destination node, the network operation comprising a transfer of one or more networked items from the entity of the source node to the entity of the destination node and the request comprising a text description of the one or more networked items or the entity of the source node or the entity of the destination node. The method can include identifying one or more sub-graph data structures of nodes each corresponding to the source node or the destination node and connected by a set of edges from a plurality of sub-graph data structures stored in a network graph data structure, the network graph data structure comprising a graph data structure storing a network of nodes and edges between the network of nodes digitally representing types of relationships between entities represented by the network of nodes. The method can include querying one or more edges of each of the one or more sub-graph data structures of nodes to identify a first one or more nodes connected by edges with the source node and a second one or more nodes connected by edges with the destination node. The method can include identifying node data from each of the source node, the destination node, and each of the first and second one or more nodes. The method can include generating an embedding of the text description of the one or more networked items or the entity of the source node or the entity of the destination node using a model. The method can include executing one or more models using the embedding and the node data to generate a network operation risk score for the network operation. The method can include, responsive to determining the network operation is compromised based on the network operation risk score exceeding a threshold, restricting the network operation by transmitting a message to the computing device.

In some implementations, the method can include generating the embedding of the text description using a transformer-based neural network model trained on network operation descriptions. In some implementations, the transformer-based neural network model comprises multiple attention layers and is trained on labeled network operation descriptions to produce semantic representations in a fixed-dimensional feature space.

In some implementations, the method can include retrieving historical network operation data for the source node and the destination node from the network graph data structure. In some implementations, the method can include incorporating the historical network operation data into the node data used by the one or more models to generate the network operation risk score for the network operation.

In some implementations, executing the one or more models comprises executing a deterministic rule-based classifier configured to compare identifiers of the source node and destination node against a restricted agent list stored in a lookup table. In some implementations, the method can include increasing the network operation risk score by applying a predefined weight adjustment if a match is detected based on the comparison.

In some implementations, the method can include generating a multi-dimensional feature vector comprising the embedding of the text description and the node data comprising node data attributes including geographic location, network operation history, and node connectivity metrics. In some implementations, the method can include executing a classification model using the multi-dimensional feature vector to generate the network operation risk score.

In some implementations, querying the one or more edges comprises identifying multi-hop relationships between the source node and the destination node. In some implementations, the method can include retrieving metadata from intermediary nodes of the multi-hop relationships. In some implementations, the method can include including the metadata from the intermediary nodes of the multi-hop relationships in the node data to generate the network operation risk score for the network operation.

In some implementations, the method can include determining whether the source node or destination node has previously participated in a compromised network operation. In some implementations, the method can include modifying the network operation risk score based on the previous participation.

In some implementations, the method can include generating a screen status explanation comprising a textual justification for restricting the network operation, the justification including one or more indicators derived from the node data and the embedding. In some implementations, the method can include transmitting the screen status explanation along with the message to the computing device, wherein the message includes a confidence score associated with the determination that the network operation is compromised.

In some implementations, restricting the network operation comprises halting execution of the network operation by transmitting a control signal to a system component configured to manage the transfer of the one or more networked items. In some implementations, the method can include generating an electronic alert comprising metadata of the network operation and storing the alert in a log data structure.

In some implementations, executing the one or more models comprises executing a probabilistic model configured to generate a risk level for the network operation based on statistical deviation of item weight and value. In some implementations, the method can include calculating the statistical deviation using z-scores derived from historical network operations stored in the network graph data structure, the z-scores representing normalized differences between the weight and value of the one or more networked items and historical benchmarks. In some implementations, the method can include modifying the network operation risk score based on the calculated z-scores to increase the score when the deviation exceeds a predefined threshold.

In some implementations, the method can include identifying a geographic location for each of the source node and the destination node from the network graph data structure. In some implementations, the method can include modifying the network operation risk score based on proximity of the geographic location to known compromised regions.

At least one other aspect relates to a non-transitory computer-readable storage medium. The non-transitory computer-readable storage medium can store instructions that, when executed by one or more processors, cause the one or more processors to perform operations. The operations can include receiving a request from a computing device, the request comprising an identification of a network operation between an entity of a source node and an entity of a destination node, the network operation comprising a transfer of one or more networked items from the entity of the source node to the entity of the destination node, and the request comprising a text description of the one or more networked items or the entity of the source node or the entity of the destination node. The operations can include identifying, using the identification of the network operation, one or more sub-graph data structures of nodes each corresponding to the source node or the destination node and connected by a set of edges from a plurality of sub-graph data structures stored in a network graph data structure, the network graph data structure comprising a graph data structure storing a network of nodes and edges between the network of nodes digitally representing types of relationships between entities represented by the network of nodes. The operations can include performing a search through one or more edges of each of the one or more sub-graph data structures of nodes to identify a first one or more nodes connected by edges with the source node and a second one or more nodes connected by edges with the destination node. The operations can include identifying node data from each of the source node, the destination node, and each of the first and second one or more nodes. The operations can include generating an embedding of the text description of the one or more networked items using a model. The operations can include executing one or more models using the embedding and the node data to generate a network operation risk score for the network operation. The operations can include, responsive to determining the network operation is compromised based on the network operation risk score exceeding a threshold, restricting the network operation by transmitting a message to the computing device.

In some implementations, the instructions can further cause the one or more processors to generate the embedding of the text description using a transformer-based neural network model trained on network operation descriptions. In some implementations, the transformer-based neural network model comprises multiple attention layers and is trained on labeled network operation descriptions to produce semantic representations in a fixed-dimensional feature space.

At least one other aspect relates to a method for detecting compromised network nodes in a computing device network based on edges between nodes of the computing device network. The method can include identifying, by one or more processors, a node of a network graph data structure and associated with an entity, the network graph data structure storing a network of nodes and edges between the network of nodes digitally representing types of relationships between entities represented by the network of nodes. The method can include identifying, by the one or more processors, one or more attributes of the entity from the node of the entity in the network graph data structure. The method can include identifying, by the one or more processors, one or more edges between the node and one or more nodes connected with the node in the network graph data structure, each of the one or more edges comprising a network operation risk score. The method can include aggregating, by the one or more processors, the network operation risk score of each of the one or more edges to generate a composite network operation risk score. The method can include executing, by the one or more processors, a model using the one or more attributes of the entity and the composite network operation risk score to generate an entity risk score for the entity. The method can include receiving, by the one or more processors, network operation data for a new network operation of the entity. The method can include generating, by the one or more processors based on the network operation data, a new edge for the new network operation comprising a new network operation risk score for the new network operation. The method can include, responsive to generating the new edge for the new network operation, updating, by the one or more processors, the composite network operation risk score based on the new network operation risk score. The method can include re-executing, by the one or more processors, the model using the one or more attributes of the entity and the updated composite network operation risk score to generate an updated entity risk score for the entity. The method can include, responsive to determining the updated entity risk score for the entity exceeds a threshold, generating, by the one or more processors, an alert identifying the node as a compromised network node.

In some implementations, the method can further include identifying, by the one or more processors, a second new network operation involving the compromised network node. In some implementations, the method can further include restricting, by the one or more processors, the second new network operation responsive to determining the updated entity risk score for the entity exceeds the threshold.

In some implementations, restricting the second new network operation comprises transmitting, by the one or more processors, a control signal to a network switch to isolate the compromised network node from further network communications.

In some implementations, the method can further include generating the network operation risk score for each of the one or more edges. For each edge of the one or more edges, the method can include querying, by the one or more processors, the edge to identify a source node of the edge, a destination node of the edge, and an item description of a networked item corresponding to a network operation of the edge. The method can include executing, by the one or more processors, an embedding model using the item description of the networked item corresponding to the network operation of the edge to generate an embedding representing the networked item. The method can include executing, by the one or more processors, one or more models using the embedding representing the networked item and identifications of the source node of the edge and the destination node of the edge to generate the network operation risk score for the edge.

In some implementations, receiving the network operation data for the new network operation of the entity comprises receiving, by the one or more processors, the network operation data identifying the entity as a source of a transfer or a destination of the transfer of a second networked item. In some implementations, the method can include generating, by the one or more processors, the new edge attached to the node for the entity responsive to the network operation data identifying the entity as the source of the transfer or the destination of the transfer of the second networked item. In some implementations, the method can include triggering, by the one or more processors, the updating of the composite network operation risk score of the entity responsive to determining the new edge is attached to the node for the entity.

In some implementations, updating the composite network operation risk score comprises increasing or decreasing, by the one or more processors, the composite network operation risk score by a weighted amount determined at least by a complementary node of the new edge opposite the node for the entity.

In some implementations, the method can further include, responsive to determining the updated entity risk score for the entity exceeds the threshold, identifying a set of nodes connected with the node of the entity by one or more edges. In some implementations, the method can further include adjusting, by the one or more processors, entity risk scores for each of the set of nodes based on determining the updated entity risk score for the entity exceeds the threshold.

In some implementations, adjusting the entity risk scores for each of the set of nodes comprises, for each of the set of nodes, incrementing, by the one or more processors, a counter for each edge between the compromised network node and the node of the set of nodes. In some implementations, adjusting the entity risk scores for each of the set of nodes further comprises adjusting, by the one or more processors, the entity risk score for the node of the set of nodes by a weighted factor according to a count of the incremented counter.

In some implementations, the method can further include, responsive to determining the updated entity risk score, identifying a set of nodes connected with the node of the entity by one or more edges. In some implementations, the method can further include adjusting, by the one or more processors, entity risk scores for each of the set of nodes based on the updated entity risk score.

In some implementations, the method can further include determining the threshold. Determining the threshold can include retrieving, by the one or more processors, a baseline threshold value associated with a type of the node of the entity. Determining the threshold can include adjusting, by the one or more processors, the baseline threshold value in real time based on at least one measured operational parameter from the computing device network, the at least one measured operational parameter including a frequency of network operations performed within a defined time period ending at a current time. Determining the threshold can include storing, by the one or more processors, the adjusted threshold value as the threshold for comparison with the updated entity risk score.

At least one other aspect relates to a system for detecting compromised network operations in a computing device network based on edges between nodes of the computing device network. The system can include one or more processors. The system can include one or more non-transitory computer-readable media storing instructions. The instructions, when executed by the one or more processors, can cause the system to identify a node of a network graph data structure and associated with an entity, the network graph data structure storing a network of nodes and edges between the network of nodes digitally representing types of relationships between entities represented by the network of nodes. The instructions can cause the system to identify one or more attributes of the entity from the node of the entity in the network graph data structure. The instructions can cause the system to identify one or more edges between the node and one or more nodes connected with the node in the network graph data structure, each of the one or more edges comprising a network operation risk score. The instructions can cause the system to aggregate the network operation risk score of each of the one or more edges to generate a composite network operation risk score. The instructions can cause the system to execute a model using the one or more attributes of the entity and the composite network operation risk score to generate an entity risk score for the entity. The instructions can cause the system to receive network operation data for a new network operation of the entity. The instructions can cause the system to generate, based on the network operation data, a new edge for the new network operation comprising a new network operation risk score for the new network operation. The instructions can cause the system to, responsive to generating the new edge for the new network operation, update the composite network operation risk score based on the new network operation risk score. The instructions can cause the system to re-execute the model using the one or more attributes of the entity and the updated composite network operation risk score to generate an updated entity risk score for the entity. The instructions can cause the system to, responsive to determining the updated entity risk score for the entity exceeds a threshold, generate an alert identifying the node as a compromised network node.

In some implementations, the instructions can also cause the system to identify, by the one or more processors, a second new network operation involving the compromised network node. In some implementations, the instructions can also cause the system to restrict, by the one or more processors, the second new network operation responsive to determining the updated entity risk score for the entity exceeds the threshold.

In some implementations, restricting the second new network operation comprises transmitting a control signal to a network switch to isolate the compromised network node from further network communications.

In some implementations, the instructions can also cause the system to generate the network operation risk score for each of the one or more edges. For each edge of the one or more edges, the instructions can cause the system to query the edge to identify a source node of the edge, a destination node of the edge, and an item description of a networked item corresponding to a network operation of the edge. The instructions can cause the system to execute an embedding model using the item description of the networked item corresponding to the network operation of the edge to generate an embedding representing the networked item. The instructions can cause the system to execute one or more models using the embedding representing the networked item and identifications of the source node of the edge and the destination node of the edge to generate the network operation risk score for the edge.

In some implementations, receiving the network operation data for the new network operation of the entity comprises receiving the network operation data identifying the entity as a source of a transfer or a destination of the transfer of a second networked item. In some implementations, the instructions can cause the system to generate the new edge attached to the node for the entity responsive to the network operation data identifying the entity as the source of the transfer or the destination of the transfer of the second networked item. In some implementations, the instructions can cause the system to trigger the updating of the composite network operation risk score of the entity responsive to determining the new edge is attached to the node for the entity.

In some implementations, updating the composite network operation risk score comprises increasing or decreasing the composite network operation risk score by a weighted amount determined at least by a complementary node of the new edge opposite the node for the entity.

In some implementations, the instructions can also cause the system to, responsive to determining the updated entity risk score for the entity exceeds the threshold, identify a set of nodes connected with the node of the entity by one or more edges. In some implementations, the instructions can also cause the system to adjust entity risk scores for each of the set of nodes based on determining the updated entity risk score for the entity exceeds the threshold.

In some implementations, adjusting the entity risk scores for each of the set of nodes comprises, for each of the set of nodes, incrementing a counter for each edge between the compromised network node and the node of the set of nodes. In some implementations, adjusting the entity risk scores for each of the set of nodes further comprises adjusting the entity risk score for the node of the set of nodes by a weighted factor according to a count of the incremented counter.

In some implementations, the instructions can also cause the system to, responsive to determining the updated entity risk score, identify a set of nodes connected with the node of the entity by one or more edges. In some implementations, the instructions can also cause the system to adjust entity risk scores for each of the set of nodes based on the updated entity risk score.

At least one other aspect relates to a non-transitory computer-readable storage medium. The non-transitory computer-readable storage medium can store instructions that, when executed by one or more processors, cause the one or more processors to perform operations. The operations can include identifying a node of a network graph data structure and associated with an entity, the network graph data structure storing a network of nodes and edges between the network of nodes digitally representing types of relationships between entities represented by the network of nodes. The operations can include identifying one or more attributes of the entity from the node of the entity in the network graph data structure. The operations can include identifying one or more edges between the node and one or more nodes connected with the node in the network graph data structure, each of the one or more edges comprising a network operation risk score. The operations can include aggregating the network operation risk score of each of the one or more edges to generate a composite network operation risk score. The operations can include executing a model using the one or more attributes of the entity and the composite network operation risk score to generate an entity risk score for the entity. The operations can include receiving network operation data for a new network operation of the entity. The operations can include generating, based on the network operation data, a new edge for the new network operation comprising a new network operation risk score for the new network operation. The operations can include, responsive to generating the new edge for the new network operation, updating the composite network operation risk score based on the new network operation risk score. The operations can include re-executing the model using the one or more attributes of the entity and the updated composite network operation risk score to generate an updated entity risk score for the entity. The operations can include, responsive to determining the updated entity risk score for the entity exceeds a threshold, generating an alert identifying the node as a compromised network node.

In some implementations, the operations further comprise, identifying a second new network operation involving the compromised network node; and restricting the second new network operation responsive to the determining the updated entity risk score for the entity exceeds the threshold.

### BRIEF DESCRIPTION OF THE DRAWINGS

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles, and concepts. The drawings are not intended to limit the scope of the claims included herewith.

FIG. 1A illustrates an example block diagram depicting a computing device, in accordance with one or more embodiments.

FIG. 1B illustrates an example block diagram depicting a computing environment comprising a client device in communication with cloud service providers, in accordance with one or more embodiments.

FIG. 2A illustrates an example block diagram depicting a system using supervised learning, in accordance with one or more embodiments.

FIG. 2B illustrates an example block diagram depicting a simplified neural network model, in accordance with one or more embodiments.

FIG. 3A is an illustration of an example system for network graph data structure-based transportation networking, in accordance with an implementation.

FIG. 3B illustrates an example network graph data structure, in accordance with an implementation.

FIG. 3C illustrates example sub-graph data structures of the example network graph data structure of FIG. 3B, in accordance with an implementation.

FIG. 3D illustrates an example sub-graph data structure of the example network graph data structure of FIG. 3B, in accordance with one or more embodiments.

FIG. 3E illustrates a hub and spoke network graph data structure, in accordance with one or more embodiments.

FIG. 3F illustrates an example flowchart of a process for network graph data structure-based transportation networking, in accordance with an implementation.

FIG. 4A illustrates an example sequence of compromised network operation detection, in accordance with one or more embodiments.

FIG. 4B illustrates an example sequence of compromised network operation detection, in accordance with one or more embodiments.

FIG. 4C illustrates an example output schema for compromised network operation detection, in accordance with one or more embodiments.

FIG. 4D illustrates an example sequence for using one or more models for compromised network operation detection, in accordance with one or more embodiments.

FIG. 4E illustrates an example flowchart of a method for using one or more models for compromised network operation detection, in accordance with one or more embodiments.

FIG. 5A illustrates an example sequence of compromised entity detection, in accordance with one or more embodiments.

FIG. 5B illustrates an example flowchart of parallel operation of method for determining a composite network operation risk score for an entity and using the composite network operation risk score to calculate an entity risk score, in accordance with one or more embodiments.

FIG. 5C illustrates an example flowchart of a method for using one or more models for compromised entity detection, in accordance with one or more embodiments.

### DETAILED DESCRIPTION

For purposes of reading the description of the various embodiments below, the following descriptions of the sections of the specification and their respective contents can be helpful:
Section A describes a computing environment and network environment that can be useful for practicing embodiments described herein.
Section B describes an artificial intelligence environment that can be useful for practicing embodiments described herein.
Section C describes a computing system for network graph data structure-based transportation networking in accordance with embodiments described herein.
Section D describes systems and methods for compromised network operation detection and mitigation.
Section E describes systems and methods for compromised entity detection and mitigation within a network.

### A. Computing and Network Environment

Prior to discussing the specifics of embodiments of dynamic management of a network graph data structure for value chain management, it may be helpful to discuss the computing environments in which such embodiments may be deployed.

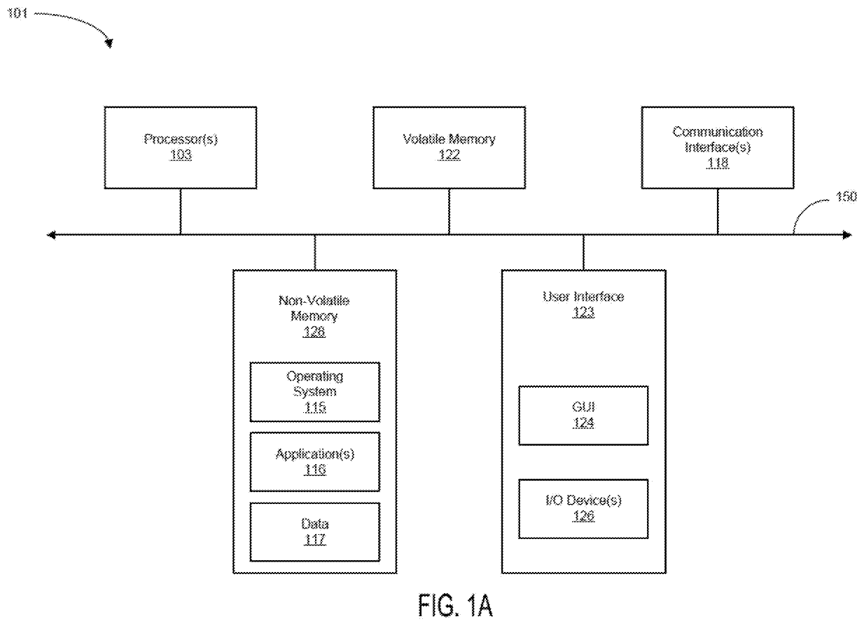

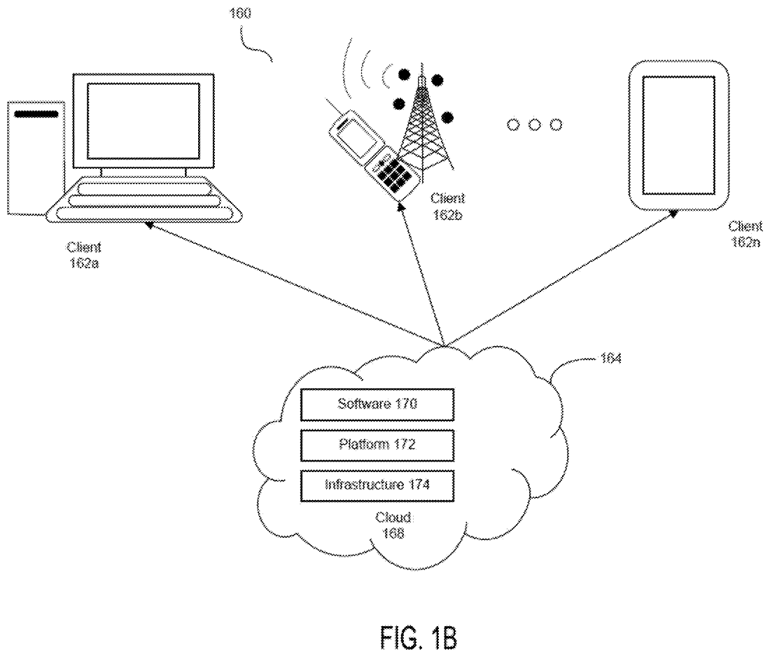

As shown in FIG. 1A, computer 101 may include one or more processors 103, volatile memory 122 (e.g., random access memory (RAM)), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, one or more accelerometers, etc.). Non-volatile memory 128 stores operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computer 101 may communicate via one or more communication buses, shown as communication bus 150.

Computer 101 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 118 may include one or more interfaces to enable computer 101 to access a computer network such as a Local Area Network (LAN), a Wide Area Network (WAN), a Personal Area Network (PAN), or the Internet through a variety of wired and/or wireless or cellular connections.

In described embodiments, the computing device 101 may execute an application on behalf of a user of a client computing device. For example, the computing device 101 may execute a virtual machine, which provides an execution session within which applications execute on behalf of a user or a client computing device, such as a hosted desktop session. The computing device 101 may also execute a terminal services session to provide a hosted desktop environment. The computing device 101 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In embodiments, the computing environment 160 may provide client 162 with one or more resources provided by a network environment. The computing environment 162 may include one or more clients 162a-162n, in communication with a cloud 168 over one or more networks 164. Clients 162 may include, e.g., thick clients, thin clients, and zero clients. The cloud 108 may include back end platforms, e.g., servers 106, storage, server farms or data centers. The clients 162 can be the same as or substantially similar to computer 101 of FIG. 1A.

The users or clients 162 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 108 may be public, private, or hybrid. Public clouds 108 may include public servers that are maintained by third parties to the clients 162 or the owners of the clients 162. The servers may be located off-site in remote geographical locations as disclosed above or otherwise. Public clouds 168 may be connected to the servers over a public network 164. Private clouds 168 may include private servers that are physically maintained by clients 162 or owners of clients 162. Private clouds 168 may be connected to the servers over a private network 164. Hybrid clouds 168 may include both the private and public networks 164 and servers.

The cloud 168 may include back end platforms, e.g., servers, storage, server farms or data centers. For example, the cloud 168 can include or correspond to a server or system remote from one or more clients 162 to provide third party control over a pool of shared services and resources. The computing environment 160 can provide resource pooling to serve multiple users via clients 162 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 162. The computing environment 160 can provide an elasticity to dynamically scale out or scale in responsive to different demands from one or more clients 162. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include serverless computing. The computing environment 160 can include Software as a service (SaaS). For example, the cloud 168 may also include a cloud based delivery, e.g., Software as a Service (SaaS) 170, Platform as a Service (PaaS) 172, and Infrastructure as a Service (IaaS) 174. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g., DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 162 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 162 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 162 may access SaaS resources through the use of web-based user interfaces, provided by a web browser (e.g., GOOGLE CHROME, Microsoft INTERNET EXPLORER, or Mozilla Firefox provided by Mozilla Foundation of Mountain View, California). Clients 162 may also access SaaS resources through smartphone or tablet applications, including, e.g., Salesforce Sales Cloud, or Google Drive app. Clients 162 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Artificial Intelligence Environment

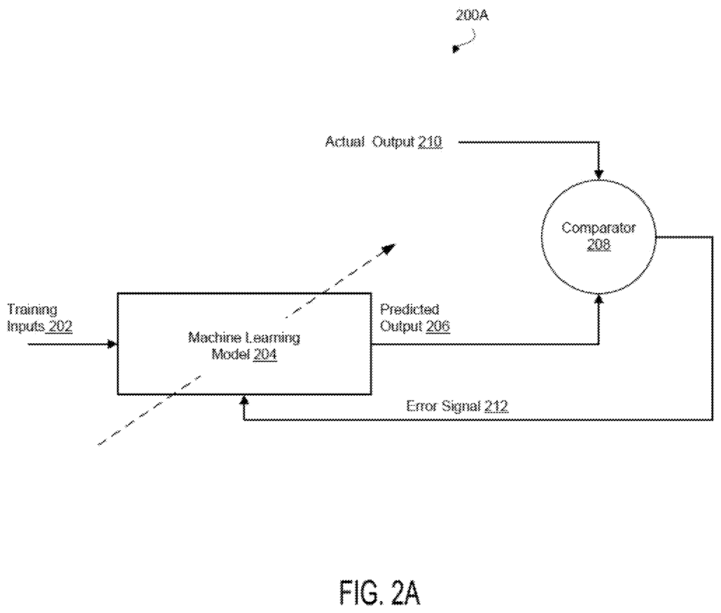

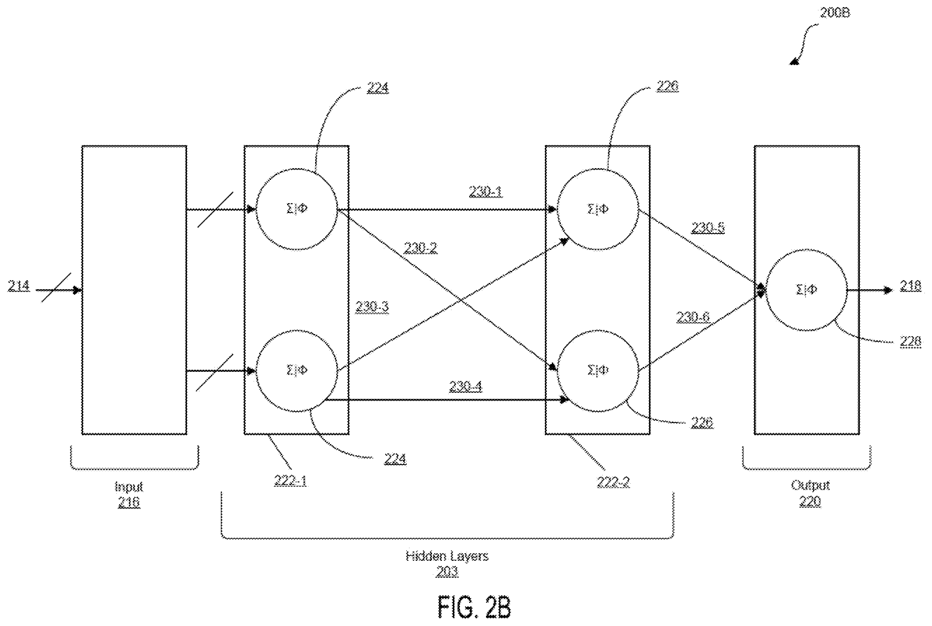

Referring to FIG. 2A, an embodiment of an artificial intelligence environment 200A is depicted. The artificial intelligence environment 200A may incorporate various machine learning models to process data, identify patterns, and generate predictions or decisions. By way of example, machine learning models can comprise supervised learning models, clustering models, neural network models, deep learning models, reinforcement learning models, unsupervised models, decision trees, support-vector machines, Bayesian networks, Gaussian processes, genetic algorithms models, generative models, image and text processing models, video processing models, any other models that can be used by one or more machine learning algorithms, any other models that can learn from data (e.g., training data) to perform tasks without explicit instructions, or various combinations thereof. They can also involve combinations of the above and agentic systems that leverage models and underlying data. The neural network models can comprise, for example and without limitation, artificial neural networks (ANNs), deep neural networks (DNNs), deep belief networks (DBNs), one or more language models, large language models (LLMs), attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), any other models that can learn patterns and make predictions or decisions, or various combinations thereof.

The machine learning models can be configured, learned, or trained using various learning or training operations, such as unsupervised learning, weakly supervised learning, semi-supervised learning, supervised learning, or any other learning or training operations that can learn from data (e.g., training data) and generalize to unseen data, or various combinations thereof. For example, parameters of nodes of a neural network model, such as weights, biases, and/or thresholds, can be configured, learned, or trained using various learning or training operations, such as unsupervised learning, weakly supervised learning, semi-supervised learning, or supervised learning. A machine learning model can be configured using training data from various domain-agnostic and/or domain-specific data sources. The training data can include a plurality of training data elements (e.g., training data instances). Each training data element can be arranged in structured or unstructured formats; for example, the training data element can include an example output mapped to an example input. The training data can include data that is not separated into input and output subsets (e.g., for configuring the machine learning model to perform clustering, classification, or other unsupervised machine learning operations). The training data can include data describing network structure, such as a supply chain network, and the greater network situation of a given observation. The training data can include human-labeled information, including but not limited to feedback regarding outputs of the machine learning model, which can allow the machine learning model to generate more human-like outputs.

Referring back to FIG. 2A, a block diagram of an example system using supervised learning is shown. Supervised learning is a method of training a machine learning model given input-output pairs. An input-output pair is an input with an associated known output (e.g., an expected output).

Machine learning model 204 may be trained on known input-output pairs such that the machine learning model 204 can learn how to predict known outputs given known inputs. Once the machine learning model 204 has learned how to predict known input-output pairs, the machine learning model 204 can operate on unknown inputs to predict an output.

The machine learning model 204 may be trained based on general data and/or granular data (e.g., data based on a specific user 132) such that the machine learning model 204 may be trained specific to a particular user 132.

Training inputs 202 and actual outputs 210 may be provided to the machine learning model 204. Training inputs 202 may include features such as numerical data, categorical variables, text, images, audio signals, and the like.

The inputs 202 and actual outputs 210 may be received from various data repositories. For example, a data repository may contain labeled datasets with example data points and their corresponding correct outputs. The data repository may also contain data associated with specific users or general populations. Thus, the machine learning model 204 may be trained to predict outcomes based on the training inputs 202 and actual outputs 210 used to train the machine learning model 204.

The example system may include one or more machine learning models 204. In an embodiment, a first machine learning model 204 may be trained to predict data using a classification or regression technique. For example, the first machine learning model 204 may use the training inputs 202 to predict outputs 206 by applying the current state of the first machine learning model 204 to the training inputs 202. The comparator 208 may compare the predicted outputs 206 to actual outputs 210 to determine an amount of error or differences. For example, the predicted output 206 may be compared to the actual output 210 to calculate a loss function or error metric.

In other embodiments, a second machine learning model 204 may be trained to make one or more recommendations to the user 132 based on the predicted output from the first machine learning model 204. For example, the second machine learning model 204 may use the training inputs 202 and the predicted outputs from the first machine learning model 204 as its own input to predict outputs 206 in the form of personalized recommendations by applying the current state of the second machine learning model 204 to the training inputs 202. The comparator 208 may compare the predicted outputs 206 (e.g., the recommended actions or networked items) to actual outputs 210 (e.g., user choices or feedback on previous recommendations to determine an amount of error or differences.

The actual outputs 210 may be determined based on historic data of recommendations made to the user 132 and the resulting outcomes in the supply chain. In an illustrative non-limiting example, the machine learning model 204 may be continuously trained to improve its quality and accuracy in predicting and improving supply chain operations. The machine learning model 204 can take into account various inputs such as forecasted demand, inventory data, customer preferences, and distributor preferences to model, recommend, and execute operations. The actual outputs 210 may then be determined by measuring the real-world outcomes after implementing these recommendations, such as the resulting stockout rate, inventory carrying costs, and overall supply chain efficiency.

In some embodiments, a single machine learning model 204 may be trained to make one or more recommendations to the user 132 based on current user 132 data received from enterprise resources 128. That is, a single machine learning model may be trained using the training inputs 202, which include historical data and current user data, to predict outputs 206 in the form of personalized recommendations by applying the current state of the machine learning model 204 to the training inputs 202. The comparator 208 may compare the predicted outputs 206 to actual outputs 210 to determine an amount of error or differences. The actual outputs 210 may be determined based on historic data associated with the recommendation to the user 132 and their subsequent actions or outcomes. The machine learning model 204 may use the data to learn patterns and make increasingly accurate recommendations over time. For instance, if the machine learning model 204 recommends ordering 1000 units of a product and a user 132 follows the recommendation, the actual output 210 may include data on whether the quantity was sufficient, excessive, or inadequate based on subsequent demand and inventory levels. This feedback loop can allow the machine learning model 204 to continuously refine its predictions and adapt to changing conditions and user preferences in the supply chain ecosystem.

During training, the error (represented by error signal 212) determined by the comparator 208 may be used to adjust the weights in the machine learning model 204 such that the machine learning model 204 changes (or learns) over time. The machine learning model 204 may be trained using a backpropagation algorithm, for instance. The backpropagation algorithm operates by propagating the error signal 212. The error signal 212 may be calculated each iteration (e.g., each pair of training inputs 202 and associated actual outputs 210), batch and/or epoch, and propagated through the algorithmic weights in the machine learning model 204 such that the algorithmic weights adapt based on the amount of error. The error is minimized using a loss function. Non-limiting examples of loss functions may include the square error function, the root mean square error function, and/or the cross entropy error function.

The weighting coefficients of the machine learning model 204 may be tuned to reduce the amount of error, thereby minimizing the differences between (or otherwise converging) the predicted output 206 and the actual output 210. The machine learning model 204 may be trained until the error determined at the comparator 208 is within a certain threshold (or a threshold number of batches, epochs, or iterations have been reached). The trained machine learning model 204 and associated weighting coefficients may subsequently be stored in memory 116 or other data repository (e.g., a database) such that the machine learning model 204 may be employed on unknown data (e.g., not training inputs 202). Once trained and validated, the machine learning model 204 may be employed during a testing (or an inference) phase. During testing, the machine learning model 204 may ingest unknown data to predict future data (e.g., future demand, inventory levels, supplier performance, delivery times, and the like).

Referring to FIG. 2B, a block diagram of a simplified neural network model 200B is shown. The neural network model 200B may include a stack of distinct layers (vertically oriented) that transform a variable number of inputs 214 being ingested by an input layer 216 into an output 218 at the output layer 220.

The neural network model 200B may include a number of hidden layers 222 between the input layer 216 and output layer 220. Each hidden layer has a respective number of nodes (224, 226, and 228). In the neural network model 200B, the first hidden layer 222-1 has nodes 224, and the second hidden layer 222-2 has nodes 226. The nodes 224 and 226 perform a particular computation and are interconnected to the nodes of adjacent layers (e.g., nodes 224 in the first hidden layer 222-1 are connected to nodes 226 in a second hidden layer 222-2, and nodes 226 in the second hidden layer 222-2 are connected to nodes 228 in the output layer 220). Each of the nodes (224, 226, and 228) sum up the values from adjacent nodes and apply an activation function, allowing the neural network model 200B to detect nonlinear patterns in the inputs 214. Each of the nodes (224, 226, and 228) are interconnected by weights 230-1, 230-2, 230-3, 230-4, 230-5, 230-6 (collectively referred to as weights 230). Weights 230 are tuned during training to adjust the strength of the node. The adjustment of the strength of the node facilitates the neural network's ability to predict an accurate output 218.

In some embodiments, the output 218 may be one or more numbers. For example, output 218 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As such, the softmax classifier may be employed because of the classifier's ability to classify various classes. Other classifiers may be used to make other classifications. For example, the sigmoid function makes binary determinations about the classification of one class (i.e., the output may be classified using label A or the output may not be classified using label A).

### C. Computing System for Node Transportation Networking

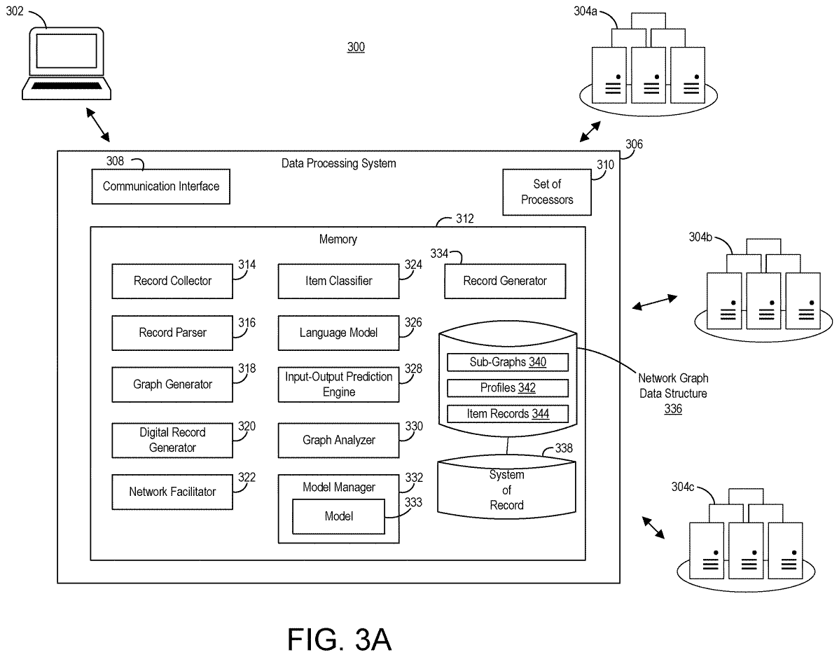

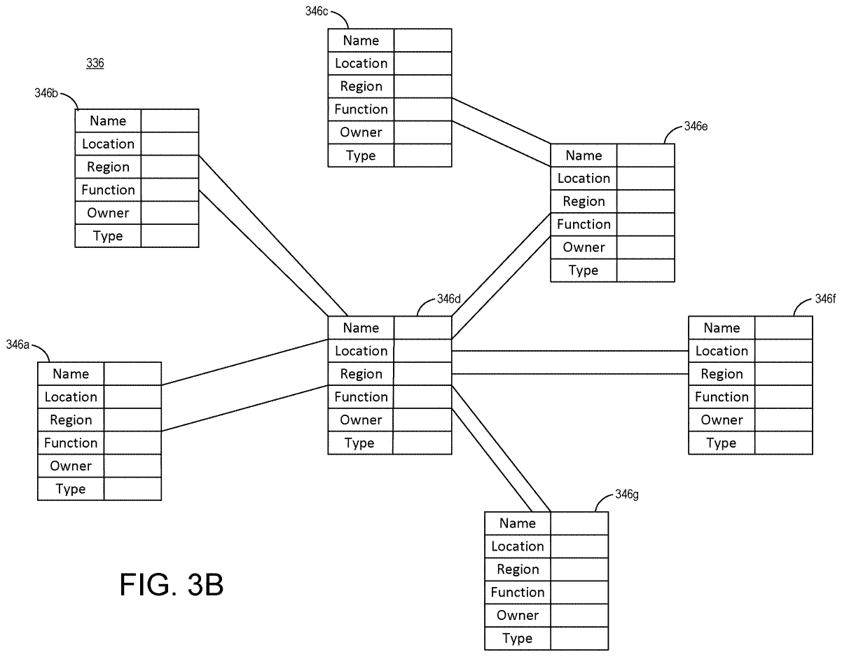

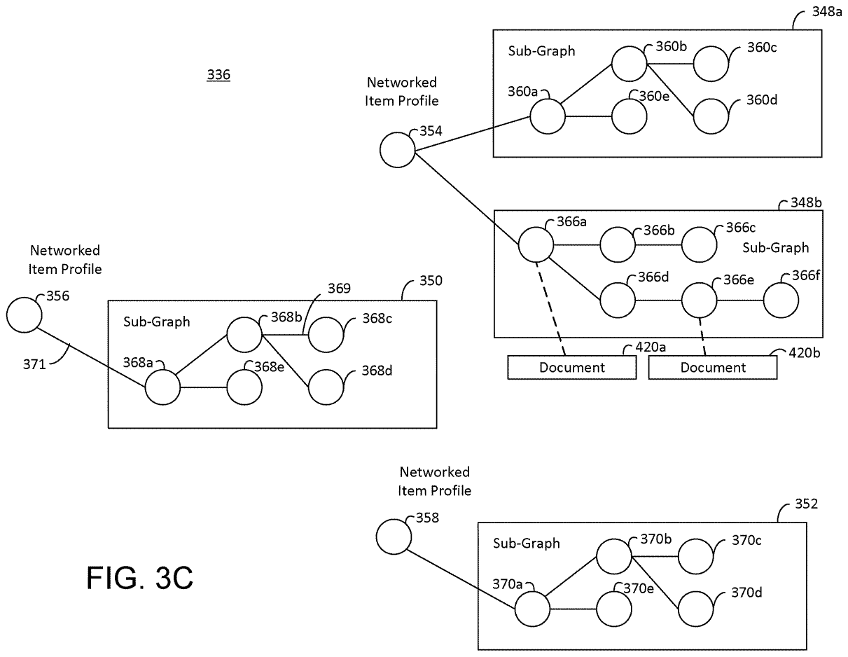

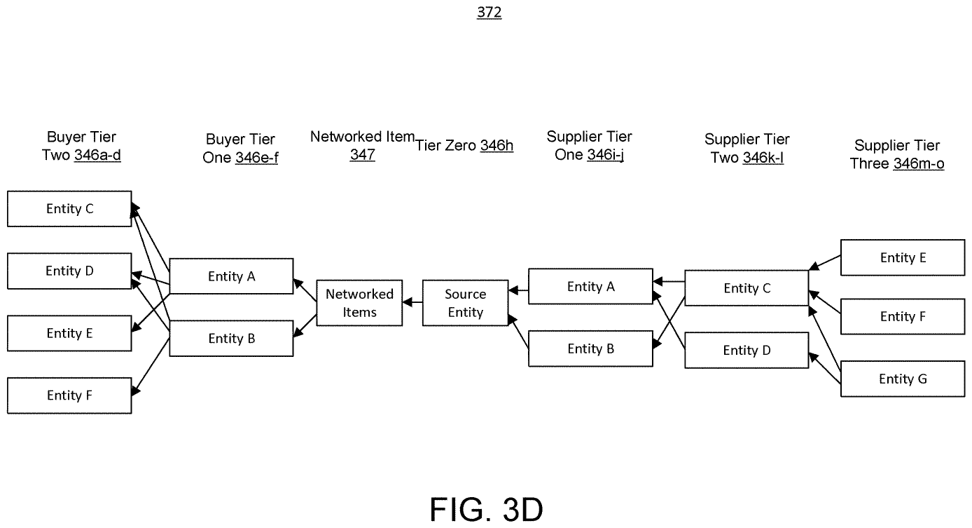

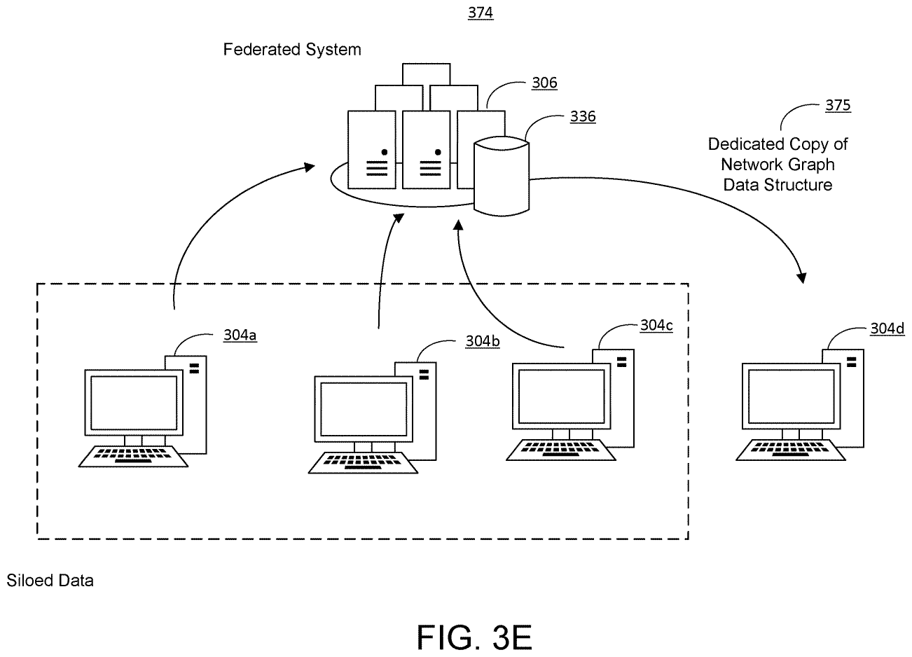

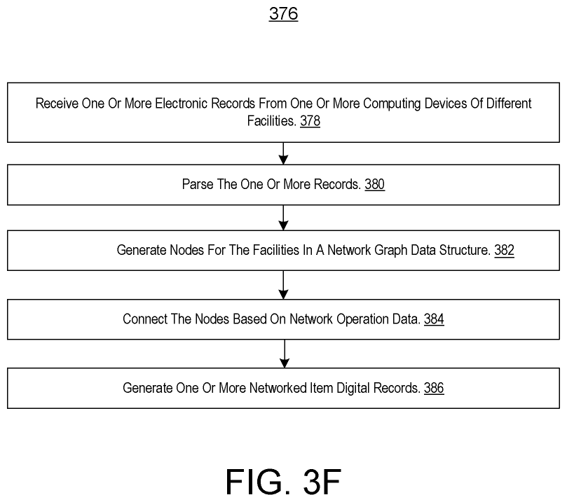

FIG. 3A is an illustration of an example system 300 for network graph data structure-based transportation networking, in accordance with an implementation. In brief overview, the example system 300 can include a client device 302, computing devices 304a-304c (individually, computing device 304, and together, computing devices 304), and a data processing system 306. Each of the computing devices 304 can be configured to store various types of data and perform various types of operations discussed in this disclosure. The data processing system 306 can execute a language processing model (e.g., a large language model) to receive and/or process contextual information regarding database transactions or other communications from a user (e.g., a user accessing the client device 302) of the data processing system 306 and/or data received from the computing devices 304. The data processing system 306 can transmit the contextual information to the computing devices 304 for storage.

The client device 302 can be an electronic computing device (e.g., a cellular phone, a laptop, a tablet, a personal computer, or any other type of computing device). The client device 302 can include a display with a microphone, a speaker, a keyboard, a touchscreen, or any other type of input/output device. A user can access a platform provided by the data processing system 306 through the client device 302 to view outputs of machine learning models and/or otherwise access a portions of a network graph data structure (e.g., a knowledge graph) provided generated and/or provided by the data processing system 306. In one example, the user can transmit a request including an identification of a networked item to the data processing system 306. The data processing system 306 can receive the request and retrieve data from a network graph data structure hosted or maintained by the data processing system to generate context or other requested information regarding the identified networked item. The data processing system 306 can transmit the generated context or requested information back to the client device 302. The data processing system 306 can receive and/or transmit such data over a network (e.g., a synchronous or asynchronous network).

The computing devices 304 can each be or correspond to facilities or locations in a transportation network. The facilities can be or include physical locations or sites within a value chain in which operations or processes take place to generate, modify, assemble, store, distribute, or otherwise deliver products or services. Facilities may include manufacturing plants, warehouses, distribution centers, transportation hubs, retail outlets, data centers, or other relevant infrastructure locations. Collectively, these facilities can facilitate the efficient movement and transformation of goods and services across various stages of the value chain, from initial sourcing and supply, through intermediate processing or logistics, and ultimately to the end user or consumer. The transformation and movement can each be a network operation indicating an operation performed on networked items as they move or are transformed across a network of facilities.

For example, a value chain for a consumer electronics product such as a smartphone may include the transportation and transformation of the smartphone across different facilities of the value chain. In the value chain, a first facility in the value chain can be a manufacturing plant, where components are initially assembled into finished products, such as the smartphone. The components of the smartphone can each originate at other facilities of the value chain, such that each facilitate may include multiple inputs to generate one or more outputs for the value chain for a single product. The smartphone can be transported to another facility in the value chain, such as a warehouse facility, which can store completed products awaiting orders from distributors or retailers. From the warehouse facility, the smartphone may be transported to another facility, such as a distribution center or transportation hub, where products are sorted, packaged, and dispatched to retail outlets or directly to end users.

A second example can be a value chain for food products. In this example, facilities may include food processing plants, which can transform raw agricultural produce into packaged and marketable food networked items. From these processing plants, the products may be transported to cold storage or refrigerated warehousing facilities for product freshness and safety, subsequently, transportation hubs or logistics centers can coordinate the distribution of the food products to supermarkets, grocery stores, or directly to consumers, completing the flow from farm to table for the value chain for the food products.

Facilities within a value chain can provide electronic documentation about their roles and operations in the value chain by transmitting relevant data from their respective computing devices 304 to the data processing system 306. For example, a manufacturing plant can use its computing device 304 to transmit detailed production reports that include finished quantities, malfunction logs, quality assurance metrics, and resource consumption data to the data processing system 306. Similarly, warehouse and storage facilities can utilize their respective computing devices 304 to regularly provide inventory updates, storage conditions, inbound delivery notifications, outbound shipment records, and product-handling information to the data processing system 306. By electronically transmitting ongoing documentation regarding inventory status, product movements, batch numbers, expiration dates, and environmental conditions (for example, temperature or humidity sensor readings), these facilities allow the data processing system 306 to maintain continuous visibility into different value chains in which the facilities are a part and the network operations performed by the facilities.

Additionally, logistics hubs and distribution centers may similarly rely upon their computing devices 304 to relay shipping and transportation documentation to the data processing system 306. The computing devices 304 for the logistics hubs and distribution centers can transmit information, such as shipment tracking data, freight bills, estimated delivery timelines, route details, transport conditions, and real-time status updates on transit delays or incidents can be to the data processing system 306.

The data processing system 306 may include one or more processors that are configured to maintain and update a network graph data structure, such as for transportation network management. The data processing system 306 may include a communication interface 308, a set of processors 310, and a memory 312. The data processing system 306 may communicate with the computing devices 304 via the communication interface 308, which may be or include an antenna or other network device that enables communication across a network and/or with other devices. The memory 312 may include a record collector 314, a record parser 316, a graph generator 318, a digital record generator 320, a network facilitator 322, an item classifier 324, a language model 326, an input-output prediction engine 328, a graph analyzer 330, a model manager 332, a record generator 334, a network graph data structure 336, and/or a system of record 338.

The set of processors 310 may be or include an application-specific integrated circuit (ASIC), a set of field programmable gate arrays (FPGAs), a set of digital signal processors (DSPs), circuits containing one or more processing components, circuitry for supporting a microprocessor, a group of processing components, or other suitable electronic processing components. In some embodiments, the set of processors 310 may execute computer code or modules (e.g., executable code, object code, source code, script code, machine code, etc.) stored in the memory 312 to facilitate the operations described herein. The memory 312 may be or include any volatile or non-volatile computer-readable storage medium capable of storing data or computer code.

One or more of the computing devices 304 or the data processing system 306 can include or utilize at least one processing unit or other logic devices such as a programmable logic array engine or a module configured to communicate with one another or other resources or databases to perform one or more of the operations described in this disclosure. As described herein, computers can be described as computers, computer devices, computing devices, or client devices. One or more of the computing devices 304 may each contain their own computer resources (e.g., processor, memory, etc.), share computer resources, or be part of a distributed computer system. The components of the computing devices 304 or the data processing system 306 can be separate components or a single component. The example system 300 and its components can include hardware elements, such as one or more processors, logic devices, or circuits. The computing devices 304 or the data processing system 306 can each be a server or computer that is configured to store various types of data, such as data stream data, image data, audio data, other types of content data, etc. For example, the computing devices 304 or the data processing system 306 can each store records for different accounts in memory (e.g., in a database in memory), where such media may include non-transitory machine-readable media used to store program instructions for performing one or more operations described in this disclosure.

The record collector 314 may include instructions that, when executed by the set of processors 310, cause the set of processors 310 to aggregate and retrieve or receive data from different sources, such as the computing devices 304. The record collector 314 may perform such operations by implementing various retrieval methods such as polling, change data capture (CDC), or event-driven mechanisms to fetch real-time data updates. For handling real-time data collection, the record collector 314 may employ message queues like Apache Kafka or RabbitMQ to buffer incoming data streams and prevent data loss during high-volume periods. In some cases, the record collector 314 can receive and/or manage data reception of electronic documents or records that the computing devices 304 transmit to the data processing system 306.

The record collector 314 may store the collected electronic documents or records within the system of record 338. The collected records may be stored in a structured manner, enabling efficient indexing, querying, and retrieval of information. For example, the computing devices 304 of the different facilities involved in one or more value chains may transmit records to the data processing system 306. Examples of records that the data processing system may receive can include, in addition to any other types of records:
Manufacturing facility records, such as production run reports, quality control data, defect logs, maintenance schedules, machine downtimes, and resource utilization reports.
Warehouse and inventory management records, such as detailed inventory counts, storage condition logs (e.g., temperature and humidity readings), product expiration dates, batch numbers, incoming delivery details, and outbound shipment data.
Logistics and transportation records, including shipment tracking records, freight bills, delivery confirmation receipts, transportation delay reports, real-time GPS coordinates, carrier performance metrics, and incident or accident documentation.
Records relating to retail or distribution centers, such as inventory sales data, return processing documents, reorder logs, store stock levels, and customer demand forecasts.
Event-driven notifications, such as alerts of supply chain disruptions, inventory shortages, equipment failures, or transportation route changes.
Operational transaction data, including purchasing or procurement orders, invoice records, payment confirmations, and financial transaction logs.
Compliance or regulatory records documenting adherence to applicable regulations, standards, certifications, inspection reports, and audit trails from each facility.
   The record collector 314 may receive such records as sets of data or electronic documents or files and store the records in the system of record 338.

In one example, the record collector 314 can be, include, or interface with an application programming interface (API) that facilitates communication between the data processing system 306 (e.g., via the communication interface 308 of the data processing system) and other computing devices, such as the client device 302 and/or the computing devices 304. The record collector 314 may communicate with the client device 302 and/or the computing devices 304 across a network.

For instance, the record collector 314 can establish a connection with one of the computing devices 304. The record collector 314 can establish the connection with the computing device 304 over the network. To do so, the record collector 314 can communicate with set of servers across the network. In one example, the record collector 314 can transmit a syn packet to the computing device 304 (or vice versa) and establish the connection using a TLS handshaking protocol. The record collector 314 can use any handshaking protocol to establish a connection with the computing device. The data processing system 306 can communicate with the computing device over the established connection.

Over the established connection, the computing device 304 can transmit one or more records for a facility. The records can include, for example, one or more shipment tracking records, bills of materials, freight bills, delivery confirmation receipts, transportation delay reports, real-time GPS coordinates, carrier performance metrics, or incident or accident documentation. The record collector 314 can receive the records and store the records in the system of record 338.

The record parser 316 may include instructions that, when executed by the set of processors 310, cause the set of processors 310 to parse the records received by the record collector 314 and/or retrieved from the system of record 338. In some cases, the record parser 316 can parse the records using natural language processing techniques, such as by extracting relevant operational data elements and facility-specific details from the electronic records transmitted by computing devices 304 of different facilities within the value chain. For example, the record parser 316 may use natural language processing techniques such as named entity recognition to identify (e.g., automatically identify) facility names, locations, equipment identifiers, product batch numbers, or shipment tracking numbers from textual records. Relationship extraction methods may be employed to identify connections between different entities, for instance, associating product batch information with manufacturing dates, quality inspection results, or origin/destination details from logistics records. Additionally, the record parser 316 may apply text classification or rule-based parsing methods to categorize records based on facility roles (e.g., manufacturing, warehousing, transportation, etc.). In some cases, the record parser 316 can normalize extracted data into standardized formats to aggregate, index, analyze, and report across datasets from multiple facilities consistently and efficiently. In some embodiments, domain-adapted machine learning models trained specifically on facility-generated documentation and supply chain terminology may further enhance the parsing accuracy and comprehensiveness of the data extraction process. The record parser 316 can identify or extract such information from the different records and store the extracted or identified data in the system of record 338.

The system of record 338 can be a relational or any other type of database that is configured to store records collected by the record collector 314 and/or data parsed or extracted from such records by the record parser 316. The system of record 338 may store structured and normalized operational data parsed from electronic records transmitted by computing devices 304 associated with facilities throughout the value chain. Examples of such operational data stored in the system of record 338 may include production run details, quality inspection results, detailed inventory levels, shipment tracking logs, logistics incidents and delays, product batch identifiers, facility locations, and transactional or compliance documentation. By maintaining this comprehensive and structured data repository, the system of record 338 can facilitate the data processing system 306 performance of efficient support queries, analytics, reporting, real-time decision-making, and/or proactive management of the overall value chain operations. The system of record 338 can also be configured to provide interfaces or data-access layers that allow other components or services within or external to the data processing system 306 to easily access and retrieve such stored information for downstream processing, visualization, or further analysis. In some cases, the system of record 338 can include the network graph data structure 336 and/or include different notes or comments about the network graph data structure 336.

The graph generator 318 may include instructions that, when executed by the set of processors 310, cause the set of processors 310 to generate the network graph data structure 336. The graph generator 318 can generate the network graph data structure 336 based on (e.g., based only on) records and/or parsed data stored in the system of record 338. For example, from the stored records and/or parsed data, the graph generator 318 can generate one or more nodes that each represent a different facility that is involved in at least one value chain. The graph generator 318 can generate edges between pairs of nodes representing pairs of facilities that represent or indicate the transportation of networked items or components used to create or transform individual the networked items. An edge between a pair of nodes representing a pair of facilities can indicate the output from one facility of the pair of nodes that is input into another facility of the pair of nodes. The graph generator 318 can additionally or instead generate nodes that represent different networked items (e.g., items that are transformed and/or transported across a value chain). The graph generator 318 can generate edges between the nodes for the networked items to the facilities that are involved in the transportation and/or creation of the respective networked items. The graph generator 318 can generate the edges by storing identifications of the nodes connected by the edges in the respective nodes. The graph generator 318 generate the nodes and/or edges between nodes in the network graph data structure 336.

The network graph data structure 336 can be or include a graph data structure configured to store different nodes of value chains for different networked items. The nodes can each be or include a separate data structure with node field-value pairs that each correspond to a different type of data regarding a facility represented by the node. For instance, the individual nodes can each include node field-value pairs for a name or identifier of the facility represented by the node, a type of node (e.g., manufacturing, warehousing, transportation, etc.), a description of the function of the node, a location (e.g., geographic location) of the node, a region of the node, an owner of the node, etc. Each node field-value pair can include an identification of the type of the node field-value pair and a value for the node field-value pair. The graph generator 318 can identify values for the node field-value pairs from the records and/or parsed data of the system of record 338 and store the values in the corresponding node field-value pairs.

The network graph data structure 336 can be or include one or more sub-graph data structures 340. Each of the sub-graph data structures can represent a value chain for generating a networked item. For instance, each sub-graph data structure 340 can be linked by an edge with a profile data structure or networked item profile 342 for a networked item that is generated by a value chain that the sub-graph data structure 340 represents. The individual sub-graph data structures 340 can each include a chain of nodes. The chain of nodes can be or include a sequence of connected nodes forming a path of one or more instances of the networked item from a source node (e.g., a source node or initial node of the chain of nodes or the sub-graph data structure 340) to a destination node (e.g., a destination node or last node of the chain of nodes or the sub-graph data structure 340). The path can represent network operations of one or more instances of the networked item through the sequence of connected nodes. In some cases, each node of the sequence of connected nodes represents an entity performing a network operation on the one or more instances of the networked item. Each edge between one or more pairs of the sequence of connected nodes can represent movement, transfer, or transport of the one or more instances of the networked item from a first node (e.g., a source node) of the pair of nodes to a second node (e.g., a destination node) of the pair of nodes.

The digital record generator 320 may include instructions that, when executed by the set of processors 310, cause the set of processors 310 to generate networked item profiles 342 and/or networked item digital records (e.g., passports) for different networked items for which value chains are represented in the network graph data structure 336. The networked item profiles 342 can be or include nodes or profiles that store data the networked items represented by the networked item profiles 342. For example, the networked item profiles 342 can be or include separate data structures that represent the respective networked items. The data structures can each be or include one or more attribute field-value pairs that each correspond to attributes of the respective networked items. Examples of attribute field-value pairs can include classifications, carbon footprint for manufacturing the networked items., revenue, origin, etc. The digital record generator 320 can generate networked item profiles 342 for different networked items using data stored for the networked items from the system of record 338. The graph generator 318 can store the networked item profiles 342 in the network graph data structure as profiles 342 as nodes of the network graph data structure 336. In doing so, the graph generator 318 can generate edges between the networked item profiles 342 and nodes representing facilities (e.g., the origin or initial facilities) of value chains involving the networked item or that are used to generate networked items of the respective networked item profiles 342.

The digital record generator 320 can generate networked item digital records for different networked items. The networked item digital records can be or include a view into the network graph data structure 336 that includes one or more sets of nodes or sub-graph data structures indicating one or more value chains of the networked items associated with the networked item digital records. The networked item digital records can each correspond to one or more networked items. The digital record generator 320 can generate the networked item digital records to each have a unique identifier (e.g., a passport identifier or a digital record identifier) that operates as an address for the networked item digital record. The digital record generator 320 can generate the networked item digital records to include identifications of one or more networked item profiles 342, identifications of individual nodes, and/or identifications of different sub-graph data structures or value chains for networked items. In some cases, the networked item digital records can include the profiles, nodes, and/or sub-graph data structures themselves.

The digital record generator 320 can generate the networked item digital records based on user selections that the digital record generator 320 receives, such as from the client device 302. For example, a user can provide an input to generate a networked item digital record for a networked item. The user can then provide an input selecting a networked item profile for the networked item and one or more sub-graph data structures indicating sets of nodes representing value chains in which the networked item is involved. The digital record generator 320 can receive the selections and generate a networked item digital record for the networked item by generating an identifier for the networked item digital record as well as identifying identifiers for each of the selected networked item profile and the sub-graph data structures and/or nodes of the sub-graph data structures. The digital record generator 320 can store a file including the identifiers and/or the data structures of the selected networked item digital record and the sub-graph data structures or nodes. The digital record generator 320 can store the file in the network graph data structure 336 as one of a plurality of networked item digital records 344.

The network facilitator 322 may include instructions that, when executed by the set of processors 310, cause the set of processors 310 to facilitate the transfer of networked items across a network nodes. The network facilitator 322 can do so, for example, by responding to requests from computing devices regarding whether networked items satisfy a set of rules. For instance, the network facilitator 322 can store a set of rules that indicate criteria that networked items can satisfy during the transfer or transportation of the networked items between facilities, in some cases across the border. In response to a request, the network facilitator 322 can identify a networked item digital record for the networked item from the network graph data structure 336. The network facilitator 322 can identify the networked item digital record, for example, by identifying the networked item digital record based on the networked item digital record containing an identification of the networked item or by identifying an address of the networked item digital record that was contained in the request. The network facilitator 322 can retrieve the networked item digital record and identify a networked item profile for the networked item and/or the nodes containing data regarding one or more transformations and/or transportations of the networked item. The network facilitator 322 can retrieve data from the respective profiles and/or data structures. The network facilitator 322 can apply the set of criteria to the retrieved data to determine whether the data for the networked item satisfies the set of criteria. Responsive to determining the set of criteria is satisfied, the network facilitator 322 can generate a flag indicating the transfer or transport of the networked item is allowed. Otherwise, the network facilitator 322 can restrict the transfer or transport of the networked item by generating an alert or otherwise operating a machine to restrict the movement of a vehicle from transferring or accepting the networked item.

The item classifier 324 may include instructions that, when executed by the set of processors 310, cause the set of processors 310 to generate classifications for networked items. The item classifier 324 can generate classifications for networked items in response to requests from computing devices, such as the client device 102. For example, the item classifier 324 can receive a request containing an identification of a networked item. The request can be for a classification (e.g., a harmonized system (HS) code for the time) for the networked item. The item classifier 324 can receive the request and identify one or more sub-graph data structures from the network graph data structure 336 that correspond to the networked item (e.g., correspond to facilities that facilitate the transformation and/or transport of the networked item and/or components of the networked item). The item classifier 324 can use edges between the sub-graph data structures to identify different information about the networked item, such as a source node (e.g., source facility) for the networked item and/or a destination node (e.g., a destination facility) for the networked item.

The item classifier 324 can use the retrieved data from the network graph data structure 336 to generate a prompt for the language model 326. The language model 326 can be or include a large language model, a transformer, a neural network, etc., that is trained to generate responses to input containing different types of content, such as images, text, or videos. The item classifier 324 can generate a prompt containing the identification of the networked item and/or any information retrieved from the network graph data structure 336 regarding the networked item in response to the request. In some cases, the item classifier 324 can include a description (e.g., a text description) of the networked item or the entity of the source node or the entity of the destination node in the prompt. The item classifier 324 may receive the description in the request or by retrieving the text description from the networked item profile for the networked item stored in the network graph data structure 336. The item classifier 324 can generate such a prompt and input the prompt into the language model 326. The item classifier 324 can execute the language model 326 based on the input to cause the language model 326 to output a classification for the networked item and/or a confidence score for the classification for the networked item.

The item classifier 324 can compare the confidence score for the classification to a threshold. Responsive to determining the confidence score exceeds the threshold, the item classifier 324 can generate a visual representation of the classification and/or the confidence score for the classification. The item classifier 324 can transmit the visual representation of the classification to the client device that transmitted the request.

In cases in which the item classifier 324 determines the confidence score is less than the threshold, the item classifier 324 can retrieve further information regarding the networked item. The item classifier 324 can do so, for example, by querying a network (e.g., the Internet) for one or more databases that store data regarding networked items that contain matching identifiers to the identifier received in the request. The item classifier 324 can retrieve information regarding the networked item from such databases enrich the prompt with the retrieved data. The item classifier 324 can input the enriched prompt into the language model 326 and execute the language model 326 to generate a classification and/or a confidence score for the classification. The item classifier 324 can repeat this process any number of times until determining or identifying a confidence score for a classification that exceeds the threshold.

The input-output prediction engine 328 may include instructions that, when executed by the set of processors 310, cause the set of processors 310 to generate predictions for inputs and/or outputs of nodes of the network graph data structure 336. For instance, the input-output prediction engine 328 can be or include one or more machine learning models (e.g., neural networks, support vector machine, random forests, etc.) that are each configured to generate a prediction regarding an input to a node and/or an output of a node. Examples of inputs can be or include different types of energy (e.g., coal, electricity, gas, etc.) the facilities represented by the nodes use for operation, the amount of energy the facilities use for a defined time interval, components that the facilities receive from other facilities, types of transportation through which the facilities receive inputs, the facilities that provide the inputs, etc. The outputs can be the types of networked items or components the facilities produce, environmental emissions or outputs the facilities produce, etc. The input-output prediction engine 328 can predict such inputs and/or outputs based on any type of data or metadata regarding the facilities, such as based on identification of the technology the facilities use, identifications of the inputs and/or outputs of the facilities, the number of employees, the geography or region of the facilities, the number of network operations that the facilities are involved in, etc. The input-output prediction engine 328 can generate predictions based on such inputs or outputs. The input-output prediction engine 328 can store the predictions in the data structures or nodes of the network graph data structure 336 for which the input-output prediction engine 328 generated the predictions.

In some cases, the input-output prediction engine 328 can store and/or include an input-output matrix. The input-output matrix can map item classifications to determine relevance for target item generation. This matrix can operate as a lookup table that facilitates fast identification of pertinent input/output relationships without requiring extensive graph traversal. The system can perform classification-based queries against this matrix, in some cases using item classifications or other types of data (e.g., textual description, numeric characteristics, categorical values, and/or graph connections) as keys to identify which inputs should be included in or discarded from the sub-graph generation process. Generating and using the input-output matrix in this way can transform the conventionally recursive and computationally expensive process of dependent graph traversal into an efficient and direct lookup operation that scales with the size of the network graph data structure.

Additionally, the input-output prediction engine 328 can implement one or more semantic models, such as generative models, foundational neural net models, transformer models, BERT models, SBERT models, etc., that analyze textual descriptions of items to make more nuanced determinations about input-output relationships. These semantic models can provide an additional layer of intelligence beyond classification matching using the input-output matrix, facilitating the data processing system 306's ability to understand contextual relationships between items based on their descriptive content. The semantic analysis can aid in resolving ambiguous cases where matrix-based filtering alone might be insufficient, ensuring that the generated sub-graphs capture the most accurate and relevant dependency relationships for the corresponding target items.

Moreover, the model manager 332 can continuously increase the accuracy of the models involved in evolving operational environments through continuous learning. To do so, the model manager 332 can train and retrain large language models using records of actual network operations and item transfers. The model manager 332 can use the trained large language models to enable the input-output matrix to adapt to changing operational patterns. This dynamic updating capability ensures that the sub-graph generation process remains accurate as new items are introduced, relationships change, or operational procedures evolve. The continuous learning approach prevents the degradation of system accuracy.

The graph analyzer 330 may include instructions that, when executed by the set of processors 310, cause the set of processors 310 to generate metrics for the network graph data structure 336. The graph analyzer 330 can generate the metrics for individual nodes in the network graph data structure 336, individual networked item profiles of the network graph data structure 336, individual sub-graph data structures of the network graph data structure 336, etc. The graph analyzer 330 can generate the metrics based on the data stored in the network graph data structure 336 for the respective nodes, sub-graph data structures, and/or networked item profiles. The graph analyzer 330 can generate the metrics and store the metrics in network graph data structure 336 and/or the system of record 338.

The model manager 332 may include instructions that, when executed by the set of processors 310, cause the set of processors 310 to generate manage the different computer models (e.g., optimization models, machine learning models, etc.) stored by the data processing system. The model manager 332 may execute and/or train the different machine learning models and/or other types of computer models to generate outputs based on data stored in the network graph data structure 336, the system of record 338, and/or any other data sources.

The model manager 332 may be or include a task agent that is configured to execute different applications and/or models stored by the data processing system 306 to perform different tasks. For instance, the task agent can be or include one or more large language models. The task agent can determine the intents of queries (e.g., natural language queries) and use the intents to determine one or more tasks to perform. The task agent can identify a relevant sets of instruction, model, and/or application of the components 314-330 and/or 334 to use to perform a task, execute the identified set of instructions, model, and/or application, determine if the task are completed based on the execution, identify another set of instructions responsive to determining the task is not completed, and repeat this process until determining the task and/or each task is completed, model, or application or applications.

The model manager 332 may include a model 333. The model 333 can include one or more of the models described herein as being processed or executed by the data processing system 306, such the language model 326 and/or the models for classification of the input-output prediction engine 328. The model manager 332 can execute and/or train the model 333 to perform different tasks, such as classifying networked items, generating risk scores for network operations, generating risk scores for entity nodes, etc. The model manager 332 can train such models using data from the network graph data structure 336 and/or ground truth information (e.g., from the network graph data structure 336 or from another source, such as the system of record 338 or an external database or data source). The model manager 332 may do so as a task agent or any type of model or application that the data processing system 306 can execute.

The record generator 334 may include instructions that, when executed by the set of processors 310, cause the set of processors 310 to generate records (e.g., user interfaces, databases, tables, files, etc.). The record generator 334 can generate records containing data that is requested by different computing devices. In some cases, the record generator 334 can generate the records to include data generated by one or more of the network facilitator 322, the item classifier 324, the language model 326, the input-output prediction engine 328, and/or the graph analyzer 330. The record generator 334 can (e.g., through the record collector 314) transmit such records to the requesting computing devices and/or store the records in the system of record 338 and/or the network graph data structure 336.

FIG. 3B illustrates an example of the network graph data structure 336 storing nodes representing the networking of the transportation and/or transformation of different networked items across a network, in accordance with an implementation. As illustrated, the network graph data structure 336 can include one or more nodes 346a-g (individually, node 346 and together, nodes 346) that represent different facilities. The nodes 346 can be connected by edges that each represent network operations (e.g., transactions or transportation instances) between the respective nodes 346. The nodes 346 can each include one or more node field-value pairs for different types of characteristics or attributes of the facilities represented by the nodes 346. The nodes 346 can include one or more attributes such as, for example, name, location, region, function, owner, type, etc.

The edges of the network graph data structure 336 can be or include data structures (e.g., edge data structures). For example, the edge data structures can each include one or more edge field-value pairs for different types of characteristics or attributes of the network operations represented by the edges. The edges can include one or more attributes such as, for example, identifier or name of the networked item being transported or transferred, quantity (e.g., number of networked items of a shipment and/or weight of an individual network item and/or weight of the total networked items being transferred in the network operation), a time and/or date of the network operation, a classification (e.g., an HS classification) of the networked item, a description (e.g., a text string description) of the networked item, a method of transport, etc. The edge data structures can each include identifiers of the nodes that the edges are connecting, in some cases forming the edge in a structured manner.

### Master Data Objects

The network graph data structure 336 can include master data objects that store data for specific types of networked items represented in the network graph data structure 336. Examples of networked items for which the network graph data structure 336 may store master data objects include products, organizations, locations, customers, users, suppliers, orders, shipments, and customs entries. Details regarding these data objects are below.
Product
   The “output” Product is the primary focus in the Catalog and in the overall value chain management system design
   Input Products are also linked to the output Product via a Bill of Materials
   Products can be linked across value chains networks, and specifically through the Systems of Record of “active” registered organizations, via product passports
   Attributes
      Revenue (for output Products)
      Spend (for input Products)
      Bill of Materials
      Certificate of Origin
      Product Carbon Footprint
      HS codes (by jurisdiction)
      Material Safety Data Sheet
      Third Party Certifications
      Images
      Reports/Attestations generated within the system
      The system ID and system-generated QR Code
      Any other attributes can be specified by users involved (e.g., the parties involved) in the need for the product passport.
Organizations
   Registered Organization
      This organization type is meant to capture the general sense of a “counterparty” entity in a global b2b or B2g interaction. I sell to Crystal and Stone Co., and not the Smith family. I import my goods with the customs agency and not the government. I buy jet engines from Acme Co. and not the parent company Globex. I fly on Jets Airways and not the regionally-licensed subsidiary.
      Registered organizations include 1) any customer-provided company counterparty node listed in their Catalog, and/or 2) system-created registered organizations generated through AI systems operating on customer and third party data, but not in reliance on, or re-constituting, any one corporate firmographic dataset.
         Registered organizations can have one or more Legal Organizations, Legal Entities, and Facilities linked to them.
      Government, non-profits, academic institutions, etc. can be registered organizations—not just corporate entities
      Attributes of registered organizations:
         Website
         Brands
         Legal Organizations linked through ownership
         Facilities
         User registries
   [GRAPH concept, not a Master Data Object: Legal Organization]
      Clustered legal entities (by name and geography)
   [Graph concept, not a VCMS Master Data Object: Legal Entity]
      A canonical legal entity provided by a third party corporate register
Locations
   Facility
      A system-generated entity that is comprised of a 1) physical address, and 2) a business relationship edge (mostly shipments, but summary buyer-supplier edges work too)
   Area
      Polygon
      Attributes:
         Land use
         Deforestation risk
Customers
   Customers are registered organizations, and can be linked to one or more output Products in the Catalog
Suppliers
   Suppliers are registered organizations, and can be linked to one or more input Products in the Catalog
Orders
Shipments
Customs Entries

### Insight Objects

The network graph data structure 336 can include or be associated with insight objects. The insight objects can store data generated from metrics or analytics performed on the nodes or objects of the network graph data structure 336. Examples of insights for which the network graph data structure 336 may store insight data objects include exposure, event, opportunity, and change. Details regarding these data objects are below.
Exposure
   Compliance risk
   Business interruption risk
   Geopolitical risk
Event
   AI event
      Subcategories thereof
   System network event
      Placeholder for events generated off of the network graph data structure 336 and/or network
Opportunity
   Placeholder for an insight type that is an opportunity, such as a “recommended supplier” or “recommended customer”
Change
   A graph change that affects a customer's VC network

### Task Objects

The network graph data structure 336 can include or be associated with task objects. The task objects represent or include data for any type of data object of the network graph data structure 336 or associated with the network graph data structure 336. In some cases, task objects can be grouped or linked into a larger “job” data structure representing different actions to be performed to accomplish a job associated with the job data structure. Details regarding task data objects are below.
Tasks can be collaborative pages that allow for internal and external collaboration/communication and role-based abilities to:
   Edit, annotate, and append Master Data Objects
   Disposition Insight Objects
   Share or request Passports, including designating data and documents to share or request within the Passport
Examples of tasks can include
   Exposure Assessment, which may be subdivided into two tasks that include:
      Network Validation
      Exposure Validation
   Event Assessment, which may be subdivided into two tasks that include:
      Network Validation
      Event Characterization
   Classification
   Connection
      Facilitation (cross-border voluntary trade facilitation)
      Survey (upstream data gathering)
      Reporting (customer and/or regulator) as recipient
   Screening
      For screening entities not in my System of Record for exposures
   Network Update
      Network Validation action associated with a Change insight

In some cases, the data processing system may include different AI agents that facilitate users requesting an agent to establish or generate a workspace or different tasks.

FIG. 3C illustrates another view of the network graph data structure 336 storing nodes representing the networking of the transportation and/or transformation of different networked items across a network, in accordance with an implementation. As illustrated, the network graph data structure 336 can include one or more sub-graph data structures 348a-b, 350, and 352. Each sub-graph data structure can represent or otherwise correspond to a value chain including a path for generating a respective networked item.

The respective sub-graph data structures 348a-b, 350, and 352 can each include a chain of nodes that represent different locations of facilities of a path for generating a networked item. For example, the sub-graph data structure 348a can include nodes 360a-e (together, nodes 360, and, individually, node 360). One or more, or all, of the nodes 360 can be the same as or similar to the nodes 346. The nodes 360 can be linked by edges to indicate the outputs and/or inputs of the nodes 360 to other nodes of the sub-graph data structure 348a to generate a networked item. The nodes 362c, d, and e can each be a source node of the sub-graph data structure because the nodes 362c, d, and e do not receive any inputs from another node (e.g., specifically for the sub-graph data structure 348a). The node 360a can be the last facility (e.g., the destination node) of the value chain represented by the sub-graph data structure 348a because the node 360a may not provide any inputs to another node of the sub-graph data structure 348a. The destination node 360a can be linked with a node 354 associated with the networked item generated by the value chain of the sub-graph data structure 348.

The sub-graph data structure 348b can be configured in a similar manner to the sub-graph data structure 348a. For example, the sub-graph data structure 348b can include nodes 366a-f (together, nodes 366, and, individually, node 366). One or more, or all, of the nodes 366 can be the same as or similar to the nodes 346. The nodes 366 together can represent a value chain for generate the same networked item as the nodes 360 of the sub-graph data structure 348a. The nodes 366 can include one or more common nodes (e.g., the same node) to the nodes 360, such as nodes that are configured to generate the same outputs as each other. The sub-graph data structure 348b can be linked with the node 354 for the profile of the networked item that the nodes 366 are configured to generate together.

A document 420a can be linked with the node 366a of the sub-graph data structure 348b and/or a document 420b can be linked with the node 366e of the sub-graph data structure 348b. The documents 420a and/or 420b can be records (e.g., electronic records) that were used to generate the respective nodes 366a and/or 366e. For example, the documents 420a and/or 420b can be or include attestations about the nodes 366a and/or 366e, attestations about networked items and/or outputs generated by the nodes 366a and/or 366e, bills of materials provided or associated with the respective nodes 366a and/or 366e, or any other types of documents or electronic records containing data about the respective nodes 366a and/or 366e and/or from which the data (e.g., attributes) of the nodes 366a and/or 366e was generated.

The sub-graph data structure 350 can be configured in a similar manner to the sub-graph data structure 348a. For example, the sub-graph data structure 350 can include nodes 368a-e (together, nodes 368, and, individually, node 368). One or more, or all, of the nodes 368 can be the same as or similar to the nodes 346. The nodes 368 together can represent a value chain for generating or creating the same networked item as the nodes 368 of the sub-graph data structure 348a. The nodes 368 can include one or more common nodes (e.g., the same node) to the nodes 368, such as nodes that are configured to generate the same outputs as each other. The sub-graph data structure 350 can be linked with the node 356 for the profile of the networked item that the nodes 368 are configured to generate together.

The node 368a can be connected with the node 356 for the profile of the networked item that the nodes 368 are configured to generate together. The node 368a can be connected with the node 356 by an edge 371. The edge 371 can be or include a data structure (e.g., an edge data structure) that is configured to identify the type of the connection. In this case, the edge 371 can store data indicating that the node 368 is the final node of the sub-graph data structure 350, an identifier of the sub-graph data structure 350 itself, an identifier of the networked item generated by the sub-graph data structure 350, an indication that the edge connects a node for a location or facility of the sub-graph data structure 350 with a node for a profile (e.g., a profile node) instead of representing a network operation, etc. The different sub-graph data structures 348a, 348b, and/or 352 may each be connected with a node for a profile of a networked item with a similar edge to the edge 371.

The nodes 368b and 368c may be connected by an edge 369. The edge 369 can be or include a data structure (e.g., an edge data structure) that includes data indicating a network operation between the entity represented by the node 368c (e.g., a source node) and the entity represented by the node 368b (e.g., a destination node). The network operation can be a transfer or a transportation of an instance of the network item (e.g., a portion of the networked item that will be eventually be transformed into the networked item or the networked item itself) from the entity of the node 368c to the entity of the node 368b. Together, the nodes 368b and 368c can be a pair of nodes because they are connected by an edge (e.g., the edge 369). The nodes 368b and 368c can be connected by any number of edges, as each edge may correspond to a different network operation. In some cases, the nodes 368b and 368c may be connected by different sets of edges that each correspond to a particular sub-graph data structure. Such may be the case when the nodes 368b and 368c are connected to generate different networked items as part of different value chains (e.g., in different sub-graph data structures). Thus, the edges may be specific to the sub-graph data structures in which the edges are depicted. The nodes of the different sub-graph data structures 348a, 348b, and/or 352 may respectively be connected with each other with edges similar to the edge 369.

The sub-graph data structure 352 can be configured in a similar manner to the sub-graph data structure 350. For example, the sub-graph data structure 352 can include nodes 370a-e (together, nodes 370, and, individually, node 370). One or more, or all, of the nodes 370 can be the same as or similar to the nodes 346. The nodes 370 together can represent a value chain for generate the same networked item as the nodes 368 of the sub-graph data structure 350. The nodes 368 can include one or more common nodes (e.g., the same node) to the nodes 370, such as nodes that are configured to generate the same outputs as each other. The sub-graph data structure 352 can be linked with the node 358 for the profile of the networked item that the nodes 368 are configured to generate together.

FIG. 3D is a sub-graph data structure 372 that represents an example value chain for the production of networked items (e.g., vehicle gearboxes). The sub-graph data structure 372 can represent supply and consumption tiers for generating or creating networked items and then distributing the generated networked items, in some implementations. For example, the sub-graph data structure 372 can include supplier nodes 346m-o that provide inputs to supplier nodes 346k-l as indicated by the edges and arrows between the nodes 346m-o and the nodes 346k-l. The supplier nodes 346k-l can use or transform the inputs to generate outputs that are input into the nodes 346i-j. The nodes 346i-j can use or transform the inputs to generate outputs that are input into the node 346h, as the source entity node. The source entity node 346h can generate the networked items 347 based on (e.g., by transforming) the inputs from the nodes 346i-j. The source entity node 346 can transfer the networked items 347 to nodes 346e-f The nodes 346e-f can distribute or transfer the networked items 347 or a transformed version of the networked items 347.

The data processing system 306 can implement the systems and methods described herein to generate the network graph data structure 336 representing one or more value chains in the sub-graph data structures 340, such as sub-graph data structures 340 with the following characteristics:
Accurate: The network graph data structure 336 may accurately describe the physical production and transportation processes, even if they are described in disparate messy documents in multiple languages.
Granular down to the part-site level: the part-site level is necessary to truly manage supply chains. Previous approaches have focused on the business network level or connection level, but these approaches fail to understand the fundamental physicality (locations and products) of the underlying value chains. The network graph data structure 336 may include specific details to ascertain what was the specific flow of a given product from raw materials to production, distribution, and sale. Failure to achieve this part-site level view results in such high levels of false-positives (erroneous links) that value chain analysis is impossible—participants are stuck in a mire of analyzing irrelevant business relationships.
Dynamically updating: the supply chain is constantly changing. To provide actionable intelligence, the network graph data structure 336 may evolve as production networks, site locations, and corporate relationships evolve. Thus, the system can automatically update while not losing track of relationship histories.
Consistent: To facilitate collaboration between participants whether their role in a value chain is suppliers, buyers, transporters, regulators, banks, insurers, or more, all participants may operate on a shared source of truth. One-off customer specific representations may fail to enable value chain management—they cannot be used as a basis for collaboration. The supply chain graph has to be consistent and linkable across all parties.
   To achieve these attributes the network graph data structure 336 may have the following characteristics.
1. Assembly: The intelligence on global value chains be assembled while respecting data sovereignty, security, and privacy. In other words, the system can have shared value-chain intelligence without sharing data.
2. Construction: The information can be harmonized into a network representation with the correct nodes and links.
3. Customization: Users can customize the resultant value chain maps with their organization specification information, groupings, and similar.
4. Value-chain specificity: The information can allow understanding of specific value chains at the part-site level of understanding. In other words, value chain understanding that is not at the company level, but rather facility-to-facility transactions can be understood in the context of the inputs they provide for the final product.

Nodes may include not only companies, but facilities, ports, products, and more. Edges may cover movement of goods, locations of facilities, ownership of companies, and more. Value chain management can include constructing a network graph data structure that covers more than just corporate relationships, but also the fundamental input-output relationships of product production. Such a part-site specific graph may allow part-site specific understanding of value chains at scale.

The network graph data structure 336 illustrated in FIGS. 3B and 3C can be constructed from both commercial and proprietary data. To do so, the system can obtain publicly and commercially available supply chain data. The system can focus upon datasets that describe physical movement of goods from facility to facility, rather than more abstract “business relationships.” In other words, documents such as bills of lading, manifests, customs declarations, and purchase orders. These documents can contain information on the sender, receiver, their addresses, the goods transported (both in free text and harmonized-system product category form), the ports, the vessels, and more. The system can augment the documents with commercially available information on corporate registries, sanctions lists, tariff incentives, and more.

However, public and commercially available data can be limited. For instance, such data may only be available for certain geographies and certain modes of transport. Operating on public data alone may not achieve the visibility necessary to solve the world's value chain problems—a disconnected, erroneous, or low-fidelity network doesn't help the participants. To understand value chains, system may need to be able to understand and connect the multiple stages of production from raw extraction through final distribution.

To do so, in some cases, the data processing system 306 can implement a federated system that permits each participant to have their own private “spoke” in which their data is secure and safe, but where derived analytics can be shared across desired participants. FIG. 3E demonstrates such a hub and spoke federated system 374, where all participants benefit from the derived analytics but sensitive information stays only with the participant that owns the information. Every participant can have a private enclave, in their jurisdiction of choice, where only they can see the entirety and fidelity of the data they put into the platform. Such participants are depicted in FIG. 3E as computing devices 304a-c, respective. Product details such as names, revenue, bills of materials, costs, supplier and customer experiences, and analytics on their supply chain are always private, never shared and only exist within each enclave. Third-party data procured by participants such as ESG scores, revenue importance, and custom calculations similarly privately enriches the individualized deployments. This functionality allows participants to wire in their own private information to the network graph data structure so they see a unified view of their world connected into the global map. Each participant benefits from seeing their data, kept for their private usage in their private enclave, bound to more visibility than any one country, let alone one company, has access to.

Participants can publish and share minimal information on linkages to allow mutual engagement and tracing of value chains. By sharing this minimal information on linkages, all participants can benefit from connectivity of the network graph data structure 336—the ability to traverse through multiple tiers. This connectivity can provide essential value to all participants, as it allows the participants to understand and manage their value chains across all stages of production. For this reason, the network graph data structure 336 can enable a collaborative supply chain graph, while preserving contributors' privacy, and competitive advantages.

The shared graph of intelligence assembled via the hub and spoke architecture can be constructed from documents with erroneous or woefully incomplete information. They frequently lack the detail necessary to go down to the part-site level. The data processing system can extract signal from the noise through the following steps: (1) recognizing and matching entities such as companies, addresses, ports, and products in many languages, robust to misspellings; identifying and correcting erroneous information, such as incorrect addresses, values, product categories (e.g., HS codes), and more; (2) imputing missing information, whether that is missing product categories, address components, values, or otherwise; and (3) solving these challenges can involve state-of-the-art machine translation, entity resolution, link resolution, deduplication, cross-linking of information, and domain specific optimizations to connect the data together in both a granular and scalable manner.

The data processing system 306 can leverage both classic machine learning and modern deep learning, including graph based approaches. Table 1 below provides an example of transformations of raw messy shipment information into canonicalized standardized representations.

| | | Canonicalized |
|---|---|---|
| Type | Original raw text | representation |
| Company | from warehaus rivilogistics by Globex | Globex |
| Company | AKMe Ko B Ka3axcTaHe | Acme Co. |
| Address | 2 a calle 8 s n 53370 naulcalpan de juarez | Calle 8 No. 2 A, Industrial |
| | naucalpan de juarez | Alce Blanco, Naucalpan De |
| | | Mexico, |
| | | Juarez, Mexico, 53370, |
| | | Mexico |
| Product | Ladies 90% cotton 7% tencel 3% elastane | 6204.62.8011 (US |
| | woven denim pant | Harmonized Tariff System |
| | | Code) |
| | | Articles of apparel and |
| | | clothing accessories, not |
| | | knitted or crocheted— |
| | | women's or girls' suits, |
| | | ensembles, suit-type jackets, |
| | | blazers, dresses, skirts, |
| | | divided skirts, trousers, bib |
| | | and brace overalls, breeches |
| | | and shorts (other than |
| | | swimwear):—trousers, bib |
| | | and brace overalls, breeches |
| | | and shorts: of cotton:—other: |
| | | other: other: other—other: |
| | | women's trousers and |
| | | breeches: blue denim (348) |
| Product | [symbol] [symbol] [symbol] [symbol] [symbol] [symbol] [symbol] | 3006.20.00 |
| | | (Gulf Cooperation Council |
| | | Harmonized System Code) |
| | | [symbol] [symbol] [symbol] [symbol] |
| | | [symbol] [symbol] [symbol] [symbol] [symbol] |
| | | [symbol] [symbol] [symbol] [symbol] [symbol] |
| | | [symbol] [symbol] [symbol] \| Blood-grouping |
| | | reagents |

The data processing system 306 can perform the following operations to generate Table 1 and similar tables:
map the raw fields to standardized fields;
use one or more artificial intelligence (AI) systems to parse fields with multiple values (e.g., name+address) concatenated into one field;
use AI systems to structure unstructured fields (e.g., address not structured by administrative granularity) into structured representations (e.g., a structured address);
use AI driven search systems to take obscure/opaque/vague descriptions and expand them (e.g., take a goods description that is just a parts number from a company specific parts database and replace it with a detailed description of that product); and
use AI systems to match to canonical representations based on a semantic understanding of the entity (e.g., company, address, product) regardless of what language/misspellings it has.

The data processing system 306 can perform this canonicalization based on the text description as well as contextual information such as involved parties, involved products, etc., in the raw document. The end result is both a canonical description of the entity and a canonical ID by which the entity can be referenced. If no canonical entity already exists, the data processing system 306 can create one.

The data processing system 306 can identify and correct erroneous or missing information functions in a similar manner. For example, the data processing system 306 can use AI systems to predict the field's information. If it differs from the provided original information, the data processing system 306 can flag and correct the discrepant information (e.g., an erroneous product code or monetary value). If it's empty, the data processing system 306 can predict the correct value. In both cases, there is a measure of confidence in the prediction that is calibrated for at least a threshold accuracy/quality. One particularly notable correction is for supplier addresses. In some cases, customers have supplier lists that either have no address information or provide the supplier's HQ, not the true production facility address. The distinction, and the data processing system 306's systemic correction of this error can be used accurate construction of part-site specific value chains.

Users of the network graph data structure 336 may customize the network graph data structure 336 with their organization and user-specific information. Users may do so, for example, through:
1. Addition of organization-specific scores and values: For example, internal parts numbers for products, ESG scores for different facilities, previous return rates on investment in trade financement.
2. Organization/user-specific groupings of entities: the ability to group multiple entities (e.g., companies, facilities, products) represented in the network graph data structure into one grouping. For example, an organization may wish to see all the activity of a given supplier cohort grouped together, ignoring distinctions between the underlying companies.
3. Attachment of source documents and files: Backing files serving as backing information for the entities.
4. Storage of notes: Specific additional information provided by users and organizations on the entities.

The data processing system 306 can provide above capability in customer private-enclave-specific (e.g., spoke specific) instances. In doing so, the data processing system 306 can provide each customer with the capability to customize the network graph data structure 336 as necessary for their organization. The sensitive information described herein may stay in each private deployment and, in some cases may never transmitted back to the hub.

Additionally, understanding physical production and acting upon the physical production can require understanding the steps from raw material extraction through final distribution. Within their private enclave, customers may have their bill of materials for their products. However, they may not have the recursive bill of materials—the inputs for their inputs or the inputs resulting from their outputs. This information may be required to understand the original and intermediate processing that led to the product, as well as the intermediate and final consumption, as illustrated in FIG. 3D.

To construct this understanding, the data processing system 306 can integrate, in the private enclave, the customer's bill of material information. Combined with the customer's supplier list, this gives the first tier understanding of production facilities and inputs for each customer product. Then, the data processing system 306 can apply an AI-based understanding of input-output relationships to understand value chains to understand the network of production conditional on the good being produced. The data processing system 306 can use the network graph data structure 336 to filter a set of relationships to only include the value chain for a vehicle gearbox, for example, while disregarding all irrelevant links and associations related to other goods at the same facility. The data processing system 306 can do so by producing and applying a recursive map of the relationship between inputs and outputs, a function estimating the “bill of materials” for all physical goods. Using deep learning, graph information/modeling, and generative AI, the data processing system 306 can derive this input-output relationship for all goods, thus allowing the refinement of site-specific exchange of goods to be conditional on specific products. This understanding can then be refined, in some cases, by a human collaborating with internal and external parties.

The resultant graph of global value chains may be, post-harmonization, gigantic in size, in some cases including billions of transactions linking 100s of millions of entities. The data processing system 306 can identify the most relevant parts of the network graph data structure, individual entities, shipments or sub-networks (“sub-graph data structures”) involving companies, addresses, products, shipments, ports. The data processing system 306 can do so using cutting edge AI, exceptional engineering, deep product understanding, and insightful design to achieve these tasks. The underlying systems and industrial ecosystems represented by the network graph data structure are complex, and easy answers are uncommon. The data processing system 306 can implement the systems and methods described herein to generate and process the network graph data structure 336 for:
Compliance: Complying with and enforcing environmental (e.g., Scope 3, deforestation, etc.), human rights (e.g., forced labor), tax/tariff/duty, national security, and other laws and regulation across multiple country's regulatory environments.
Sourcing and procurement: Analyzing existing and potential suppliers and buyers at scale across 10s of thousands or more relationships.
Resiliency: Proactively and reactively understanding potential disruption to value chains at the scale of multinational corporations or nations. Analyses include understanding bottlenecks, exposure to current or potential adverse events (e.g., a factory being destroyed), multi-tier exposure to geopolitically risk geographies, and more. Such resiliency is critical to continued corporate operation as well as economic and national security.
Insurance: Usage of the above resiliency information to offer and price novel forms of business-interruption coverage. Understanding resiliency at scale enables origination and pricing of insurance that could not profitably previously be offered due to lack of information on the extended value chain. Contingent business interruption insurance, insuring against extended disruptions in the value chain, was previously unavailable at desired volumes due to the difficulty of understanding extended value chain relationships. Insurers can now offer such insurance while understanding extended risk and concentrations, and insureds can benefit from the surety that such insurance brings.
Trade facilitation and prevention of illicit activity across borders: Logistics parties, multinational corporations, and governments can collaborate together to ensure facilitation of legitimate cargoes and targeting of illicit activity. Positive value chains are promoted and aided in filing of required paperwork, negative value chains (such as narcotics production) are impeded.

The data processing system 306 has several features that facilitates generation and processing of a network graph data structure that represents a real-time version of multiple value chains. For example, the data processing system 306 can use security features such that the represented data remains safe using information security programs, secure software development lifecycle, and segmenting customer accounts. The data processing system 306 may be deployed into various secure environments across the globe. These controls help service the goal of securing data.

Another advantage is that the system supports granular role-based access controls to put individual organization's administrators in control of who in the organization can see which details, as well as external collaboration with other parties.

In some cases, in the context of sensitive applications, the data processing system 306 can support selection and vetting of which specific users (e.g., government-associated users) can access private deployments. The most standard use case is for public sector deployments where all access must be done by vetted/security-cleared individuals, often from that nation.

In some cases, the data processing system 306 may never share raw data between spokes without explicit instructions for collaboration between trusted parties. The default may be that no direction is enabled. Rather, the system can facilitate sharing of network visibility, analytics, and shared AI models without moving raw data.

The data processing system 306 can provide individual customers a private enclave where they, and only they, can see the entirety of the data their organization puts into the platform. Product details such as name, revenue, bill of materials, costs, supplier and customer experiences, and analytics on the customer's supply chain are always private, never shared and only exist in the private enclave. They are processed and harmonized with the network graph data structure's broader multi-tier view while remaining within that individual enclave.

To facilitate the value chain network function, and connections between buyers and suppliers in multi-tier value chains, the data processing system 306 can facilitate minimal linkages necessary for engagement. After normalizing and canonicalizing the entities to the network graph data structure in the private-enclave, the data processing system 306 can anonymously connect the minimal details of a supply chain linkage to the central network graph data structure. These details include: the sender and receiver companies and locations; an intentionally vague description of the goods such as an HS code or summarized description; and the month of the transaction.

The source of the derived links derived via this canonicalization and anonymization may not be revealed to any other clients. This shared intelligence may allow each customer to in turn receive and connect to linkages provided by others.

The data processing system 306 can be, include, or otherwise interact with a federated learning system to generate the network graph data structure 336 and generate metrics and intelligence across users or entities. Federated learning is a field of machine learning focused on how to learn in a privacy preserving manner that does not share nor combine data. One example of use of federated learning is customization of suggestions when an individual types on a cell phone. The system learns across many devices by learning on the device and never transferring the raw data, only the trained model, back to a central hub. All users thus benefit without ever sharing any typing history such as passwords, loved ones' names, or full messages back to the cloud.

The data processing system 306 can implement federated learning across a number of features of generating and processing the network graph data structure 336. In doing so, the data processing system 306 can preserve user privacy while providing the benefits of aggregating data from a large number of data sources. Examples of how the data processing system 306 uses federated learning include the following:

Value chain construction: Many facilities receive shipments of coffee, but these are very unlikely to be relevant to a particular product's specific value chain. As such, the data processing system 306 can implement a process which smartly builds product value chains from the network graph data structure creating specific and granular understanding down to the material category, type of input (e.g., ingredients, capital goods, packaging). Customers can engage and refine these value chains which further contributes to quality of this machine learning construction. The customer provided feedback, as well as rich product descriptions, and relationships may all be private to the users that provide the data. The data processing system 306 can train across the feedback on those classifications in a privacy preserving manner and such that each user may benefit from other customers' refinements. This technique has shown significant improvement in quality of value chain construction both within and across industries when compared to expert review.

A value chain can be constructed as a network graph data structure to provide the technical foundations of value chain management. The network graph data structure can be used to identify missing information or deficiencies and identify risk probabilistically. Users can collaborate in a risk/impact-oriented manner on top of the network graph data structure For example, the network graph data structure 336 can be used to generate or support product passports and trade facilitation.

Harmonized System (HS) Classification: Assigning HS codes to products may determine tariff rates and other global trade related requirements. Determining the appropriate HS code for a product is difficult, however, and most practitioners outside of customs don't know how to classify products correctly. The data processing system 306 can include suite of tools for both assigning HS codes to products as well as explaining these according to the general rules of interpretation, and using previous rulings from customs or similar agencies to support a classification. To properly do this requires detailed product descriptions that are private to individual users. As such, the data processing system 306 can use federated learning to achieve these processes, while preserving the privacy of users' information, and enabling users to benefit from other users' refinements of the classifications.

Trust scores: Shipment fraud and illicit goods may affect all players in the logistics and shipping space. To facilitate cross border trade, the data processing system 306 can generate a trust score based on customers' shipment interdiction history, proximity to sanctions, shipper history, and other attributes. These details may be private to customer relationships, however, all participants in the space would benefit from being able to identify contraband and smuggling better. The data processing system 306 can use federated learning across the participants working in these areas to better identify shipment fraud and facilitate expedited clearance while preserving the privacy of each participant's specific history and never pooling any customer data together.

The hub and spoke of generating and processing the network graph data structure 336 can be applied for multiple internal departments/agencies to collaborate within or between governments. For example, the hub-spoke architecture described herein can facilitate secure collaboration within and across government agencies and governments themselves. The data processing system 306 can generate private copies of the entire architecture, and thus a private network/“intranet” of value chain information and collaboration may be generated. This architecture can thus enable collaboration between different departments/ministries without different rights to access different data. Furthermore, they can enable shared intelligence across national boundaries for sensitive national security and economic security use cases that require multi-national collaboration between cooperating/allied nations. Combined with the role-based access controls and government-ready secure deployments described above, the data processing system 306 can enable secure collaboration.

In some cases, the data processing system 306 may not synchronize any information, including derived information such as network visibility, analytics, or AI models, back to the hub from national deployments. In other words, national security users benefit from the platform provided by the data processing system 306 in support of their missions, and are given new abilities to collaborate with the private sector in service of security, economic growth, and resiliency through a shared source of truth, but maintain the classification levels and security of their agencies and departments.

In some cases, to preserve privacy and security, the data processing system 306 can transmit copies (e.g., versions, dedicated copies, dedicated version, etc.) of the network graph data structure 336 to the different computing devices 304 of the hub-and-spoke system. The copies can be dedicated copies for the respective computing devices 304, such that the computing devices 304 only receive data that the computing devices 304 are authorized (e.g., via stored permission of profiles for the computing devices 304) to receives. For example, the data processing system 306 can generate a copy 375 of the network graph data structure 336. The data processing system 306 can generate the copy 375 by identifying the data of the network graph data structure, such as the types of data, edges connected with specific nodes, specific nodes, etc., that the computing device 304d is permissioned or authorized to receive, view, or access. The data processing system 306 can identify such data by applying a schema or a set of rules or permissions stored in a profile for the computing device 304d or the entity associated with the computing device 304d. The data processing system can use such permissions to retrieve that that the computing device 304d is authorized to access, and generate a copy 375 of the network graph data structure 336 only with the retrieved data. The data processing system can transmit the copy 375 of the network graph data structure 336 to the computing device 304d. In this way, the data processing system 306 can preserve the privacy of certain types of data for different nodes, while still providing different spokes of the federated system with access to the network graph data structure 336.

By implementing the systems and methods described herein, the data processing system 306 can generate a network graph data structure using a hub-spoke federated learning system with privacy preserving techniques to provide industry-wide insights while protecting confidential information.

FIG. 3F illustrates an example flowchart of a process 376 for network graph data structure-based networking, in accordance with an implementation. A data processing system (e.g., the data processing system 306, shown and described with reference to FIG. 3A) can perform the process 376 to generate and/or update a network graph data structure representing the network between facilities for networked item transformation and/or transportation. The process 376 can include any number of operations or additional operations and the operations may be performed in any order.

At operation 378, the data processing system can receive one or more electronic records. The data processing system may receive the electronic records from one or more computing devices of different facilities that are involved in a network of value chains representing the transport and/or transformation of networked items.

At operation 380, the data processing system can parse the one or more electronic records. The data processing system can parse the records using natural language processing techniques and/or language processing models to identify specific entities or data included in the electronic records. The data processing system can store the parsed data in a database, such as a system of record that maintains the data for the network of value chains.

At operation 382, the data processing system can generate nodes in a network graph data structure. The data processing system can generate the nodes based on the electronic records and/or the parsed data such that each of the facilities corresponds to a different node in the network graph data structure. Each of the nodes can include node field-value pairs for different characteristics or attributes of the facilities represented by the respective nodes.

At operation 384, the data processing system can connect nodes in the network graph data structure. The data processing system can connect the nodes in the network graph data structure with edges. Each edge can represent a different network operation or transaction. For example, an edge between two nodes can represent transport of a networked item or component from one facility to another facility. The data processing system can generate any number of edges between pairs of nodes.

Each edge can be or include a data structure. The data structure can include data about the relationship indicated by the edge between the nodes. For instance, the data structure can include an identification of the networked item transported between nodes, a time and/or date of the transportation, a quantity, etc.

At operation 386, the data processing system can generate one or more networked item digital records. The data processing system can generate the networked item digital records in response to one or more requests to generate the digital records, for example. The data processing system can generate a networked item digital record by identifying one or more nodes or sub-graph data structures of the network graph data structure to include in the networked item digital record. The data processing system can identify such nodes or sub-graph data structures based on identifications of the nodes or sub-graph data structures in a request. The data processing system can generate the networked item digital record to include identifications of each of the identified or nodes or sub-graph data structures and/or the data structures of the nodes or sub-graph data structures themselves. In some cases, the data processing system can include an identification of a networked item profile or the networked item profile itself in the networked item digital record. The data processing system can generate and store such networked item digital records in the network graph data structure or a separate database in a file. Subsequently, the data processing system can transmit the networked item digital record to another computing device to either provision the computing device with access to the data structures (e.g., the nodes, the networked item profiles, the sub-graph data structures, etc.) identified in the network graph data structure and/or provision a copy of the data structures included in the networked item digital record to provide a view of the data represented in the networked item digital records.

Implementations of the current solution provide systems and methods of addressing technical challenges in network systems, focusing on the real-time construction of node graphs, faster data retrieval methods, federated system controls, and communication across network systems. First, the solution tackles the complexity involved in representing large-scale permutations of input-output relationships within node graphs. These graphs can be constructed in real-time and accommodate dynamic updates to maintain an accurate end-to-end matrix of relationships. Second, improvements to data retrieval processes are implemented by structuring node graphs into sub-graph data structures that represent specific value chains for specific networked items across networking systems. These improvements allow for targeted access to pertinent data and reduce computational overhead through intelligent navigation and traversal of the edges of the graph. Federated systems offer data privacy by implementing controls over node graph sharing. Data can be segmented within private enclaves, accessible only to authorized entities, while insights are shared without the transmission of raw or proprietary data. Furthermore, the architecture facilitates seamless communication and collaboration between systems and users across value chains over the complex network. This configuration enables efficient data updates and retrieval over the network, providing real-time synchronization, reduced latency, and improved coherence within interconnected systems.

The technological problem addressed by real-time construction of a node graph centers on the complexity and scalability of mapping intricate input-output relationships within large-scale systems. Conventional systems often encounter difficulties when attempting to represent the extensive permutations of transactional and procedural interactions across an entire network. As such, limitations in processing capabilities hinder the ability to produce comprehensive and dynamic models, resulting in fragmented or incomplete depictions of these relationships. This constrains computing system ability to analyze, plan, and improve processes across large scale networks and systems that are useful for more efficient operations.

The techniques described herein provide a technical solution through the development of a node graph architecture designed for real-time integration and analysis of large data sets. This architecture can dynamically construct node graphs that encapsulate different permutations of input-output connections within an end-to-end framework. Advanced algorithms can be deployed to continuously update and reconcile the graph structure as new data inputs become available. This includes identifying and relating comprehensive network nodes, allowing the system to seamlessly integrate diverse data points and maintain an up-to-date, accurate representation of the large scale network that continuously grows and changes.

The implementation of real-time node graph construction results in several technical enhancements. This construction provides continuous data integration into the node graph with continuous updates to the nodes and the edges between nodes within the node graph, ensuring that systems have up-to-date information streams. Accordingly, the construction can eliminate or reduce latency in data availability. The node graph structure facilitates efficient data indexing and retrieval, allowing for faster access to pertinent system relationships than conventional systems data storage and retrieval techniques or data storage and retrieval techniques that involve a node graph data structure. This capability can facilitate swift propagation of updates across the system, thus enhancing the system's responsiveness and scalability.

The technical problem addressed by improving data retrieval in node graphs entails the inefficiencies and inaccuracies associated with accessing relevant information from complex graph data structures. Conventional methods of data retrieval can struggle to efficiently navigate vast graph networks, especially when attempting to extract pertinent details related to sub-graph data structures that represent specific value chains. These challenges arise from redundant or unoptimized search processes, which often lead to increased retrieval times and higher computational costs, while failing to effectively pinpoint or prioritize the most relevant data subsets necessary for analysis.

The techniques described herein offer a technical solution by implementing advanced data retrieval through the structure of node graphs, particularly focusing on sub-graph data structures within these networks. This solution includes algorithms that can intelligently navigate the node graph, identifying sub-graph data structures that correspond to specified value chains or sub-graph data structures. Such algorithms can improve search paths and employ heuristic techniques that reduce retrieval time and computational overhead. By structuring data access around the segmentation of the graph into sub-graph data structures, the system can more efficiently target and extract relevant information.

The improved data retrieval techniques yield several technical enhancements in accessing and utilizing specific subsections of a broader node graph. These techniques increase the precision of data query results, ensuring high accuracy by effectively filtering out irrelevant data points. They also enhance retrieval efficiency that reduce query response times, allowing fast access to relevant data subsets. This facilitates real-time data analytics capabilities, enabling systems to quickly process and analyze specific value chain segments. The improved retrieval mechanisms support enhanced data throughput and minimize bottlenecks in information processing, contributing to the system's overall responsiveness. Additionally, these techniques improve and/or optimize computational resource allocation by minimizing data redundancy and ensuring efficient utilization of processing power across networked system.

The technical problem associated with federated systems and the control over node graph sharing arises from the need to balance collaborative data integration against data privacy and sovereignty constraints. In traditional centralized data systems, sharing comprehensive data sets poses risks to confidential information and often violates regional data protection regulations. As organizations engage in shared networks, the challenge is to allow effective collaboration while ensuring that sensitive elements of the node graph remain protected and are only shared with authorized entities.

The techniques described herein introduce a federated system architecture designed to control specific node graph sharing, thus mitigating privacy concerns while still facilitating collaborative benefits. This system can segment the node graph into isolated private enclaves for each participant. Within these enclaves, data remains secure and local, accessible solely to the owner. Federated learning techniques are employed to derive shared insights without actual data transmission, enabling the selective sharing of insights rather than raw data. The system allows participants to define granular sharing controls, specifying which segments of the node graph are accessible and under what conditions, ensuring alignment with privacy and regulatory standards.

The implementation of federated systems with controlled node graph sharing results in several technical improvements. These systems uphold robust data privacy through decentralized data management, minimizing the risk of exposure by keeping data within local storage environments. By utilizing federated learning, the system aggregates insights without raw data transfer, maintaining data integrity and sovereignty across network nodes. This decentralized approach reduces the attack surface for potential breaches, significantly enhancing system security. Additionally, the architecture enables seamless integration of proprietary data into a collective analytical model, optimizing inter-organizational data processing without compromising the proprietary data. This configuration allows for efficient parallel processing and model refinement, facilitating advanced analytics and machine learning applications across distributed environment

The technical problem in networked systems, particularly within the context of systems operating across the value chain, is the challenge of seamless communication and data exchange with a central system. Traditional networked systems often experience latency, data inconsistency, and bottlenecks when numerous disparate systems attempt to update and retrieve information over a central network. These issues are exacerbated by the scale and complexity inherent in value chains, which traverse multiple entities and geographical locations, necessitating robust and efficient communication mechanisms to maintain coherence and synchronization of data across the network.

The techniques described herein propose a technical solution through the implementation of an advanced graph node architecture that facilitates efficient communication between systems across the value chain and a central system. This solution can involve configuring the central system as a nodal hub, where each node in the architecture represents specific entities or processes within the value chain. These nodes are interconnected in a manner that reflects the actual input-output relationships, allowing for streamlined data propagation and retrieval. The architecture can employ algorithms that dynamically adjust node connections based on network traffic, ensuring optimized data routing that minimizes latency and improves overall efficiency.

The implementation of a graph node architecture within networked systems enhances several technical aspects across the value chain. First, the architecture enables real-time data synchronization, reducing discrepancies and mitigating the risk of data inconsistency. This facilitates immediate data availability, enhancing the precision of analytics and decision-support systems. Second, the intelligent routing algorithms adjust node connections dynamically, which optimizes data flow and reduces latency throughout the network. This results in faster data processing times and improves system responsiveness under varying load conditions. Additionally, the architecture inherently supports fault tolerance by maintaining alternative pathways for data communication in the event of a node failure, thereby ensuring continuous operation and system reliability. Overall, the advanced graph node architecture strengthens the technical infrastructure needed for efficient data exchange, contributing to a more robust and agile value chain network.

The technical problem associated with tracking real-world events, processes, and occurrences, such as the production and transportation of goods within a graph node system, stems from the complexity of accurately representing and managing the dynamic and interconnected nature of these physical activities. Traditional systems often lack the capability to integrate multiple aspects of physical processes, such as changes in location, status, and characteristics, within a cohesive and responsive framework. This leads to inefficiencies in monitoring the transformation and movement of goods, making it challenging to manage logistics, ensure compliance with transportation restrictions, and capture the nuanced transformation characteristics of inputs into outputs.

The techniques described herein provide a technical solution through the implementation of an intelligent node graph system that can model and track the multifaceted physical nature of production and transportation events in real time. The system can use advanced data analytics to map and update each node's attributes as goods progress through various stages of their lifecycle, such as from production, through transportation, to final transformation. Each node within this architecture can represent specific goods, transportation modes, or transformation processes, capturing relevant data points, such as location, condition, and transformation metrics. This setup allows the system to dynamically allow or restrict transportation based on predefined criteria and regulatory requirements, integrating these constraints into the decision-making functionality governing the network.

The implementation of this graph node system results in several technical effects useful to managing physical processes. The system enhances data acquisition and integration capabilities by providing precise real-time updates of physical attributes and changes within the network. This significantly improves monitoring accuracy by reducing dependency on manual tracking, thereby minimizing tracking errors. The architecture supports the orchestration of logistics operations by facilitating data-driven adjustments and enabling instantaneous data updates to relevant nodes. Automated enforcement of transportation restrictions through system integration enhances compliance and regulatory adherence within the network. The standardized data framework within the system supports interoperability across different technological platforms, facilitating seamless data exchange and system integration. Overall, the system optimizes computational resources by structuring heterogenous data inputs into a cohesive, scalable architecture, improving the overall reliability and efficiency of monitoring physical events and processes.

The technical problem related to enabling collaborations between users on a graph network while tracking products lies in the challenge of facilitating seamless and secure data exchanges among diverse entities. Traditional systems struggle with synchronizing real-time updates and ensuring compatibility across different data formats. Moreover, protecting sensitive information while still allowing effective collaboration presents a significant technical hurdle. These issues can lead to inconsistencies and inefficiencies, impacting the effectiveness of the collaborative workflow.

The techniques described herein offer a technical solution through the development of an advanced graph network architecture. This architecture supports secure, real-time collaboration by employing cryptographic protocols and robust access controls, ensuring that data confidentiality is maintained. It provides mechanisms for integrating diverse data inputs into a cohesive structure, enabling consistent updates and data visibility across the network. By implementing dynamic access controls, the system can facilitate efficient information sharing that aligns with user roles and collaborative activities.

The implementation of this collaborative graph network results in several technical effects. The system ensures real-time data synchronization across users, minimizing discrepancies and enhancing the consistency of information. Secure data exchange can be facilitated through encryption and access control measures, restricting access to authorized users and preserving data confidentiality. The architecture integrates disparate data inputs into a unified format, enhancing data coherence across various systems. Additionally, adaptive management of user permissions through dynamic access controls enables efficient collaboration, ensuring data sharing aligns with security policies. These improvements contribute to a more resilient and efficient framework for tracking products and facilitating user collaboration within the graph network.

The implementations of embodiments of the present solution results in several technical advancements that significantly enhance system capabilities. Improved data retrieval algorithms ensure high accuracy and reduce query response times, facilitating real-time analytics. Intelligent node graph constructions can enable continuous data integration, precise monitoring, and efficient parallel processing, improving resource allocation and system responsiveness. Federated systems can uphold data privacy while allowing collaborative information sharing, enhancing system security and integrity. Advanced graph node architectures can provide real-time synchronization and fault tolerance, contributing to robust data exchange across the value chain. Systems for tracking physical events and facilitating user collaboration improve monitoring accuracy and regulatory compliance while supporting seamless data integration and communication. Overall, these solutions collectively optimize system reliability, efficiency, and the technical infrastructure needed for streamlined operations across complex network systems.

### D. Compromised Network Operation Detection and Mitigation

Network environments face increasingly sophisticated threats where malicious actors attempt to disguise illicit operations within the vast volume of legitimate network traffic. Computers implementing security approaches that rely on analyzing individual network operations in isolation frequently fail to detect these threats because they lack the contextual understanding necessary to identify subtle patterns of suspicious activity across complex networks. These methods generate excessive false positives that overwhelm security teams, while simultaneously missing truly compromised operations that have been deliberately structured to appear legitimate when viewed in isolation.

Another technical problem exists in the analysis of unstructured data associated with network operations. Network operations often involve text descriptions that contain indications of compromise, but security computing systems often struggle to extract meaningful insights from this unstructured information and correlate it with the structured relationship data that defines network connections. This disconnect between textual content analysis and network topology assessment can create substantial blind spots that can be exploited by malicious entities who manipulate their operations to avoid detection.

A computer implementing the systems and methods described herein can overcome the aforementioned technical deficiencies. The computer can do so, for example, by using a graph data structure-based approach that analyzes the relational context of network operations between nodes. The computer can identify and traverse relevant sub-graphs connected to both source (e.g., origin) and destination (e.g., final destination) nodes (e.g., through intermediary nodes), the computer can identify multi-hop relationships and patterns that would remain invisible to network operation-level analysis. This contextual evaluation can facilitate the detection of compromised operations that have been deliberately structured to conceal their true nature through intermediaries or complex network paths.

The computer can further address the unstructured data analysis problem by using natural language processing techniques to transform text descriptions into embeddings that can be computationally analyzed alongside structural network data. In some embodiments, embeddings from text descriptions are combined with embeddings (e.g., combinations) of other descriptive information. Text descriptions and other descriptive information or attributes may also be combined prior to being input to the embedder. The computer can generate such embeddings and feed the embeddings into an ensemble of models (e.g., machine learning models) with other data retrieved from the sub-graphs to identify linguistic patterns that may indicate attempts to disguise illicit transfers, while correlating these textual signals with the relationship patterns identified from the data retrieved from the sub-graphs. The computer can use the ensemble of models to generate risk scores for the network operations that each indicate a likelihood that a particular network operation is compromised.

The computer can use the generated risk scores to restrict or otherwise mitigate compromised network operations. For instance, responsive to determining a risk score for a network operation exceeds a threshold, the computer can restrict the network operation by transmitting a message to a computing device that transmitted a request identifying the network operation. The message can be configured to stop the network operation. The computer can stop or restrict the network operation based on the message. Accordingly, by implementing the systems and methods described herein the computer can immediately restrict potentially compromised network operations before they are completed, preventing completion of compromised network operations. This automated response capability can reduce the security vulnerability window that exists between detection and intervention in other systems.

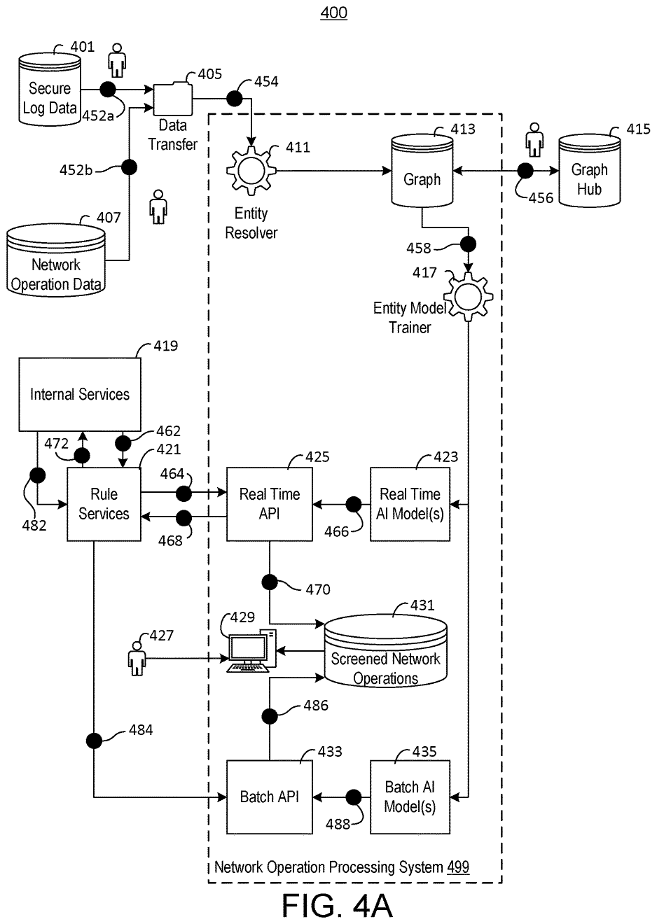

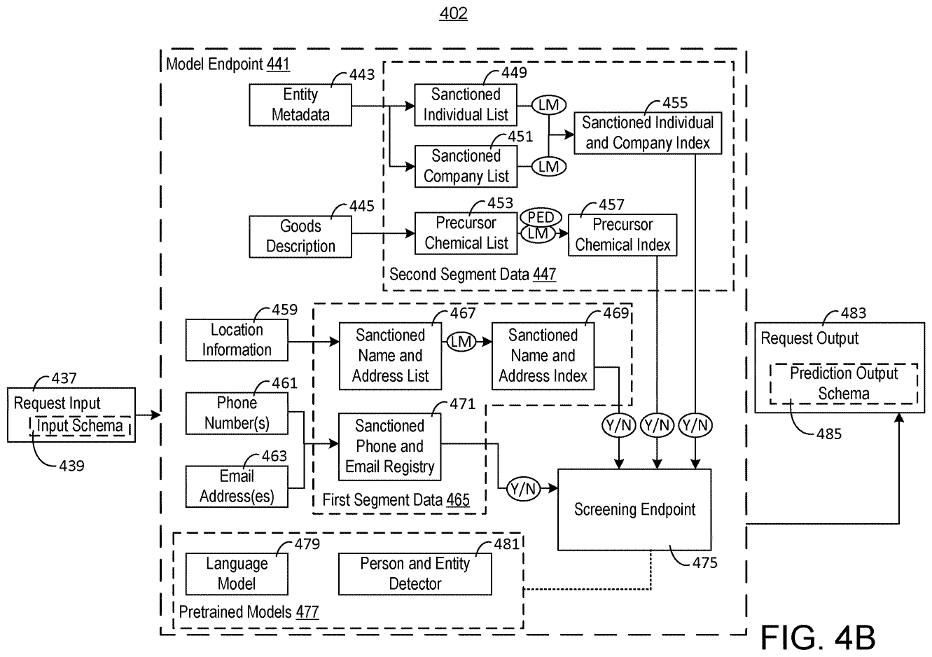

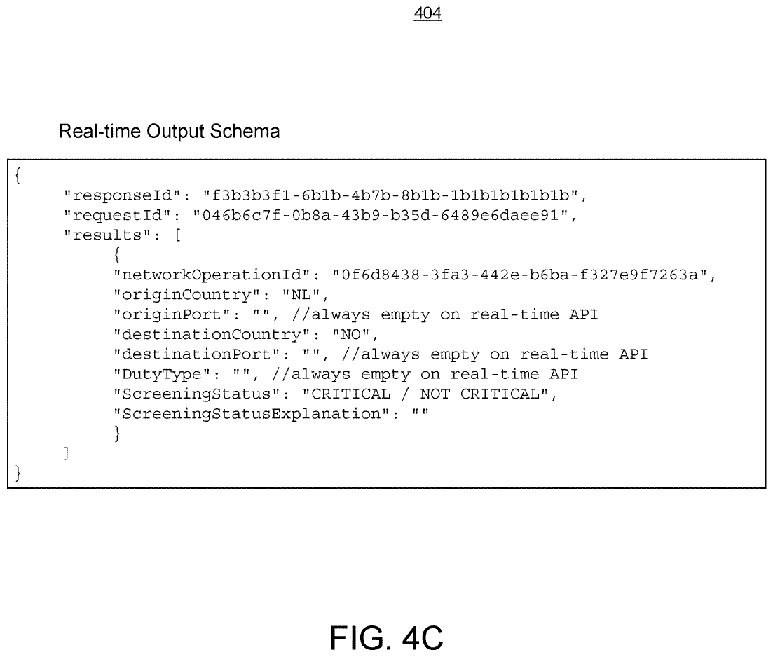

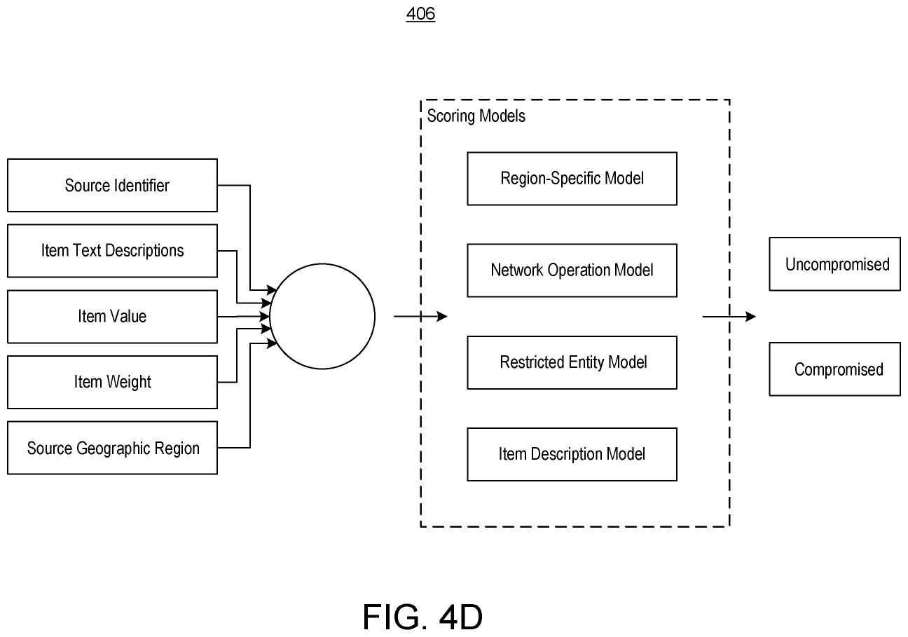

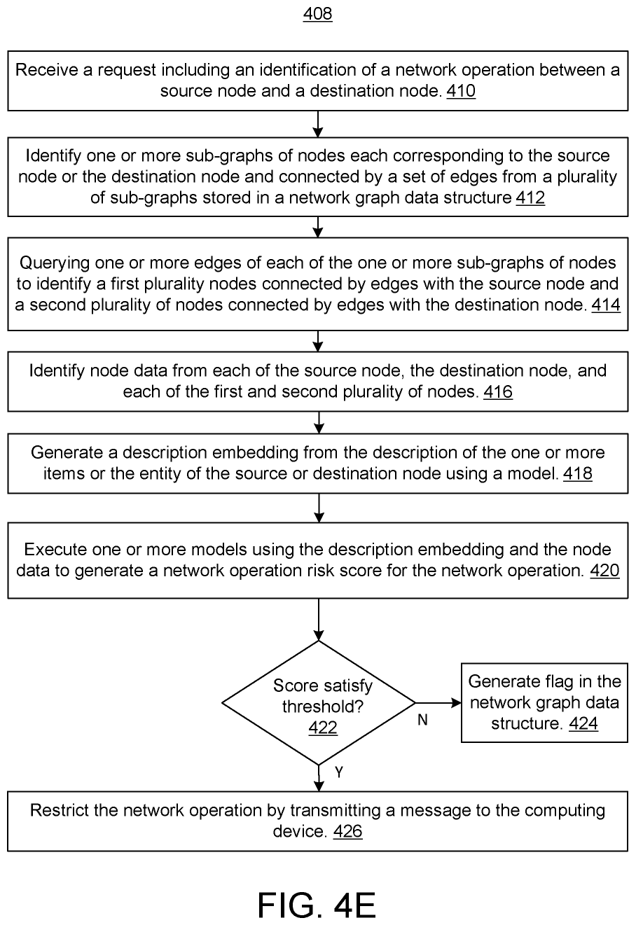

FIG. 4A is a data flow diagram of a system 400 for compromised network operation detection, in accordance with one or more embodiments. A data processing system (e.g., the data processing system 306, shown and described with reference to FIG. 3A) can be configured within the system 400 to detect compromised network operations. The system 400 may be configured to perform a number of operations to detect compromised network operations. FIG. 4A illustrates three sequences performed that can be performed by the system 400 according to some embodiments. For example, the system 400 is shown to perform a training sequence including operations 452-458, a real-time detection sequence including operations 462-472, and a batch detection sequence including operations 482-488. It is understood that the sequences performed by the system 400 can include any number of operations or additional operations and that the operations may be performed in any order.

As shown in FIG. 4A, the system 400 includes a network operation processing system 499. The network operation processing system 499 may be configured to receive data from various sources, for example, entities responsible for performing the network operation and process the network operation to generate one or more AI models. APIs are provided by the network operation processing system 499 for to provide access points to various services related to the detection of compromised network operations. The network operation processing system 499 is shown to include an entity resolver 411, a graph database 413, an entity model trainer 417, one or more real-time AI models 423, a real-time API 425, one or more batch AI models 435, a request input 437, a screened network operations database 431, and a user interface 429.

A network operation may include the exchange of information, value, or goods across a distributed system or network. A network operation may include information (e.g., data, etc.) transfer between networked computers. For example, the networked operations may include email transfer, file uploads or downloads using protocols such as file transfer protocol (FTP) or secure file transfer protocol (SFTP), API requests, messaging system, streaming audio or video, remote desktop connections, etc. A network operation may also include value transfers (e.g., financial transactions) between entities (e.g., business entities or persons). For example, the networked operations may include bank wire transfers, credit or debit card transactions, mobile payment transactions, cryptocurrency transactions, recurring subscription payments, etc. A network operation may also include shipping goods between multiple entities within a supply chain to produce a final product. For example, the networked operations may include shipping of goods between and/or within different countries and may include shipments made by ship, plane, or truck.

In some embodiments, the system 400 is configured to detect compromised network operations (e.g., based on metadata of the entities, computers, goods, etc. involved in the transaction). A compromised network operation may refer to any network operation that may make it advisable or otherwise warrant intervention or investigation of the network operation. For example, a compromised network operation may refer to uploading, downloading, or streaming copyrighted information, performing financial transactions after identity theft, transferring illicit goods (e.g., narcotics and/or their precursors, unlicensed replicas, counterfeit goods, items that do not meet certain standards, goods made utilizing forced labor, etc.) into another country or within a country, or fraudulently avoiding tariffs. Although the system 400 is described as detecting compromised shipments of goods, a person of ordinary skill in the art would recognize that similar techniques may be used to detect compromised data transfer within a computer network and/or compromised financial transactions.

The system 400 can include secure log data 401. The secure log data 401 can store records of system activity, access, or operations in a secure manner. In some embodiments, the secure log data 401 is stored within the database (e.g., webserver, etc.) of an entity responsible for performing the network operations or for providing the infrastructure to perform the network operations. For example, secure log data 401 may include logs of shipment screening events, access attempts, or audit trails. The secure log data 401 may be part of a system for a shipping company, a customs system, a system of an importer/exporter, etc. In some embodiments, information related to shipments, entities, or individuals that have been involved in seizures by border protection or customs authorities and may include formal records sent from the boarder protection and customs authorities to companies (e.g., shipping companies, logistics providers, etc.) when items or shipments are found to be involved in illicit, suspicious, or non-compliant. The secure log data 401 may include potentially criminal activity, personally identifiable information (PII), and details supporting risk assessment and compliance actions. For example, the secure log data 401 may be stored in a secure server.

The system 400 (e.g., the network operation processing system 499) can incorporate into a graph database 413 historical network operation data for the source node (e.g., entities, people, companies, etc.) and the destination node. The historical network operation data can later be retrieved from the graph database 413 and used (e.g., incorporated) as additional data by the node to generate a risk score for a future network operation.

The system 400 (e.g., the network operation processing system 499) can use the information from the secure log data 401 in the machine learning pipeline. For example, to generate the One or more real-time AI models 423 and/or the one or more batch AI models 435. The information from the secure log data 401 may be used as a ground truth (e.g., known bad actors, items, entities, etc.) to train and tune the AI models for detecting risky operations. The secure log data 401 can be loaded into the network operation processing system 499 via one-time load operation. For example, the secure log data 401 may be provided through a data transfer 405 (e.g., a FTP, SFTP, etc.). The one-time load operation or manual load operation may be represented by operation 452a, where the secure log data 401 is transferred to the data transfer 405 where it is available for access by the network operation processing system 499 during training.

The operation 452a may include a manual one-time load of data from a secure log data 401 of an entity responsible for the network operations to the data transfer 405. The data transferred during operation 452a may be of any form. For example, the operation 452a may include a load of a CSV file containing historical shipment logs. JavaScript Object Notation (JSON), Extensible Markup Language (XML), or other data transfer media such as database transactions may be similarly used to transfer data from the secure log data 401 to the data transfer 405 during operation 452a. In some embodiments, the operation 452a is triggered during system initialization or when importing legacy data (e.g., when importing data from a new entity for the first time).

The system 400 can include network operation data 407. In some embodiments, the network operation data 407 is similar to the secure log data 401 and has up-to-date information related to the current network operations performed by the entity. For example, the network operation data 407 can store records of shipments or operations (e.g., transactions) relevant to counternarcotics screening and may include customs declarations, bills of lading, or shipment manifests. The network operation data 407 may be updated as operations occur, facilitating training (e.g., updating, adjusting, fine-tuning) of the one or more real-time AI models 423 and/or the one or more batch AI models 435 based on the latest available information.

The network operation data 407 can be loaded into the system 400 via an incremental load. For example, the network operation data 407 may be provided manually or through automated processes in which the network operation data 407 is automatically transferred to the data transfer 405 as it is received. The network operation data 407 may be uploaded periodically (e.g., every day, week, month, as new shipments are processed, etc.). For example, the incremental load of the network operation data 407 into the data transfer 405 may be represented by the operation 452b.

In some embodiments, the operation 452b includes uploading new network operation data 407 into the system 400 on a periodic basis. For example, the operation 452b may allow an operator to upload new shipment records at the end of each day. The operation 452b may be performed to keep the network operation processing system 499 updated with recent network operation data 407, thereby facilitating adaptation of the one or more real-time AI models 423 and the one or more batch AI models 435 to ensure the latest trends from various bad actors (e.g., nefarious entities) are reflected in the AI models used for detection.

The system 400 can include a data transfer 405. In some embodiments, the data transfer 405 is a networked computer (e.g., a server, etc.) configured to provide automated data transfer into the system 400. For example, the data transfer 405 may use an API or SFTP to receive data from external sources (e.g., the secure log data 401 and/or the network operation data 407). The data transfer 405 may be scheduled to run at regular intervals to maintain up-to-date information that can be accessed by the system network operation processing system 499. The data transfer 405 may include an API or use SFTP to provide the data stored in the data transfer 405 to the network operation processing system 499. For example, the network operation processing system 499 may subscribe to updates of the information in the data transfer 405 and the data transfer 405 may communicate the latest data to the network operation processing system 499 as it is received. As another example, the network operation processing system 499 may periodically poll data from the data transfer 405 to determine whether updates have occurred and request any updated data.

In some embodiments, the operation 454 includes the transfer of information from the data transfer 405 to the network operation processing system 499. For example, the operation 454 may include the network operation processing system 499 receiving information from the data transfer 405 in response to an update at the data transfer 405 and/or in response to the network operation processing system 499 polling for information. In some embodiments, the operation 454 includes communicating the data from the data transfer 405 to the entity resolver 411.

In some embodiments, the system 400 includes an entity resolver 411 configured to process the data (e.g., the network operation data 407 and the secure log data 401) as it enters the network operation processing system 499. The entity resolver 411 may check records (e.g., including addresses, businesses, individuals, phone number, emails, etc.) as network operation data is provided to the network operation processing system 499. The entity resolver 411 may be configured to determine whether a new record includes unique entities (e.g., that should be added to the graph database 413) or relationships between such entities. The entity resolver 411 may compare entities within inbound records with those in the graph database 413 using a number of matching techniques including, for example, semantic search in order to uncover attempts to obfuscate the true identity of a location, business, individual, etc. in the record. In some embodiments, a text-based (e.g., keyword search) or rule-based search (e.g., based on numerical descriptive parameters of the record) is also used to determine whether a record is unique.

Entities that may be found in an inbound record include companies, individuals, operations (e.g., transactions), locations (e.g., the geographic location such as geocoordinates, city, street address, etc.), the assets transported (e.g., item, information, goods, etc.), regulatory entities, and/or transport infrastructure (e.g., the paths, equipment, companies, etc. involved in the transport of the asset). For example, the system 400 may be used to identify illicit drug shipments. The entities in a record may include companies, individuals, the shipments, the ports or zones, the declared good that was shipped, whether the shipment was seized, and/or the carriers, warehouses, or facilities involved in the transport of the goods.

In some embodiments, the entity resolver 411 performs a text-based search between an entity in an inbound record and existing entities (e.g., in the graph database 413 or in a current batch being processed by the entity resolver 411). For example, the entity resolver 411 may compare metadata for the entity in the inbound record and metadata for the entity in the graph database 413. In some embodiments, the text-based search uses a regular expression (regexp) command to perform the search. In some embodiments, the entity resolver 411 performs a semantic search between the inbound entity and the existing entities. For example, the entity resolver 411 may generate an embedding vector representing the inbound entity and compare that embedding vector to embedding vectors for entities stored in the graph database 413. In some embodiments, the embedding vector is generated based on the metadata for the record. The metadata may include text-based metadata as well as numerical or categorical metadata. The features associated with networked items can include text descriptions, numeric values (e.g., size, weight, value, quantity, etc.), categorical values (e.g., country codes, port identifiers, shipment type, item type, classification codes, etc.), and graph-derived attributes (such as metadata and/or embeddings from related nodes, network centrality scores, relationship encodings, etc.). The system 400 can generate embeddings from any combination of these feature types. For example, text may be generated from the metadata (e.g., describing the hierarchy of interactions between multiple entities). The generated text can be free-form (e.g. natural language), JSON, XML, or similar text-based formats. The embedding vector may be generated by applying an embedding model (e.g., a word embedding model or sentence embedding model such as a bag-of-word model, a skip-gram, BERT, etc.). In some embodiments, the entity resolver 411 performs searches based on numerical parameters related to the inbound record and existing entities. Text-based and other rule-based searches can be combined by the entity resolver 411. In some embodiments, the entity resolver 411 performs searches that are based on embeddings from input including text, numerical information, or other input classes such as categorical information, enumerations, etc.

To determine whether the inbound entity is an existing entity within the graph database 413, the entity resolver 411 may generate a match score and/or a distance metric between the inbound entity and the existing entities. The match score (or distance metric) may be based on the text-based search and/or the semantic search. In some embodiments, the match score (or distance metric) includes a distance between the embedding vectors of the inbound entity and the existing entities. For example, the entity resolver 411 may determine the cosine distance and/or the Euclidean distance between embedding vectors. The match score may be compared to a threshold or a similar criterion may be used in order to determine whether the inbound entity is one that is already stored in the graph database 413. The graph database 413 may be any of various types of data storage capable of storing the network graph data structure. For example, the graph database 413 may include a database specifically configured for efficiently storing graphs, a relational database, file storage or another arrangement of storage.

Metadata used for the text-based, embedding based, or rules based search can include various sources. For example, the metadata may include an entity name, an entity description, a location for the entity (e.g., geolocation, street address, etc.), an email address, a phone number associated with the entity (e.g., for a company or individual), and any other information that may be included in the record of a network operation (e.g., a shipment). In some embodiments, metadata is obtained from other nodes (e.g., entities) connected to the entity of the record. For example, the record may include child nodes for the entity that indicate other entities that were a part of or related to the network operation (e.g., other entities that supplied components, parts, ingredients, etc. for the items transferred). Similarly, metadata from connected entities in the graph database 413 may be used for the text-based and/or semantic search (e.g., information from connected nodes may be used to generate the embedding vector to which the inbound entity is compared). The entity resolver 411 may use metadata from entities at any degree of separation between the entity for which the embedding vector is being generated. For example, the entity resolver 411 may use metadata from entities directly related to the entity for which the embedding vector is being generated, from entities that require traversal of two relationships from the entity for which the embedding vector is being generated, etc.). In some embodiments, the metadata for connected entities is weighted based on the depth of the connection (e.g., the entity itself may be weighted most, then the direct relationships, then 2-hop relationships, etc.).

In response to the entity resolver 411 determining that the entity of an inbound record satisfies the match criterion with another entity of the graph database 413, the entity resolver 411 may cause the inbound record to be associated with the matched entity in the graph database 413. For example, the new record for the entity may be used as another representative pattern for that entity. In response to the entity resolver 411 determining that the entity does not satisfy the match criterion with another entity of the graph database 413, the entity resolver 411 may cause the graph database 413 to allocate storage for the entity and associate the inbound record for that entity with the newly created entity in the graph database 413. Upon receiving a new record from the entity resolver 411, the graph database 413 may update. For example, the graph database 413 may generate a node for the new entity and/or an edge for a relationship that connects the entity with existing entities.

The entity resolver 411 may generate new edges between entities within the graph database 413. For example, after entities are identified within the inbound record (e.g., matched to an existing entity in the graph database 413 or identified as new), the entity resolver 411 can generate relationships between entities within the record. For example, relationships such as “ships to,” “receives from,” “located at,” “transports,” “stores,” etc. may be identified from the inbound record and edges representing such relationships may be added to the graph database 413.

In some embodiments the network operation processing system 499 includes a graph database 413 that stores entities and records found in the network operation information transmitted through the data transfer 405 from the secure log data 401 and/or the network operation data 407. The graph database 413 may use a graph model to store the data. For example, the graph database 413 may implement the network graph data structure 336 as shown in FIGS. 3B-3D. In some embodiments, the graph database 413 stores entities as nodes within the graph database 413 and uses network operation records (e.g., shipment records, data transfer records, etc.) to generate edges of the graph (e.g., connections) that describe the relationship between the entities. For example, edges of the graph database 413 may store (and/or point to a storage location) to the records indicating past shipments between two entities.

In some embodiments, the graph database 413 stores whether a record indicating a particular entity involved a compromised network operation (e.g., a seized shipment, etc.). For example, the graph database 413 may store a count of compromised network operations or a ratio indicating the fraction of network operations related to an entity that were compromised. Association with entities that more frequently participate in compromised network operations may be predictive of another compromised network operation.

The edges of the graph database 413 may store (or point to a storage location) any type of relationship. For example, the system 400 may be used to identify illicit shipments of narcotics into or within a country; transferring other illicit goods such as precursors, unlicensed replicas, counterfeit goods, items that do not meet certain standards (e.g., safety standards), or goods made utilizing forced labor into another country or within a country; or tariff evasion. The edges of the graph database 413 may store relationships relevant to counternarcotics screening. For example, the edges may indicate that an entity (e.g., company) ships to another entity (e.g., another company), an entity (e.g., an individual) ships another entity (e.g., a product or good), an entity (e.g., company) is associated with a risk for another entity (e.g., a regulatory body), or other similar relationships. Relationships may be identified by the entity resolver 411 and stored in the graph database 413.

The graph database 413 may be used to provide training data or model inputs for downstream AI models. For example, the entity model trainer 417 may request data from the graph database 413 to train the AI models during the operation 458. The graph database 413 may support queries for network analysis, risk scoring, and visualization. For example, the graph database 413 may be queried to identify multi-hop relationships between companies and shipments. Multi-hop relationship queries may facilitate determining bad actors by comparing relationships between entities even when the actor has obfuscated their identity. For example, the entities' relationships with other intermediaries may be used as a unique signature when determining a true identity allowing the network operation processing system 499 to identify compromised (e.g., illicit) network operations.

The graph database 413 may also store each record (e.g., in unprocessed form), for example, to be used as training samples. The records may indicate whether the network operation described by the record was prevented (e.g., the shipment seized) and was found to be compromised. The unprocessed record may be used as a training sample, while the graph model (e.g., the nodes and edges) stored in the graph database 413 may be used to query feature data related to the record. For example, the graph database 413 provides data from related nodes that may not be listed within the unprocessed record may be used as a training sample. In some embodiments, to prevent information leakage (e.g., access to information during training that would not be available during a similar prediction), the graph database 413 stores information related to the record that caused certain nodes and edges to be stored. During training, records may be temporarily removed from the graph model (or a copy of the graph model may be generated having a subset of the edges and nodes), for example, to prevent information from the record being processed from being available in the graph model during processing. For example, the permuted ordering of the records may be generated and nodes and edges from records higher on the list that the currently processed sample may be reflected in the temporary graph model (e.g., removing the nodes and edges that are supported by only the currently processed sample and the samples below the currently processed sample).

In some embodiments, the system 400 includes a graph hub 415 configured to provide additional storage and/or backup for the graph database 413. The graph hub 415 may also provide copies of the graph database 413 for experimental training data storage techniques, etc. (e.g., without exposing the graph database 413 to possible adverse side effects). The graph hub 415 may also provide the graph database 413 for test environments such as quality assurance, user acceptance testing, etc. The graph hub 415 can receive data from the graph database 413 via manual load operations, or the graph database 413 may be automatically loaded into the graph hub 415 (e.g., during the operation 456). For example, the graph hub 415 may be updated periodically with new data from the graph database 413 (e.g., based on a schedule or as new data is received by the graph database 413). In some embodiments, the graph hub 415 supports integration with external systems or advanced analytics tools. For example, the graph hub 415 may be queried by external investigators for network analysis.

The network operation processing system 499 may include an entity model trainer 417 configured to train one or more AI models (e.g., the one or more real-time AI models 423 and/or the one or more batch AI models 435). For example, the entity model trainer 417 may execute during the operation 456 in order to generate the one or more AI models. In some embodiments, the entity model trainer 417 is configured to generate multiple models for risk analysis. The models may be configured to generate a risk score for various factors related to the network operation (e.g., the shipment, data transaction, etc.). For example, the entity model trainer 417 may train a geospatial model, a network operation model, a restricted part model and/or an item description model.

In some embodiments, the models are classification models. For example, each model may be trained as a dichotomizer (e.g., identifying whether a network operation should be prevented, a shipment seized or denied, etc.). To train the classification models, the entity model trainer 417 may obtain a set of training samples from the graph database 413. A training sample may include the record of the network operations and an indication of whether the network operation was compromised (e.g., the ground truth). The entity model trainer 417 may generate features from a training sample (e.g., using the training sample and/or the information from the graph model in the graph database 413 related to the training sample). The entity model trainer 417 may apply a machine learning architecture to the features to generate a prediction of whether the network operation was compromised and adjust the machine learning architecture to cause a decrease in a loss function including a comparison between the prediction and the ground truth. For example, the loss function may include binary cross-entropy, logloss, squared error, etc.

In some embodiments, the entity model trainer 417 uses gradient boosting to train the AI models. The entity model trainer 417 may generate a first decision tree at a first iteration trained to identify whether a record for a network operation indicates a compromised network operation. For example, the first decision tree may be trained to predict ‘0’ indicating that the network operation is not compromised and ‘1’ indicating the network operation is compromised. In some embodiments, the decision tree can generate numbers between zero and one, for example, indicating a probability (e.g., likelihood, confidence, score, etc.) related to whether the network operation is compromised. After training the first decision tree, the entity model trainer 417 may train a second decision tree to predict (e.g., identify, quantify, etc.) the error (e.g., difference) between the prediction of the first tree and the ground truth. Predictions from the first tree and the second tree may be multiplied by a weight and summed to generate a composite output. Iterations may be continued by generating additional decision trees that predict the error between the ground truth and the output of the previous group of decision trees.

In some embodiments, the entity model trainer 417 uses a CatBoost (e.g., categorical gradient boosting) training procedure to train the AI models. The entity model trainer 417 may order the records of the training set and only use information from records that precede that record during training (e.g., according to the ordering). For example, the second record in the order may only use the nodes and edges in the graph database 413 that were generated based on the first record to generate input features for classification; other nodes and edges may be temporarily removed or otherwise not used during training.

During training (and later during classification of new records) the network operation processing system 499 may generate features for a record of a network operation. The features may include an embedding vector for the description of the asset transferred during the network operation (e.g., the goods shipped). The features may also include attributes related to the geographic location, network operation history, and node connectivity metrics for the source node representing the source entity, the destination node representing the destination entity, or any additional nodes connected to the source node or the destination node (e.g., directly connected or connected through intermediary nodes in a multi-hop fashion). Attributes may be weighted based on their relevance to the record (e.g., a distance such as the number of edges that are traversed to the source or the destination). Attributes may include entity names, locations (e.g., street address, longitude and latitude, country, region, etc.), function, owner, etc. Attributes may be embedded by way of a language model or other AI model to facilitate input as features.

In some embodiments, the entity model trainer 417 trains multiple models. For example, each model may be configured to accept input from features related to a different type of attribute. Multiple models can be combined in an ensemble fashion in order to generate a final prediction result. The prediction made by the ensemble may be generated based on the prediction of individual models. The output of the individual models may be averaged or summed and compared to a threshold. For example, the ensemble prediction may be generated according to a majority vote, an average risk score, or another combination of the individual models.

In some embodiments, the entity model trainer 417 trains a geospatial model to generate a risk score based on the geospatial attributes. For example, the geospatial model may accept, as input, features related to geospatial attributes of the source entity, destination entity, and/or any entities represented by nodes connected to the source or destination entity (e.g., directly connected or through intermediaries in a multi-hop fashion). Nonlimiting examples of geospatial attributes include geospatial coordinates (e.g., longitude and latitude), street address, distance to an area of particular interest (e.g., distance to an area originating high rates of compromised shipments), and the transfer route (e.g., roads, coordinates, cities, ports, etc. of the route) or distance to the route.

In some embodiments, the entity model trainer 417 trains a network operation model to generate a risk score based on the attributes related to the network operation of a record. For example, the network operation model may accept, as input, features related to other network operations of the source entity, destination entity, and/or any entities represented by nodes connected to the source or destination entity (e.g., directly connected or in a multi-hop fashion). Nonlimiting examples of attributes related to the network operations include whether previous network operations have been compromised, the frequency (e.g., prevalence, fraction, etc.) of compromised network operations, the type of network operation (e.g., shipment via air, sea, ground), and common entities included when the network operation is compromised.

In some embodiments, the entity model trainer 417 trains a restricted party model to generate a risk score based on the attributes for entities in the network operation of a record. For example, the restricted party model may accept, as input, features related to the source entity, destination entity, and/or any entities represented by nodes connected to the source or destination entity (e.g., directly connected or in a multi-hop fashion). Nonlimiting examples of attributes for entities include the entity name, type (e.g., company, individual, etc.), owner of the entity (e.g., people or parent companies), the function of the entity (e.g., type of business, goods produced, etc.).

In some embodiments, the entity model trainer 417 trains an item description model to generate a risk score based on the attributes for the assets transferred (e.g., the goods shipped, etc.) in a record. For example, the item description model may accept, as input, features related to assets transferred from the source entity and the destination entity, including any items that may have been added to the transferred assets during the network operation (e.g., source material, ingredients, etc.). Nonlimiting examples of attributes for the assets transferred include the asset name, asset classification (e.g., hazard level, resource, consumer good, etc.), asset description, and asset value (e.g., the declared value and/or the purchase value).

In some embodiments, the entity model trainer 417 is configured to retrain models as new data and/or feedback is received. For example, the entity model trainer 417 may periodically retrain the models. The entity model trainer 417 may use active learning workflows to incorporate investigator feedback. After investigators validate leads (e.g., an indication that a network operation may be compromised), the entity model trainer 417 may retrain models to improve future lead identification. For example, if an investigator follows up on a lead from the network operation processing system 499, the investigator may report whether the lead was a false positive or whether the network operation was compromised. The record of the network operation can be added to the network operation data 407 including the ground truth entered by the investigator. The new data from the network operation data 407 may propagate into the graph database 413 where it is used as training data for future executions of the entity model trainer 417. Alternatively, the investigator can flag the lead as correct or incorrect (e.g., using a user interface) directly for the network operation processing system 499.

The multi-model architecture may provide explainability in the output. For example, the model having the largest output may indicate a reason for a positive detection. In addition, many of the features are word embeddings that may be interpreted by language models. After a positive detection, features and/or text related to the features may be provided to a language model with a prompt requesting an explanation for the positive detection. In some embodiments, the models generate Shapely values (e.g., Shapely additive explanations (SHAP) values), or other feature-based interpretability frameworks to indicate features that contributed most to the positive identification. The Shapley values may be used to indicate models, features, or nodes within the graph database 413 that contributed to the positive detection and, in some embodiments, how much (e.g., an amount, a fraction, etc.) each model feature, or node contributed.

Trained models can be stored in the network operation processing system 499, for example, as part of an API endpoints for real-time or batch processing. The trained models are used in other sequences performed by the system 400. To summarize the training sequence according to some embodiments, the data from the secure log data 401 and the network operation data 407 is made available in the data transfer 405 during the operations 452a and 452b. During operation 454, records of network operations stored in the secure log data 401 and the network operation data 407 may be transferred into the network operation processing system 499 and processed by the entity resolver 411. During the operation 454, the entity resolver 411 uses the records to generate a graph model that is stored in the graph database 413. For example, the entity resolver 411 may compare entities in the subsequent records to entities in the graph database 413 to determine if an entity in the record is new or already exists in the graph database 413. Nodes in the graph model are stored for new entities. In addition, edges may be generated for the graph model to represent relationships indicated in the record of the network operation. At the operation 456, the graph database 413 may be duplicated and stored in the graph hub 415 for backup. After the graph model has been generated using the available records, the entity model trainer 417 trains multiple classification models to detect whether a network operation is compromised. The entity model trainer 417 generates features (e.g., an embedding vector) for input to one or more of the classification models by embedding various attributes related to the source and the destination of the network operation. The embedding vector may also be based on attributes for entities related to the source and/or destination entity (e.g., as indicated by edges within the graph model).

In some embodiments, the system 400 includes internal services 419. The internal services 419 can provide supporting functions for data processing, orchestration, or integration. Internal services 419 may handle data validation, transformation, or routing between components. For example, the internal services 419 may cause the periodic transfer of data from the data transfer 405 to the network operation processing system 499. The internal services 419 may also include a webserver to serve results from processed network operations records. Internal services 419 may also monitor system health or log processing events. For example, internal services 419 may generate alerts if data transfer 405 fails or if anomalies are detected. Internal services 419 may facilitate the flow of data to rule services 421 as records from new network operations to be processed (e.g., scanned for indications of a compromise) are received.

In some embodiments, the system 400 includes rule services 421 to facilitate and manage screening workflows (e.g., of network operations, shipments, etc.). The rule services 421 may be configured to process data received from internal services 419 and apply rules to route new screen requests through a particular sequence (e.g., batch or real-time). For example, the rule services 421 may route records and screen requests to a real-time API 425 for real-time screening. The real-time API 425 may be used for high-risk network operations (e.g., using addresses, phone numbers, etc. known to be associated with bad actors that participate in compromised network operations. The real-time API 425 may also be used for network operations having high urgency, for example, that occur in a short amount of time (e.g., 1 day, 1 hour, 1 minute, etc.). The rule services 421 may also route screening requests to the batch API 433 for batch processing. The batch API 433 may be used to screen records of network operations that may not have the same risk or urgency as records processed by the real-time API 425. For example, the batch API 433 may be used for shipments by sea that have multiple days before reaching port.

In some embodiments, the rule services 421 interact with the network operation processing system 499 to trigger holds on suspicious shipments. The rule services 421 may contact users (e.g., agents, workers, etc.) related to shipments for further review based on risk scores received from the network operation processing system 499. For example, the rule services 421 may generate an email, text message, instant message, push notifications, alerts on wearable devices, etc. in response to receiving an indication of a possible compromised operation. The rule services 421 may generate electronic alert signals configured to transmit an email, instant message, push notification, or alert on a wearable device. The electronic alert signal may be communicated over a network (e.g., a cellular network, the internet, a WiFi network, etc.).

The network operation processing system 499 includes one or more AI models trained (e.g., generated) by the entity model trainer 417. In some embodiments, the network operation processing system 499 includes one or more real-time AI models 423 and/or one or more batch AI models 435. The one or more real-time AI models 423 and the one or more batch AI models 435 may include the same models from the entity model trainer 417, for example, provided using a different API facilitating different user experiences. In some embodiments, the one or more real-time AI models 423 and the one or more batch AI models 435 are different models. For example, the one or more real-time AI models 423 may have a smaller number of parameters or otherwise be optimized or configured to perform in a real-time environment. Alternatively, the one or more batch AI models 435 may include additional parameters, layers, etc. The one or more batch AI models 435 may be tuned for high accuracy with less regard for computational complexity and/or completion time.

As described above, the one or more real-time AI models 423 and/or the one or more batch AI models 435 may generate risk scores for shipments or other network operations in real-time or in batch mode, respectively. During processing, the one or more real-time AI models 423 and/or the one or more batch AI models 435 may receive a new network operation record for processing and generate features based on the record. For example, the new record may be included as input to a respective API for the AI models. The AI models may generate a multi-dimensional feature vector including an embedding based on data related to the source and/or destination entities including the including geographic location, network operation history, and/or node connectivity metrics or the entities. The AI models may include a classification model using the multi-dimensional feature vector to generate the risk score.

Features for the record may be generated based on the source entity, the destination entity, and/or the asset transferred by the network operation (e.g., the goods shipped from source to destination). Upon receiving the record the AI model (e.g., any of the one or more real-time AI models 423 or the one or more batch AI models 435) may search the graph database 413 for a node matching the source entity. The AI model may determine a match based on a keyword search, regular expressions, and/or a semantic search. Semantic search may be used to uncover obfuscated entity names, etc. that would otherwise avoid detection. To perform a semantic search, the AI model may generate an embedding vector for the source entity. For example, the metadata associated with the source entity (e.g., entity description, entity name, phone number, owner, etc.) may be used to generate an embedding vector and compared with embedding vectors for entities (e.g., nodes) in the graph database 413.

If the AI model detects a match in the graph database 413 (e.g., based on a match criterion including the keyword matches, the regular expression matches, and a distance metric associated with the embedding vector), the additional features may be generated based on the records associated with the entity stored in the graph database 413. For example, the embedding vector from the record being processed and the embedding vectors of matched entities in the graph database 413 may be merged (e.g., averaged, appended, combined, etc.). In some embodiments, the AI model also traces edges of the graph model in the graph database 413 from the source entity. Additional entities may be identified that are related to the source entity by one or more relationships (e.g., connected by edges representing relationships in the graph database 413). The AI model may receive attributes from the related nodes. The attributes may be numerical and can be appended to the embedding vector. In some embodiments, the attributes are used to generate additional text descriptions which can be used to generate another embedding vector representing features for the source entity. For example, the AI model may generate a text listing of the relationships using a template for relationships of different types, which can then be embedded using an embedding model. For example, the model may convert a relationship into text using a template similar to “<entity> <relationship> <related entity> which is <related entity description>,” where information within the characters < > represent variables that are filled in based on the entity and the related entity.

The AI model may perform a similar set of operations to generate features based on the destination entity. For example, the AI model may generate an embedding for the destination entity, find matching entities in the graph database 413, and generate features based on related entities in the graph database 413.

In some embodiments, the AI model also generates an embedding of the description of the assets (e.g., items, goods, etc.) transferred in the network operation. The AI model may combine embedding vectors for the source entity, destination entity, and asset descriptions to be used as input to the AI model. Multiple models may be used (e.g., each focusing on a particular type of attribute)

The trained AI model may be applied to the generated embeddings and/or features (e.g., the embeddings and/or features are used as input to the AI model. As output, the AI model may generate a risk score (e.g., a probability of compromise, etc.), as described above.

The system 400 may include a real-time API 425 and a batch API 433. The real-time API 425 and the batch API 433 provide access to the one or more real-time AI models 423 and the one or more batch AI models 435, respectively. The APIs provide endpoints that can be accessed by a client device. For example, a client device running a user interface in a web browser or a proprietary application may provide POST or GET commands to the APIs. In some embodiments, the POST commands are used to provide new records of network operations to be processed. The POST command may add a record or a batch of records to a processing queue maintained by the API. GET commands may be used to obtain results (e.g., the resulting risk score), updates to a particular record's location in the queue, and/or progress of a currently processing record.

The real-time API 425 may provide an interface for submitting shipments or operations (e.g., transactions) for real-time risk scoring. The real-time API 425 may accept requests from internal services 419, rule services 421, or other external systems and/or client devices. In some embodiments, the real-time API 425 is configured to store processing results in the screened network operations database 431 (e.g., for batch reporting, audits, future user feedback, etc.) and to provide results back to the calling system as record processing is completed. The real-time API 425 may be configured to provide rapid response, for example, while a user of the system (e.g., agent, etc.) waits. For example, the real-time API 425 may return a risk score to the user interface 429 or trigger a shipment hold via the validate and initiate shipment holds client system 427.

The batch API 433 may provide an interface for submitting multiple shipments or operations for batch risk scoring. The batch API 433 may accept a file, data structure, or structured text input (e.g., JSON, XML, etc.) containing multiple operations and return multiple predictions in a single response. In some embodiments, the batch API 433 is configured to store processed results in the screened network operations database 431. Users who have submitted a batch request may retrieve the results or information related to the progress of the batch via the batch API 433 (e.g., using a GET call to the endpoint). In some embodiments, the batch API 433 is used to process large shipments (e.g., arriving on the same ship, plane, truck, etc.) when the shipment is in transit. If the shipment is illicit or otherwise compromised, it may be investigated and/or seized upon arrival.

The APIs (e.g., the real-time API 425 and/or the batch API 433) may be scalable. For example, resources and memory may be provisioned for executing the AI models as record processing requests are provided to the APIs. Scaling processing and/or memory resources may facilitate rapid response, allowing the real-time API 425 to maintain a specified level of performance (e.g., results within 30 seconds, 1 minute, etc.). Similarly, processing resources for the batch API 433 may be scaled based on the number of records included in a batch request.

Results from the one or more real-time AI models 423 or the one or more batch AI models 435 may be combined with heuristic and/or rule-based outputs. For example, outputs of the AI models may be adjusted based on additional checks. For example, a positive match to suspicious or block-listed phone numbers or emails may raise the risk score or supersede the AI models and cause a positive detection. Additionally, the AI models may include entity independent models. For example, the AI models may include one or more AI models (e.g., including language models) that are configured to detect poorly (e.g., sloppy, carelessly, inaccurately, etc.) completed forms. These AI models may detect patterns that indicate copy-and-paste, vague descriptions, obfuscation, etc. that indicate potentially compromised network operations. Scores from AI models configured to detect such anomalies may be combined with other AI models related to attributes or metadata for the specific entities of the network operation record.

In some embodiments, the network operation processing system 499 is configured to generate features for detection models by comparing properties of a network operation record against historical baselines relevant to similar goods or entities. For example, properties such as shipment weight, value, or item description may be analyzed in relation to historical averages or standard deviations associated with a corresponding classification, such as a harmonized system (HS) code. The system may compute quantitative measures, including z-scores or similar outlier metrics, to identify records that deviate significantly from expected norms. Input records exhibiting such anomalous values may be flagged for heightened scrutiny or intervention, thereby enhancing the system's capability to identify compromised or suspicious operations. Advantageously, the network operation processing system 499 may exploit statistical regularities and learn subtle patterns indicative of illicit activity or abnormal network operations. Detected outliers may be used to adjust the output from the AI models, for example, by increasing the associated ensemble risk score. Adjustments may be fixed or variable. In some embodiments, the amount of the adjustment is based on the amount by which a value is a statistical outlier (e.g., based on the z-score, or other statistical measure) compared to typical or benchmarked values for the weight of similar items. Similarly, detection of outliers may supersede the AI models and automatically cause a network operation (e.g., shipment) to be flagged (e.g., investigated, detected, etc.) if a statistical outlier exists.

The screened network operations database 431 may be configured to store processed records (e.g., to be reviewed by a user of a client system 427). The screened network operations database 431 may store records of network operations that have been screened by the system 400 including risk scores, shipment details, and hold statuses. Both the real time and batch screening results may be stored in the screened network operations database 431 and accessed through either the real-time API 425 or the batch API 433 to support reporting, auditing, and further analysis. For example, monthly reports may be generated from the screened network operations database 431.

The system 400 may include a client system 427. The client system 427 may be configured to evaluate risk scores and initiate holds or investigations on network operations in response to elevated risk scores. Risk score evaluation may be performed manually and/or automatically (e.g., by comparison to a threshold score). In some embodiments, a hybrid approach is used where network operations with elevated risk scores are flagged automatically and reviewed in a human-in-the-loop process. The client system 427 may initiate a hold on a network operation until it can be investigated. In some embodiments, the client system 427 automatically generates work orders to perform the investigations. For example, the client system 427 may transmit work orders to regional systems at the destination (or source) of the network operation to initiate an investigation. After an investigation has been performed, the user may provide feedback as to whether the detected network operation was actually compromised. Feedback may be used for future training (e.g., model adjustments, etc.).

The network operation processing system 499 may include a user interface 429. The user interface 429 may generate instructions and transmit the instructions over a network to a client system 427 for execution (e.g., in a web browser or other application). The user interface 429 may be configured to generate instructions for a user interface tailored to the type of network operation that is being identified. In some embodiments, the user interface 429 generates instructions for an interface that is used in counter drug trafficking. The user interface 429 can provide an interface for reviewing risk scores, shipment details, and flagged entities. For example, the user interface 429 may display a scored list of high-risk companies or shipments that may be indicative of a disguised narcotics shipment. The user interface 429 can receive risk scores from the real-time API 425 and allow users to initiate shipment holds or further investigations. For example, a user may filter and expand flagged entities to explore their broader trade and corporate networks. The user interface 429 may support interactive visualization and exploration of flagged entities. For example, the user interface 429 may generate visualizations of the records, supply chains, business activity for high-risk companies or shipments.

As described above, the system 400 may provide two report processing sequences, a real-time processing sequence and a batch processing sequence. The real-time processing sequence may be used to rapidly process individual records with high importance and immediacy. The batch processing sequence may be used to process several records (e.g., hundreds, thousands, etc.). The batch sequence may be performed overnight and/or while network operations are being performed. For example, the batch sequence may be used for all shipments on a single vehicle while it is in transit.

The real-time processing sequence may include operations 462-472. To summarize the real-time processing sequence according to some embodiments, the internal services 419 may initialize a request and provide that request to the rule services 421 during operation 462. The rule services 421 may determine whether real-time processing or batch processing should be performed. For example, the rule services 421 may determine whether real-time processing should be performed based on the immediacy, risk, and/or importance indicated in the request from the internal services 419. If the rule services 421 determines that real-time processing is indicated, one or more records may be transmitted to the real-time API 425 during operation 464. For example, the operation 464 may include a POST request adding the new records for processing to the real-time queue. During operation 466, the one or more real-time AI models 423 may be applied to the records to generate a risk score. In some embodiments, the operation 466 includes evaluating whether additional resources are necessary to maintain a particular response time or other level of performance; new computational resources may be provisioned accordingly to execute multiple instances of the one or more real-time AI models 423 in parallel. Results are provided back to the rule services 421 in the operation 468, which can in turn provide the results to the internal services 419, where a client device or other device providing user access can be updated. The real-time processing sequence may also include storing results for later viewing, audits, reports, etc. in the screened network operations database 431 during operation 470.

The batch processing sequence may include operations 482-486. To summarize the batch processing sequence according to some embodiments, the internal services 419 may initialize a request and provide that request to the rule services 421 during operation 482. The rule services 421 may determine whether real-time processing or batch processing should be performed. For example, the rule services 421 may determine whether batch processing should be performed based on the immediacy, risk, number of records, and/or importance indicated in the request from the internal services 419. If the rule services 421 determines that batch processing is indicated, one or more records may be transmitted to the batch API 433 during operation 484. For example, the operation 484 may include a POST request adding the batch of new records for processing to the batch processing queue. During operation 486, the one or more batch AI models 435 may be applied to the records to generate a risk score for each record of the batch. In some embodiments, the operation 486 includes evaluating whether additional resources are necessary to complete the batch request at a particular time; new computational resources may be provisioned accordingly to execute multiple instances of the one or more batch AI models 435 in parallel. For example, the batch request may indicate a necessary completion time (e.g., entered by a user via the user interface). Results may be stored in the screened network operations database 431 as they complete. The user interface 429 may generate a display by which the client system 427 can access newly created results.

FIG. 4B illustrates a sequence 402 of compromised network operation detection, according to some embodiments. A data processing system (e.g., the data processing system 306, shown and described with reference to FIG. 3A or the network operation processing system 499 as described with reference to FIG. 4A) can perform the sequence 402 to detect compromised network operations. The sequence 402 can include any number of operations or additional operations, and the operations may be performed in any order.

The sequence 402 is divided into four sequences (e.g., describing for different checks and/or AI models) in some embodiments. As shown in FIG. 4B, the sequence 402 may include an entity check, a goods check, a geolocation check, and a contact check. Although the sequence 402 is illustrated for a use case of detecting shipments of illicit goods such as narcotics, it is understood that similar sequences may be used to detect other network operations including data transfer; shipments of other goods such as precursors, unlicensed replicas, counterfeit goods, items that do not meet certain standards (e.g., safety standards), or goods made utilizing forced labor; or tariff evasion, and/or financial transactions. For example, the sequence 402 may include other or additional subsequences of the same form. Lists used by the checks of the sequence 402 may refer to other types of data storage models including, but not limited to, dictionaries, sets, registries, collections, structures, lookup tables, etc. Each check of the sequence 402 may be used individually or in combination. In some embodiments, one or more of the checks are used to establish a risk score and one or more of the checks are used adjust (e.g., modify, change, etc.) the risk score. For example, one check may determine whether the entity of the source node or the entity of the destination node has previously participated in a compromised network operation and modify a risk score generated from other models (e.g., checks) based on whether the entity of the source node or the entity of the destination node has previously participated in a compromised network operation.

The sequence 402 may begin when a request input 437 is provided to the model endpoint 441 (e.g., the model endpoint 441 may implement one or both of the APIs shown in the network operation processing system 499). The request input 437 is shown to follow an input schema 439. The input schema 439 may define a number of required and/or optional fields to screen the shipment (e.g., the network operation). The input schema 439 may define fields found on a shipment manifest. For example, the 439 may include a source and destination company or individual name, company or individual phone numbers, email addresses, physical addresses, a list of the networked items included in the shipment, a description of the networked items, a declared value of the networked items, a weight of the networked items, or any other portion of a shipment record, including custom forms, etc. The input schema 439 may also specify screening options such as model parameters, the models that are to be run, sensitivity (e.g., false alarm rate, etc.), whether to flag missing data, etc. For example, the request input 437 may be preprocessed (e.g., prescanned, etc.) as it enters the model endpoint 441. Shipment records in the request input 437 that are missing data may be flagged for review and processing may be stopped.

The models (e.g., the classifiers, etc.) described with reference to the sequence 402 may be trained by the entity model trainer 417. For example, the sequence 402 may use any of the one or more real-time AI models 423 or one or more batch AI models 435 described above. Similarly, the one or more real-time AI models 423 and/or the one or more batch AI models 435 may perform any functions or use any of the architectures described for the AI models or classifiers of the sequence 402.

In some embodiments, the sequence 402 includes an entity check. The entity check is illustrated by the sequence including entity metadata 443, sanctioned individual list 449, sanctioned company list 451, and sanctioned individual and company index 455 according to some embodiments. The entity check includes lists (e.g., the sanctioned individual list 449 and the sanctioned company list 451) for which the entries are indexed (e.g., into the sanctioned individual and company index 455) and used to compare to the entity metadata 443 in order to generate a risk score or a binary result (e.g., yes/no, compromised/uncompromised).

The entity check may include comparing the entity metadata 443 against the machine learning model artifacts in the second segment data 447 (e.g., the sanctioned individual list 449, sanctioned company list 451, and/or the sanctioned individual and company index 455). The comparison may be performed by a classifier (e.g., including any of the classifiers trained by the entity model trainer 417). The comparison may alternatively (or additionally) be performed by a language model (e.g., the language model 479).

In some embodiments, the machine learning artifacts for the entity check are generated based on the sanctioned individual list 449 and the sanctioned company list 451. For example, the sanctioned individual list 449 may include a compilation of individuals, groups of individuals, and organizations designated as restricted parties. The sanctioned individual list 449 may be used within the system to efficiently identify entities associated with economic or trade sanctions, terrorism, or other criminal activities, for example, as described in regulatory and compliance protocols. Screening names and addresses against the sanctioned individual list 449 mitigates the risk of engaging with sanctioned entities and allows users of the system 400 (and the model endpoint 441 thereof) to adhere to national and international laws. The sanctioned company list 451 may be a list of companies and/or individuals that previously have had items seized by a shipping company or have otherwise been identified as bad actors by a shipping company providing records to the system 400. For example, the sanctioned company list 451 may be a list maintained by the network operation processing system 499 and be based on records for which the ground truth notes that the shipment was compromised. The sanctioned individual list 449 and the sanctioned company list 451 may be used as inputs in the classifier for the entity check.

In addition, the sanctioned individual list 449 and/or the sanctioned company list 451 may be processed by a language model (e.g., the language model 479) in order to generate the sanctioned individual and company index 455. In some embodiments, each entity (e.g., company and/or individual) in the sanctioned individual list 449 and/or the sanctioned company list 451 is converted into an embedding vector (e.g., a multi-dimensional vector, feature vector, etc.) by applying the language model 479 or an embedding model thereof. The collection of embedding vectors (e.g., from each of the companies or individuals) may be included in the sanctioned individual and company index 455. The sanctioned individual and company index 455 may also be used as input to the classifier as part of the entity check.

Each entry in the sanctioned individual list 449 and/or the sanctioned company list 451 may be converted into an embedding vector based on metadata for that entry. For example, a description, name, and type of the company (or individual) may be processed by a language model 479 or word embedding model such as a BERT, a bag-of-words model, a skip-gram, a GPT model, etc. to generate the embedding vector for the entry of the list. Other data/metadata may also be used to generate the embedding vector; non-limiting examples of the other data/metadata include known aliases, country or citizenship, associates, reason for sanction, etc. It is understood that the metadata used to generate the embedding vector may include metadata from other companies and/or entities that are related to those companies on the sanctioned individual list 449 and/or the sanctioned company list 451. Metadata from entities at any degree of separation between those companies on the lists can be used. For example, the metadata from entities directly related to the company for which the embedding vector is being generated, from entities that require traversal of two relationships from the company for which the embedding vector is being generated, etc. can be included. In some embodiments, the metadata for connected entities is weighted based on the depth of the connection.

In some embodiments, the entity metadata 443 is individually tested against each machine learning model artifact in the entity check sequence. For example, the entity metadata 443 may be compared to the sanctioned individual list 449 by keyword and/or regular expression search. Similarly, entity metadata 443 may also be compared to the sanctioned company list 451. In some embodiments, if either comparison to entities in the sanctioned individual list 449 and/or the sanctioned company list 451 generates a match, the output of the entity check sequence is “yes” or “compromised.” Alternatively, a match in the comparison to the sanctioned individual list 449 and the sanctioned company list 451 may be used to adjust the risk score generated by the classifier or the comparison to the sanctioned individual and company index 455.

In some embodiments, the sequence 402 includes executing a deterministic rule-based classifier configured to compare identifiers of either or both of the source node (e.g., entity, person, company, etc.) and destination node against a restricted agent list stored in as part of a lookup table. The risk score may be adjusted if a match is detected, for example, by increasing the risk score or increasing a weight with a particular component of the risk score such as the component related to the entity check. In some embodiments, the sequence 402 determines whether the entity of the source node or the entity of the destination node has previously participated in a compromised network operation. The risk score may be similarly modified if previous participation in a compromised network operation has occurred.

In some embodiments, a distance-based classifier is used to determine a risk score or a compromised/uncompromised decision for the screening endpoint 475. The entity metadata 443 may be converted into an embedding vector (e.g., using the same embedding model that was used to generate the sanctioned individual and company index 455 from the sanctioned individual list 449 and the sanctioned company list 451). The embedding vector for entity metadata 443 in the shipment record being processed can be compared to the embedding vectors in the sanctioned individual and company index 455. In some embodiments, the smallest distance between the embedding vectors in the sanctioned individual and company index 455 and the embedding vector of the entity metadata 443 is used for further processing (e.g., used to calculate a risk score or compared to a threshold). The smallest distance represents the sanctioned company having the most semantic similarity with the source or destination entity in the shipment record. Advantageously, the entity check may detect compromised shipments (e.g., network operations) even if the source or destination is obfuscated. In some embodiments, a number of smallest distances are used for the further processing (e.g., smallest three distances, smallest five distances, etc.). The distances may be averaged or otherwise combined before being compared to the threshold or used to calculate the risk score.

In some embodiments, a neural network-based classifier is used to determine a risk score or a compromised/uncompromised decision for the screening endpoint 475. The entity metadata 443 may be converted into an embedding vector (e.g., using the same embedding model that was used to generate the sanctioned individual and company index 455 from the sanctioned individual list 449 and the sanctioned company list 451. The embedding vector for entity metadata 443 in the shipment record being processed may be compared to the embedding vectors in the sanctioned individual and company index 455 using the neural network model. For example, the neural network may have been trained by the entity model trainer 417 to generate a compromised/uncompromised decision or a risk score using both the ground truth shipment records and embedding vectors of sanctioned companies as inputs. The classifier may learn the correlations between compromised shipments and entities on a list of sanctioned entities. Advantageously, by accepting as input embedding vectors for sanctioned entities, the classifier may require less frequent training. For example, by updating the sanctioned individual and company index 455, the classifier may adapt to the latest trends in illicit shipping, obfuscation techniques, sanctioned companies, etc. In some embodiments, the sanctioned individual list 449 and the sanctioned company list 451 are updated as new information becomes available from law enforcement or regulatory bodies.

The sequence 402 may use two comparisons. For example, a comparison between the entity metadata 443 and entities of the sanctioned individual list 449 or the sanctioned company list 451, and semantic a comparison (e.g., based on the embedding vectors) between the entity metadata 443 and the sanctioned individual and company index 455. Integration of these lists in the model workflow for regular expression checks, along with language model-based searches using the index, may enhance the capability of the network operation processing system 499 and the models thereof to uncover both direct and nuanced matches to sanctioned actors.

In some embodiments, the sequence 402 includes a goods check. The goods check is illustrated by the sequence including goods description 445, precursor chemical list 453, and precursor chemical index 457, according to some embodiments. The goods check includes lists (e.g., the precursor chemical list 453) for which the illicit goods or goods that can be used to manufacture illicit goods are indexed (e.g., precursor chemical index 457) and used to compare to the goods description 445 in order to generate a risk score or a binary (e.g., yes/no, compromised/uncompromised).

The goods check may include comparing the goods description 445 against the machine learning model artifacts in the second segment data 447 (e.g. the precursor chemical list 453 and/or the precursor chemical index 457). The comparison may be performed by a classifier (e.g., including any of the classifiers trained by the entity model trainer 417). The comparison may alternatively (or additionally) be performed by a language model (e.g., the language model 479).

In some embodiments, the machine learning artifacts for the goods check are generated based on the precursor chemical list 453. The precursor chemical list 453 may include a compilation of chemicals and/or products that may be used to produce illicit products such as narcotics. For example, the precursor chemical list 453 may include precursor chemicals or products including precursor chemicals (e.g., that can be used to recover the precursor chemical). This precursor chemical list 453 may be used within the system to efficiently identify shipments of precursor chemicals or other chemicals or products associated with narcotics trafficking. The precursor chemical list 453 may be a list maintained by the network operation processing system 499 and may be based on products included in records for which the ground truth notes that the shipment was compromised. In some embodiments, the precursor chemical list 453 also includes products that have previously been used to disguise shipments of narcotics.

In addition, the precursor chemical list 453 may be processed by a language model (e.g., the language model 479) in order to generate the precursor chemical index 457. In some embodiments, each entry precursor chemical list 453 is converted into an embedding vector by applying the language model 479 or an embedding model thereof. The collection of embedding vectors (e.g., from each of the products or chemicals included in the precursor chemical list 453) may be included in the precursor chemical index 457. The precursor chemical index 457 may be used as input to the classifier as part of the goods check.

Each entry in the precursor chemical list 453 may be converted into an embedding vector based on metadata for that entry. For example, a description of the chemical or product and/or name of the chemical or product may be processed by a language model 479 or word embedding model such as a BERT, a bag-of-words model, a skip-gram, a GPT model, etc. to generate the embedding vector for the entry in the precursor chemical list 453. Other data/metadata for the chemicals or products may also be used to generate the embedding vector; non-limiting examples of the other data/metadata include known chemical formulae, ingredients, weight, etc.

In some embodiments, the person-entity detector 481 is also used to generate the precursor chemical index 457. The person-entity detector 481 may be configured to identify companies or individuals that are known to produce a listed precursor chemical. The description of a business identified as a precursor chemical or other metadata related to the business may be included in the text used to generate the corresponding entry in the chemical index 457.

In some embodiments, the goods description 445 is individually tested against each machine learning model artifact in the goods check sequence. For example, the goods description 445 may be compared to the precursor chemical list 453 by keyword and/or regular expression search. In some embodiments, if a match is found in the precursor chemical list 453, the output of the goods check sequence is “yes” or “compromised.” Alternatively, a match in the comparison with the precursor chemical list 453 may be used to adjust the risk score generated by the classifier or the comparison to the precursor chemical index 457. In some embodiments, the output and/or the adjustment depends on the number of matches detected in the precursor chemical list 453. For example, the goods check may produce a “yes” or “compromised” output if a threshold number of matches are found in the precursor chemical list 453. Similarly, the amount of adjustment may be a function of the number of matches found in the precursor chemical list 453 (e.g., a linear function, nonlinear function, etc.)

In some embodiments, a distance-based classifier is used to determine a risk score or a compromised/uncompromised decision for the screening endpoint 475. The goods description 445 may be converted into an embedding vector (e.g., using the same embedding model that was used to generate the precursor chemical index 457 from the precursor chemical list 453. The embedding vector for goods description 445 in the shipment record being processed can be compared to the embedding vectors in the precursor chemical index 457. Similar to the entity check, the smallest distance between the embedding vectors or a function of a number of the smallest distances (e.g., the average of the smallest 3 distances, etc.) is used for further processing (e.g., used to calculate a risk score or compared to a threshold).

In some embodiments, a neural network-based classifier is used to determine a risk score or a compromised/uncompromised decision for the screening endpoint 475. The goods description 445 may be converted into an embedding vector (e.g., using the same embedding model that was used to generate the precursor chemical index 457 from the precursor chemical list 453). The embedding vector for goods description 445 in the shipment record being processed may be compared to the embedding vectors in the precursor chemical index 457 using the neural network model. For example, the neural network may have been trained by the entity model trainer 417 to generate a compromised/uncompromised decision or a risk score using both the ground truth shipment records and embedding vectors of precursor chemicals as inputs. Advantageously, the neural networks may learn correlations between the number of precursor chemicals or certain combinations of precursor chemicals that are indicators of illicit shipments of narcotics.

The sequence 402 may use two comparisons to perform the goods check. For example, a comparison between the goods description 445 and entities of the precursor chemical list 453, and a semantic comparison (e.g., based on the embedding vectors) between the goods description 445 and the precursor chemical index 457. Integration of the lists in the model workflow for regular expression checks, along with language model-based searches using the index, may enhance the capability of the network operation processing system 499 and the models thereof to uncover both direct and nuanced matches to precursor chemicals that are indicative of a shipment of narcotics or other illicit goods.

In some embodiments, the sequence 402 includes a geospatial check. The geospatial check is illustrated by the sequence including the location information 459, the sanctioned name and address list 467, and the sanctioned name and address list 469, according to some embodiments. The geospatial check includes a list (e.g., the sanctioned name and address list 467) including addresses and geolocations that have had illicit shipments in the past which are indexed (e.g., to generate the sanctioned name and address list 469) and used to compare to the goods description 445 in order to generate a risk score or a binary (e.g., yes/no, compromised/uncompromised).

The geospatial check may be performed similar to the goods description check, for example, by comparing the location information 459 against the machine learning model artifacts in the first segment data 465 (e.g., the sanctioned name and address list 467 and/or the sanctioned name and address list 469). The comparison may be performed by a classifier (e.g., including any of the classifiers trained by the entity model trainer 417). The comparison may alternatively (or additionally) be performed by a language model (e.g., the language model 479). In some embodiments, the geospatial check is performed by identifying a geographic location for each of the source node (e.g., entity, person, company, etc.) and the destination node from the graph database 413. The geospatial check may include modifying the risk score based on proximity of the geographic location to known compromised regions. For example, the risk score may be increased based on a distance between a compromised region (e.g., location, area, etc.) and the source or destination of the network operation (e.g., shipment). In addition, the risk score may be further modified according to distances between the path of the network operation, for example, based on the distance between any location along the path of the network operation and the compromised region.

As shown in FIG. 4B, model artifacts used by the network operation processing system 499 may be stored (e.g., maintained, saved, etc.) in separate segments of data (e.g., separate databases, servers, etc.) shown as the second segment data 447 and the first segment data 465. Storing model artifacts in different data segments may allow users to have varying access to the model artifacts. For example, some artifacts may be provided and maintained by a first user (e.g., company) of the system 400 and privacy concerns may dictate that a second user not have access to the artifacts from the first user. In some embodiments, each user is individually provided permissions to the data segment and the checks performed thereby.

The sequence 402 may also include a contact check, for example, based on the phone numbers 461 and the email addresses 463 of the entities in a shipment record. The sequence 402 may include comparing the phone numbers 461 and the email addresses 463 to the entries in the sanctioned phone and email registry 471. If any entry in the sanctioned phone and email registry 471 matches the phone numbers 461 and/or the email addresses 463 listed in the shipment record being processed, the contact check may produce a “yes” or “compromised” output. The output may be provided to the screening endpoint 475 and used to adjust or generate the request output 483. The sanctioned phone and email registry 471 may be updated as new information is received from law enforcement and new phone numbers or email addresses linked to illicit shipments are uncovered. In some embodiments, the contact check is performed as an initial screening step. Shipments involving phone numbers or email address in the sanctioned phone and email registry 471 may be automatically flagged for further review.

The sequence 402 can use one or more pre-trained models 477. For example, the pre-trained models may include one or more language models 479 and/or a person-entity detector 481. The language model 479 may be used to generate indexes from lists by generating a vector embedding for each entry in the list as described above. For example, the sanctioned individual list 449 and the sanctioned company list 451 may be combined and converted into the sanctioned individual and company index 455 using an embedding model. The language model 479 may also be used to perform semantic comparison. For example, the language model may be prompted with a list (e.g., the sanctioned individual list 449, sanctioned company list 451, precursor chemical list 453, or address list 467), a corresponding description or metadata from the shipment record, and a request to determine whether the description or metadata matches any of the entities (e.g., companies, individuals, goods, or addresses from the list). The language model 479 may include large language models (LLMs), small language models (SLMs), and/or multimodal language models (MMLMs). The language model 479 may be a transformer-based neural network model including multiple attention layers. In some embodiments, the language model is trained to generate to semantic representations in a fixed-dimensional feature space (e.g., embeddings). For example, the language model may produce embeddings as part of an input layer to the language model.

In some embodiments, the models of the sequence 402 and/or the network operation processing system 499 support multiple languages. For example, a different embedding model (e.g., language model, etc.) may be used to generate the embeddings of the sanctioned individual and company index 455, the precursor chemical index 457, and the address list 469. New records of network operations generated in different languages may still have semantic meaning that matches the precursor chemicals, sanctioned companies and/or geographic locations in the lists and can be compared in embedded form (e.g., by a cosine distance or similar metric). Additional languages may be supported by adding additional language models to the language model 479.

The person-entity detector 481 may be configured to identify individuals or entities of interest from input data. The person-entity detector 481 may extract names and associate the name with a role (e.g., a supplier of, source, destination, etc.). For example, the person-entity detector 481 may provide additional description indicating the types of chemicals or goods a company makes. The person-entity detector 481 may also be used to link individuals with companies on the sanctioned individual list 449 or the sanctioned company list 451. Individuals linked to high-risk companies may be flagged for further review (e.g., during the entity check).

In some embodiments, the screening endpoint 475 is configured to aggregate the results from each of the models (e.g., the entity check, the goods check, the geospatial check, and the contact check). The screening endpoint 475 may generate a request output 483 including the aggregated risk assessment. The screening endpoint 475 may generate a binary result (e.g., yes/no or compromised/uncompromised). For example, the screening endpoint 475 may generate a binary result based on a majority vote (or weighted voting) of the individual models (e.g., the checks). As another example, the screening endpoint 475 may generate a binary result by comparing an aggregation (e.g., combination, sum, average, etc.) of risk scores from the individual models to a threshold value. Alternatively, the screening endpoint 475 may generate an aggregated risk score for the request output 483. The aggregated risk score may be based on the average, sum, or another function of the individual model outputs (e.g., risk scores).

The request output 483 may follow a prediction output schema 485 defining various fields that may be communicated to a user (e.g., to the client system 427) for display or performance of an automated action (e.g., initiating an investigation, holding the shipment, etc.). For example, the prediction output schema 485 may include a risk score, a binary decision (e.g., compromised or uncompromised decision), Shapley values for the processed record (e.g., indicating which of the models, goods, or entities such as the source or destination, contributed most to the shipment being flagged), an explanation of the results, or any other information that may contribute to the appropriate response. In some embodiments, the sequence 402 includes prompting the language model 479 with the fields of the prediction output schema 485 and a request for a summary of the results. The summary may also be added to the prediction output schema 485.

FIG. 4C illustrates an example output schema 404 (e.g., an example of the prediction output schema 485) for compromised network operation detection, in accordance with one or more embodiments. As shown in the output schema 404, a response to a request for an indication of whether a network operation is compromised can include fields for a response identification, a request identification, (e.g., globally unique identifiers (GUIDs) to provide a method for the client system 427 to access particular results for display) and the results. The results can include fields such as network operation number, source geographic region (e.g., origin country), source port (e.g., origin port), destination geographic region (e.g., destination country), detection portion, duty type, screening status (e.g., an indication of whether the network operation is compromised), and/or a screen status explanation (e.g., a text description or justification of the screen status). An example of a value for the screen status explanation can be “Importer was matched to a known prior compromised network operation.” In some embodiments, the results can include the risk score that was used to generate the screening status (e.g., if the screening status is based on a comparison between a risk score and a threshold).

FIG. 4D illustrates an example sequence 406 for using an ensemble of models for compromised network operation detection, in accordance with one or more embodiments. A data processing system (e.g., the data processing system 306, shown and described with reference to FIG. 3A, the network operation processing system 499 shown and described with reference to FIG. 4A) can perform the sequence 406 to detect compromised network operations. The sequence 406 can include any number of the operations or include additional operations and the operations may be performed in any order. The sequence 406 may be performed within the model endpoint 441 including either the real-time API 425 or the batch API 433.

As shown in the sequence 406, the data processing system can receive a destination identifier, a source identifier, item descriptions, and a source geographic region for a network operation in which an item is being transported between facilities represented by nodes of a network graph data structure (e.g., the network graph data structure 336). The data processing system can receive such data from a computing device involved in completing the network operation, such as a computing device of a customs agent. In some cases, the data processing system can receive an identification of a destination node and/or region for the network operation from the request from the computing device.

The data processing system can execute different models in the sequence 406 to generate metrics for the network operation. Each of the models can be or include a machine learning model (e.g., a neural network, a random forest, a support vector machine, etc.) or any other type of computer model. For example, the data processing system can execute a region-specific model, a trusted network operation model, a restricted party screening model, and/or an item description screening model. The region-specific model can be a probabilistic model. The region-specific model may be configured to generate a probability (e.g., confidence, risk score, etc.) that the network operation will be completed in a geographic region in which receipt of items in network operations is restricted. The region-specific model may do so based on the data received in the request for the network operation and/or node data extracted from the network graph data structure (e.g., in the graph database 413) from nodes that are involved in the network operation and/or nodes that are connected with such nodes through edges (e.g., relationships) in the network graph data structure.

The trusted network operation model can be a probabilistic model. The trusted network operation model can be configured to generate a confidence score or a probability that the network operation is a trusted network operation. In some embodiments, the trusted network operation model includes a number of companies and/or individuals that have been pre-authorized (e.g., on an approved list, authorized list, pre-cleared list, etc.). Such companies or individuals may have permitted site inspection or other clearance activity to become pre-authorized. The trusted network operation model may indicate whether a company or individual associated with the network operation has been pre-authorized. The aggregated risk score may be adjusted down (e.g., less risk for network operations, including pre-authorized entities). In some embodiments, after a company, shipment route, or other network operation has been determined by the system 400 or sequence 406 to be not compromised a number of times, the system 400 or sequence 406 may grant pre-authorized status to that company, shipment route, etc.

The restricted entity screening model can be a deterministic model. The restricted entity screening model can be configured to store and/or perform a look-up technique in a list of source nodes and/or destination nodes for network operations that are identified as restricted and/or non-restricted. The list can only include identifications of restricted entities and/or include identified entities with flags or settings indicating whether the entities are restricted from completing network operations. The restricted entity screening model can compare identifiers of the source node and/or the destination node received in the request from the computing device and/or identified from the network graph data structure based on the request to the list. Based on the comparison, the restricted entity screening model can output or generate a binary value indicating whether or not at least one of the entities of the network operation is restricted from completing network operations. Accordingly, the aggregated risk score may be adjusted up if a source or destination entity has been identified as restricted. In some embodiments, if either the source or destination entity is identified as restricted, the aggregate output may include an indication of a compromised network operation. If a node related to the source node or destination node is indicated as restricted, the aggregated risk score may be adjusted up (e.g., higher risk of a compromised network operation).

The item description screening model can be a deterministic model. The item description screening model may be configured to process text descriptions of items to generate embeddings of the text. For example, the item description screening model can be or include a model (e.g., a large language model, a neural network, or another type of model) that is configured to generate numerical vectors or embeddings (e.g., a vector with a defined size, such as 358×1) from text and/or additional descriptive information or attributes (e.g., numerical parameters, categories, types, etc.). To generate an indication of whether the items of a network operation may be compromised, the item description screen model may compare the embedding vector with embedding vectors for restricted items such as chemical precursors for manufacture of narcotics or items previously seized as storing, hiding, or concealing narcotics during shipment or other illicit goods. If the embedding vector for items in the shipment satisfies a matching criterion (e.g., based on cosine distance, etc.) with an embedding vector from the restricted items, the aggregate risk score may be increased.

The data processing system can execute a classification model (e.g., a neural network, a support vector machine, a random forest, etc.) based on the outputs of the aforementioned scoring models to generate a risk score (e.g., a value between 0 and 1, between 0 and 100, or within any other range) for a network operation in the sequence 406. For example, each of the models can generate a value based on features identified, retrieved, or generated for a particular network operation. The data processing system can use the generated values to generate a feature vector. The data processing system can input the feature vector into the classification model and execute the classification model to generate a risk score. The risk score can indicate a likelihood that the network operation is compromised.

The data processing system can use the risk score to determine whether the network operation is compromised in the sequence 406. For example, the data processing system can compare the risk score to a threshold. Responsive to determining that the risk score does not exceed the threshold, the data processing system can generate a flag indicating the network is not compromised. The data processing system can transmit a message back to the computing device including the flag. In some embodiments, the flags are used to generate a “green light” (e.g., a light indicating uncompromised) on the client system 427 as shown in sequence 406. For example, the green light may be generated if the flag indicating the network is not compromised is generated. Otherwise, the data processing system can generate a message including a flag indicating the network operation is compromised. Similarly, the data processing system may generate a “no light,” for example, in which the space on a user interface generated on the client system 427 where the green light would appear may be left blank (e.g., off, etc.), which may indicate a compromised network operation. The message can include instructions to restrict the network operation. The computing device can receive the message and restrict the network operation, such as by generating an alert, presenting the flag on a user interface, or stopping movement of devices involved in the network operation. To halt (e.g., restrict) the network operation a control signal may be transmitted to a system component configured to manage the transfer of the one or more networked items. In addition, an metadata of the network operation associated with the alert may be stored in a log data structure, for example, for review, audit, and/or later training.

In some embodiments, the sequence 406 includes generating a screen status explanation including a textual justification for restricting the network operation. For example, the justification may include one or more indicators derived from the node data and the embedding thereof. The screen status explanation may be transmitted by the data processing system (e.g., with the green light or no light indication). The message may include a confidence score associated with the determination that the network operation is compromised.

The data processing system can use different implementations to generate scores or indications of whether network operations are compromised in the sequence 406. A few examples are as follows. In one embodiment, the data processing system can select (e.g., randomly or pseudo-randomly) network operations that are compromised. In another embodiment, the data processing system can execute a model (e.g., a machine learning model or a company level model) to generate risk scores for network operations. In doing so, the data processing system can perform an entity resolution process on a source node and a destination node (e.g., importer and exporter name+address pairs), which may be matched with entities in the network graph data structure, generate relevant features for company level modeling, and compute or generate a risk score for each network operation for both the source node and the destination node.

In some embodiments, the data processing system can use source features for a model (e.g., a machine learning model or company level model) for network operation level datasets in the sequence 406. Once a company is matched to a given source or destination, a variety of features can be derived from network graph data structure data that can be used as orthogonal features for modeling. In some embodiments, features are further classified with respect to whether the company is importing or exporting. Non-limiting examples of features that may be used for a company include a number of imports, a number of exports, a number of shipments, number of shipments per year, a number of suppliers for a shipment or product, a type of shipment, a type of product, a number of other companies with which the company trades, etc.

In some embodiments, the data processing system can use a feature called “matched to graph” as a corollary for network operation level screening. This feature can be derived by assigning a TRUE when there is a given risk_score for either destination or source. If there is no risk score, this feature can be false.

In some embodiments, the data processing system can use a Boolean flag indicating whether a source node or a destination node is a person to generate a risk score for a network operation. For example, the Boolean flag indicating a person may be included as a feature for the models used in the sequence 406 (e.g., the one or more real-time AI models 423 or the one or more batch AI models 435).

In some embodiments, the data processing system (e.g., the data processing system 306 and/or the network operation processing system 499) can use sentence embeddings generated from items description to generate risk scores for network operations in the sequence 406. For example, the data processing system can identify text strings from “items description” fields in requests for network operations. The data processing system can generate (e.g., using a sentence embedding model, such as a large language model or a Bidirectional Encoder Representations from Transformers BERT model) embeddings from such text strings each with the shape (1, 384), for example, or with any other shape. The embeddings generated from the descriptions may provide context for narcotic activity or other illicit goods transfer (e.g., general vagueness, a specific selection of types of words or phrases, repetitive, etc.) and/or a positive correlation to generalized compromised (e.g., narcotic) activity. The data processing system can input text embeddings generated from item descriptions into a model (e.g., a classification model, such as a CatBoost model or a neural network) to generate a risk score indicating a likelihood that the network operation is compromised.

In some embodiments, in addition to or instead of using the embedding of the item description to generate a risk score, the data processing system can use a geography-based metric in the sequence 406. For example, the data processing system can identify a geographic location (e.g., latitude and/or longitude) of the source node and/or the destination node of a network operation. The data processing system can identify such data from the network graph data structure and/or from data in a request received for the network operation. The data processing system can store a list of geographic regions that correspond to item compromise. The data processing system can determine or calculate a distance between the locations of the source node and/or destination node the closest geographic region on the list of geographic regions. In some cases, the data processing system can do so by identifying the zip code of the latitudes and longitudes of the source nodes and/or destination nodes from a database (e.g., an online database or a database stored by the data processing system) and using a distance formula, such as the haversine distance formula, between centroids of the zip codes and/or the source node and/or destination node and centroids of the closest compromised zip codes to the source node and/or destination node. In some cases, in doing so, the data processing system can generate two separate distances, a distance for the source node and a distance for the destination node. In some cases, the data processing system can perform a function (e.g., sum, average, median, etc.) on such distances to generate a single distance. The data processing system can use such distances as an input into the classification model to generate a risk score for the network operation.

In some embodiments, the data processing system can use flags indicating whether the source nodes and/or the destination nodes are persons as input into the classification model in the sequence 406. The data processing system can identify such flags from the network graph data structure, in some cases. The data processing system can use such flags as input with one or both of the sentence embeddings and/or distances, determined as described above, into the classification model. The data processing system can execute the classification model based on such inputs to generate a risk score for the network operation.

In some embodiments, the data processing system can additionally or instead use a measure of string or embedding similarity such as cosine similarity (e.g., distance, score, etc.) and/or a number of commodity line items as input into the classification model in the sequence 406. The data processing system can determine the similarity measure (e.g. cosine similarity) as a distance between text embeddings from commodity line items compared to embeddings from network operation item descriptions. The data processing system can identify the number of commodity line items from a request for a network operation. The data processing system can input the cosine similarity and/or the number of commodity line items into the machine learning model with other features, such as a sentence embedding, a nearest distance calculation, Boolean flags indicating whether the source node and/or the destination node are persons in a features vector. The data processing system can execute the machine learning model based on the feature vector to generate a risk score for the network operation.

In some cases, the data processing system can additionally or instead use a measure of statistically significant difference such as a z-score for item weights and values per network operation in the sequence 406. To determine z-score for an item weight, the data processing system can generate fixed confidence (e.g., 0.8) ranges for shipment items within descriptions of a dataset, for example, based on the type of item, the item description, and/or other information that is indicative of an expected weight. The data processing system can normalize the shipment weights to kilograms and shipment values to dollars. The data processing system can totalize the expected shipment weight and value and determine a z-score based on the mean and standard deviation of the totals. In some embodiments, the data processing system can generate a table from the output values. The data processing system can join a table containing the output values with original network operation level data to calculate a z-score (e.g., as a means for quantifying how far from the expected weight or value the shipment is) for each network operation's weight and value. The data processing system can use such generated z-scores as input into the classification model with any combination of the metrics described here to generate risk scores for network operations.

In some cases, the statistical deviation using z-scores is derived from historical shipments stored in the graph database 413. The z-scores represent normalized differences between the weight and value of the one or more networked items and historical benchmarks obtained from the graph database 413. The risk score may be increased according to the z-score. For example, the risk score may be proportionally increased or increases when or after the z-score exceeds a predefined threshold (e.g., 1, 2, etc.).

In some cases, the data processing system can use a combination of sentence embeddings generated from item descriptions fields, one or more distance metrics, Boolean flags indicating whether the source node and/or the destination node are persons, and a cosine similarity between commodity description embeddings and network operation description embeddings as input into the classification model to generate a risk score.

In some cases, the data processing system can generate node risk scores that can be used as input into the classification model to generate risk scores for particular network operations in the sequence 406. The data processing system can generate the node risk scores using the network graph data structure. For example, for a node of the network graph data structure that represents a particular entity, the data processing system can identify edges between the node and other nodes that represent other entities. The edges can indicate or represent network operations (e.g., item transfers or other types of network operations) between the entities. The data processing system can retrieve data (e.g., node data) from the node such as geographical region (or a latitude and longitude that the data processing system can compare to a database to determine a geographical region), such as a zip code, country, city, etc., an item industry, a number of employees, product categories, a type of the entity (e.g., individual, corporation, non-profit, limited liability company, etc.), income level, a time series of network operations involving the node, a number of facilities, a number of detected compromised network operations involving the node, a flag indicating whether or not the node has participated in a prior compromised network operation, etc. The data processing systems can additionally retrieve the same or similar data from the nodes that share at least one (or at least a threshold number) of edges with the node. In some cases, the data processing system can determine a number of network operations and the different connected nodes, such as by maintaining a counter for each connected node and incrementing the respective counters for each edge between the two nodes. The data processing system can retrieve or generate any such data for the node from the network graph data structure. The data processing system can retrieve such data for any nodes of any degree of connectivity. For instance, the data processing system can retrieve or identify such data with nodes that are connected by edges with nodes that are connected with the node for which the data processing system is generating the node risk score.

The data processing system can use the retrieved data from the node graph to generate a node risk score for the node. The data processing system can do so, for example, by applying a machine learning model (e.g., a neural network, a support vector machine, a random forest, etc.) to the collected data. The machine learning model may be configured to generate node risk scores based on such data. The data processing system can generate a feature vector from the collected data and input the feature vector into the machine learning model. The data processing system can execute the machine learning model based on the input to cause the machine learning model to output a node risk score for the node. The data processing system can input the node risk score into the data structure of the node in the network graph data structure. The data processing system can similarly generate node risk scores for any number of nodes of the network graph data structure.

In some cases, the data processing system can dynamically update the node risk scores of the network graph data structure as the data processing system can generate and/or update node risk scores for other nodes within the network graph data structure in the sequence 406. For example, an input into the machine learning model trained to generate node risk scores can include the node risk scores of nodes connected with the node for which the data processing system is generating a node risk score. In some cases, the data processing can include node risk scores of nodes of several layers of connectivity with the node. In such cases, the weights for the nodes may decrease the further away the connected nodes are from the node for which the data processing system is generating a node risk score, for example (e.g., a risk score for a first node that is directly connected with the node may have a higher weight than a risk score for a second node that is connected with the first node but not the node). For each instance that the data processing system generates a risk score for a node, the data processing system can use the generated risk score as input with other data as described above to generate risk scores for nodes directly connected with the node and/or indirectly connected by a number (e.g., a predetermined or defined number) of edges with the node. In some cases, the data processing system can regenerate scores for the entire node graph or for individual nodes at defined intervals or pseudo-randomly to account for new network operations that are represented in the network graph data structure. The data processing system can repeat this process for each generated or updated node risk score to maintain a live version of the network graph data structure that can be used for compromised network operation detection.

In some cases, the data processing system can use the risk score to generate flags for the nodes that indicate whether the nodes are compromised or not. For example, the data processing system can compare the node risk scores to a threshold (e.g., a defined threshold). Responsive to determining a risk score for a node exceeds or otherwise satisfies the threshold, the data processing system can generate a flag in the data structure for the node indicating the node is compromised. Otherwise, the data processing system may not generate such a flag (e.g., keep the field for such a flag NULL or empty) or insert a value indicating that the node is not compromised in the data structure. The data processing system can similarly generate such flags for any number of nodes of the network graph data structure.

The data processing system can use the node risk scores and/or flags indicating whether the nodes are compromised for the source node, the destination node, and/or a defined number of layers of connected nodes to generate risk scores for network operations. In doing so, the data processing system may use the most recently generated node risk scores and/or flags (which may be identified from timestamps associated with the node risk scores and/or flags) and/or a timeseries of the node risk scores or flags generated for the nodes. The data processing system can include such node risk scores and/or flags in the input into the machine learning model trained to classify network operations with any combination of the metrics or values described above and execute the machine learning model to generate risk scores for network operations.

For entities that exceed a threshold risk score, the data processing system can generate an evidence-based explanation for the risk scores and/or flags generated from the risk scores for individual nodes. The explanations can identify specific risk factors contributing to the risk score, document potential indicators from network transaction histories, list concerning trading partners, map the entity's position within relevant value chains, and present other supporting evidence in a standardized format.

In some cases, the data processing system can generate scores for sections of a network graph data structure instead of or in addition to scores for companies or other entities. The data processing system can do so using a machine learning model (e.g., a neural network, a support vector machine, a random forest, etc.) trained to generate scores for such sections. The section scores can be scores for multiple nodes of the network graph data structure or for sub-graphs of the network graph data structure. The data processing system can generate the scores for sections by inputting values extracted or metrics generated as described herein for individual nodes of the section into the machine learning model. The data processing system can execute the machine learning model based on the inputs to cause the machine learning model to generate scores for the respective sections. The data processing system can store the score generated for a section in nodes included in the section. The data processing system can use such scores in combination with other metrics or scores (e.g., the company score) to generate risk scores for network operations involving the respective nodes.

FIG. 4E illustrates an example flowchart of a process 408 for compromised network operation detection, in accordance with some embodiments. A data processing system (e.g., the data processing system 306 shown and described with reference to FIG. 3A and/or the network operation processing system 499 shown and described with reference to FIG. 4A) can perform the process 408 to detect compromised network operations. The process 408 can include any number of operations or additional operations, and the operations may be performed in any order.

At operation 410, the data processing system can receive a request including an identification of a network operation between a source node and a destination node. The network operation can be or include a transfer of one or more items from the source node to the destination node. The request can include a text description of the one or more items. The data processing system can receive the request from a computing device. For example, the operation 410 may be performed by the real-time API 425 and/or the batch API 433. The source node and destination node may represent entities acting at the endpoints of the network operation. For example, the source node may represent a shipper and the destination node may represent a receiver. The nodes may represent individuals and/or companies involved in the network operation.

At operation 412, the data processing system can use the identification of the network operation to identify one or more sub-graphs of nodes. In doing so, the data processing system can identify sub-graphs from a network graph data structure maintained by the data processing system. The network graph data structure can be a graph data structure that stores a network of nodes and edges between the network of nodes, digitally representing types of relationships between entities represented by the network of nodes. For example, the network graph data structure may have been generated during the training sequence including any of the operations 452-458 illustrated in FIG. 4A. The network graph data structure may include the graph model of the graph database 413 and include entities and/or relationships learned from previously encountered network operations. The data processing system can identify sub-graphs that correspond to (e.g., include) the source node or the destination node. Each sub-graph of nodes can include nodes (e.g., including the source node and/or the destination node) connected by a set of edges.

At operation 414, the data processing system can perform a search through one or more edges of each of the one or more sub-graphs of nodes. In performing the search, the data processing system can identify a first plurality of nodes connected by edges with the source node and a second plurality of nodes connected by edges with the destination node. The first plurality of nodes may be related to the source node according to relationships extracted from records of previous network operations and stored in the graph database 413. Similarly, the second plurality of nodes may be related to the destination node according to relationships extracted from records of previous network operations and stored in the graph database 413. In some embodiments, the operation 414 includes identifying nodes that are related to the source or destination node by more than one edge (e.g., are related through relationships with one or more intermediary nodes in a “multi-hop” fashion). The operation 414 may traverse any number of relationships (e.g., edges) to identify the first plurality of nodes or the second plurality of nodes (e.g., one edge, two edges, etc.). The first and/or second plurality of nodes may be used as input to the models used to generate risk scores (e.g., the one or more real-time AI models 423, the one or more batch AI models 435, or any of the models shown in FIG. 4B as being part of the sequence 402 or shown in FIG. 4D as part of the sequence 406). For example, the models may generate features from attributes and/or metadata associated with the first plurality of nodes or the second plurality of nodes which may include intermediary nodes connected to the source node or the destination node.

At operation 416, the data processing system can identify node data from each of the source node, the destination node, and each of the first and second plurality of nodes. Node data may include any data (e.g., including attributes or metadata) associated with the identified nodes (e.g., the source node, the destination node, and each of the first and second plurality of nodes) that may be used as input to the models used to generate risk scores (e.g., the one or more real-time AI models 423, the one or more batch AI models 435, or any of the models shown in FIG. 4B as being part of the sequence 402 or shown in FIG. 4D as part of the sequence 406). In some embodiments, the models include a list of the necessary inputs. During the operation 418, the network graph data structure (e.g., or the graph database 413) may be queried to acquire the inputs. In some embodiments, information from the identified nodes is converted into embedding vectors prior to input to the model. For example, the descriptions and/or any other attributes of the nodes (e.g., including numeric properties and other non-text information) for the entities represented by the identified nodes, their relationships with other nodes, etc. may be converted into a textual format (e.g., natural language sentences, JSON, XML, etc.) and/or applied as input to an embedding model. The operation 418 may be performed within the models and/or the endpoints executing the models (e.g., the real-time API 425, the batch API 433, and/or the model endpoint 441).

At operation 418, the data processing system can generate a description embedding from the text description of the one or more items using a model (e.g., a machine learning model, such as a neural network or an encoder). For example, the operation 418 may include applying an embedding model or language model to the description of items transported in the network operation. Additionally, the operation 418 may include identifying statistical outliers related to the weight of the item and adjusting the risk score accordingly.

At operation 420, the data processing system can execute one or more models using the description embedding and the node data to generate a network operation risk score for the network operation. The operation 420 may include executing any number of the models described herein. For example, the operation 420 may include executing the one or more real-time AI models 423, the one or more batch AI models 435, the models of the entity check, the goods check, the geospatial check, or the contact check described with reference to FIG. 4B and/or the scoring models described as executed in sequence 406 of FIG. 4D. The outputs of each of the models may include a binary indicator as to whether that model is indicating a compromised or uncompromised network operation or a risk score for that model. The operation 420 may include aggregating the outputs of the individual models. The risk scores may be summed or averaged, and the binary outputs may be used to adjust the risk scores. For example, the risk score may be increased by applying a predefined weight (e.g., additive, multiplicative, etc.).

At operation 422, the data processing system can determine whether the network operation is compromised based on the network operation risk score and/or the binary outputs from the models. For example, the data processing system can compare the network operation risk score generated by the ensemble of models to a threshold (e.g., a predetermined threshold). In some embodiments, the operation 422 includes a voting criterion. The operation 422 may include performing a weighted vote based on the individual models that have binary outputs. In some embodiments, certain models can supersede the evaluation of other models. For example, certain models may cause the criterion of operation 422 to be satisfied if their output indicates a compromised network operation (e.g., regardless of risk scores or outputs of other models). Responsive to determining the network operation risk score does not satisfy the criterion (e.g., does not exceed the threshold), at operation 424, the data processing system can generate a flag for the network operation. The flag may indicate that the network operation is not compromised. The data processing system can do so in a data structure of the network graph data structure indicating the network operation is not compromised. The flag may be used, for example, to populate a green light in a user interface of the client system 427 indicating the network operation is not compromised and/or can proceed.

In response to the criterion of operation 422 being satisfied, at operation 426, the data processing system can restrict the network operation. In some cases, the data processing system can restrict the network operation by transmitting a message to the computing device (e.g., the computing device that transmitted the request for the network operation). The message can be configured to restrict (e.g., prevent, halt, etc.) the network operation from completion and/or can include an alert or message indicating the network operation is compromised.

In some implementations, the data processing system can attach network operation risk scores to digital records for the networked items of the network operations. For example, responsive to receiving a request containing an identification of a network operation for transferring a networked item between two nodes, the data processing system identify a digital record from memory that contains an identifier of the networked item contained in the request. The data processing system can generate a network operation risk score for the network operation using the systems and methods described here. The data processing system can store the network operation risk score in the digital record for the networked item, in some cases with other metadata about the network operation, such as the inputs that were used to generate the operation risk score, a timestamp of the generation of the network operation risk, or any other metrics or data regarding the network operation or networked item. The data processing system can repeat this process for the networked item over time such that the data processing system can continuously generate and continuously update a structured data set with operation risk scores corresponding to the networked item. The data processing system can repeat this process for any number of networked items and/or network operations.

The data processing system can use the network operation risk scores in digital records of networked items to generate network operation risk scores for subsequent network operations. For example, responsive to receiving a request containing an identification of a network operation for transferring a networked item between two nodes, the data processing system identify a digital record from memory that contains an identifier of the networked item contained in the request. The digital record can contain one or more network operation risk scores generated for network operations previously completed involving the networked item of the current network operation. The data processing system can retrieve the network operation risk scores from the digital record, in some cases with the metadata stored with the respective network operation risk scores. The data processing system can additionally retrieve the data regarding the current network operation for which the data processing system is generate a network operation risk score. The data processing system can execute one or more models using the data retrieved from the digital record and the data retrieved for the network operation to generate a network operation risk score for the network operation. In some cases, the data processing system can use a weighting function on the historical network operation risk scores based on the timestamps (e.g., network operations with more recent timestamps may correspond to a higher weights than other network operations). The data processing system can generate the network operation risk score for the network operation and operate based on the network operation risk score, as described herein. The data processing system can store the generated network operation risk score, in some cases with other metadata for the network operation in the digital record for the networked item to facilitate generation of future network operations, facilitating the generation of more accurate future network operation risk scores.

Some of the description herein emphasizes the structural independence of the aspects of the system components or groupings of operations and responsibilities of these system components. Other groupings that execute similar overall operations are within the scope of the present application. Modules can be implemented in hardware or as computer instructions on a non-transient computer readable storage medium, and modules can be distributed across various hardware or computer-based components.

### E. Compromised Entity Detection and Mitigation

Malicious actors may perform illicit behavior (e.g., malicious network operations) across multiple operations and/or time periods so that no single network operation appears sufficiently suspicious on its own. As a result, scoring entities based on an aggregation of operation and corresponding scores can result in the identification of additional compromised operations and identification of a source node/entity responsible for several compromised network operations. Building from the operation-level detection techniques described above, the systems and methods described herein improve computer-based threat detection by storing network operation risk scores on graph edges representing relationships between entities and then using those edge-level scores to determine whether a corresponding actor, organization, device, facility, or other entity should itself be classified as compromised. Advantageously, the systems and methods described herein can detect suspicious actors based on the accumulated pattern of their operations within the network in addition to detecting individual suspicious network operations.

Compromised or malicious entity-level (e.g., node-level, actor-level, etc.) detection can provide additional technical advantages because detection is not limited to evaluating a single transfer, communication, or interaction in isolation. Instead, the entity-level detection can identify a node corresponding to an entity, retrieve multiple connected edges associated with prior network operations, and aggregate the network operation risk scores across those edges to generate a score based on a distribution and/or other statistics related to the network operations of an entity and attributes of the entity. A holistic approach facilitates detection of a compromised entity allowing all network operations therefrom to be considered compromised or otherwise associated with higher risk during detection of compromised network operations. For instance, the compromised entity can be a computer involved in a communications network attack or an entity involved in malicious network item transfers, exploitation, export control, malicious transfers, and/or malicious value adjustments. The systems and methods described herein can detect bad actors whose compromise is only apparent when viewed through their broader relationship graph, including repeated interactions with high risk entities, persistent participation in suspicious paths, or patterns of activity spread across many individually moderately suspicious operations.

In some embodiments, the systems and methods described herein can maintain entity-level risk dynamically as new network operations are observed and scored. Responsive to receiving a new network operation, the system can update the graph database with a new or modified edge, update the composite risk associated with the relevant entity node, and re-execute the entity risk scoring process. Reprocessing of all network data may not be required, which can substantially reduce the processing resources required during inference. Bad actors may be identified and/or mitigated in near real time based on the evolving set of scored network operations. Additionally, the systems and methods may initiate mitigation actions, such as alerts, investigations, restrictions, or blocking of real-time (e.g., a currently pending network operation or a network operation that is currently being performed) and/or future operations involving the compromised entity.

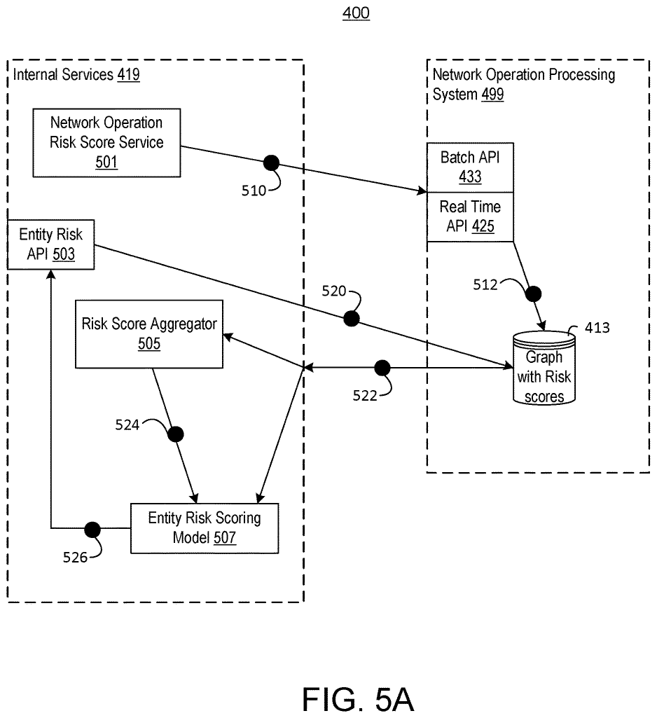

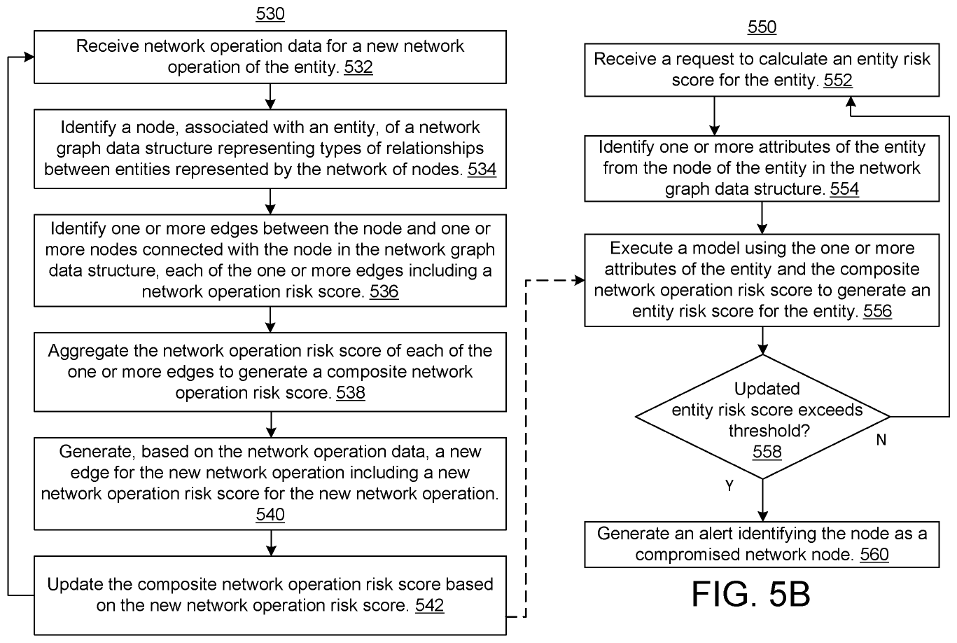

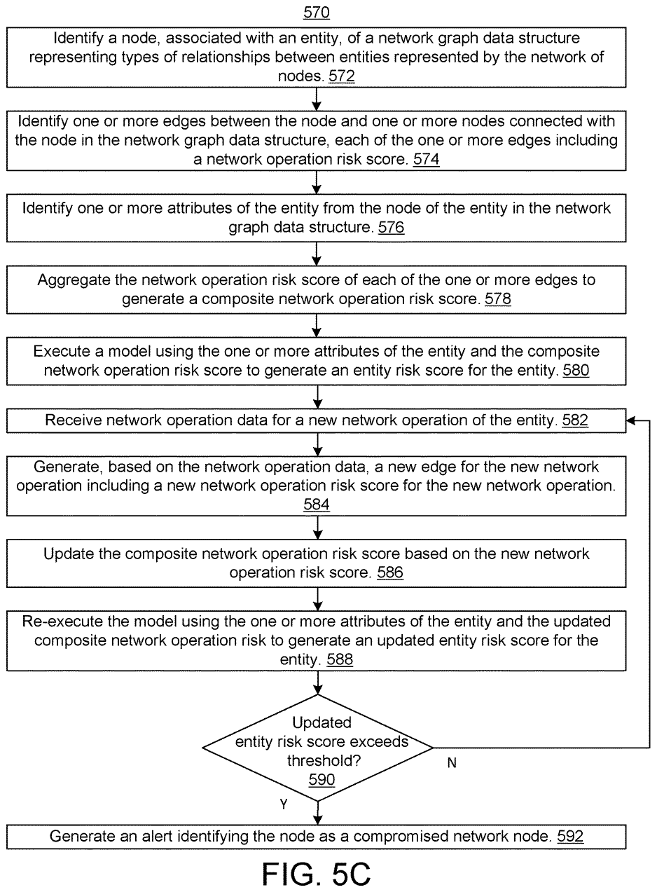

FIG. 5A is a data flow diagram of a system 400 for entity-level risk determination using network operation risk scores stored in a graph database, according to some embodiments. A data processing system, such as the network operation processing system 499 and the internal services 419 described with reference to FIG. 4A, can be configured to generate entity risk scores based on edges between nodes of a network graph data structure. In brief overview, the internal services 419 may include a network operation risk score service 501, an entity risk API 503, a risk score aggregator 505, and an entity risk scoring model 507. For example, the system 400 may include these components in addition to the real-time API 425, the batch API 433, and a graph database 413 storing graph data with risk scores previously described. The system 400 may be configured to determine a network operation risk score for a new network operation, update the graph database 413 with a new edge (e.g., a new relationship) or updated relationship data for the new network operation (e.g., new entities from the network operation, new network operation scores or average scores for the same network path, etc.), identify a node associated with an entity from the graph database 413, identify one or more edges between the node and one or more nodes connected to the identified node, aggregate the network operation risk score of each of the one or more edges to generate a composite network operation risk score, and execute a model using one or more attributes of the entity and the composite network operation risk score to generate an entity risk score for the entity.

The graph database 413 may store a network of nodes and edges between the nodes, digitally representing types of relationships between entities represented by the nodes. Each of one or more edges can include a network operation risk score representing the risk that the network operation represented by the edge is compromised. The graph database 413 may store edge-level risk outputs generated for prior network operations and may expose the stored risk outputs to downstream entity-level services. The system 400 can operate on top of (e.g., using, with, etc.) the compromised network operation detection framework of FIG. 4A to derive node-level or entity-level risk from accumulated edge-level risk across the graph. For example, each node of the graph database 413 may represent an entity (e.g., a company, business, organization, product, person, etc.), and the edges, representing network operations, may include one or more network operation risk scores for the relationship. The one or more network operation risk scores may be an average of the risk scores for operations traversing the edge, a listing of all risk scores for operations having traversed the edge, or any other suitable statistic or operation for the risk scores related to an edge in the graph database 413.

In some embodiments, the system 400 may perform a number of operations to maintain current entity risk assessments, relationships, and/or edge risk scores for network operations. For example, a new network operation involving an existing entity may lead to a new relationship between two existing entities represented by nodes in the graph database 413. In another example, the new network operation may lead to the creation of a new entity node and a new relationship to a first entity already stored in the graph database 413. To do so, the system 400 may parse the network operation data to identify one or more entities participating in the network operation and determine, using an entity resolution process, whether corresponding nodes already exist in the graph database 413. Responsive to determining that a participating entity does not correspond to an existing node, the system 400 may allocate storage for a new node associated with the entity and populate the new node with one or more attributes of the entity, such as a name, location, region, owner, function, or type. The system 400 may then generate a new edge attached to the node for the entity and a complementary node opposite the node for the entity, the new edge digitally representing a type of relationship between the entities and storing metadata for the network operation, including the new network operation risk score for the new network operation. In some embodiments, responsive to generating the new edge for the new network operation, the system 400 updates a composite network operation risk score for a node associated with the entity and can re-execute a model to generate an updated entity risk score for the entity.

In some embodiments, the system 400 includes the network operation risk score service 501. The network operation risk score service 501 may be configured to obtain or generate network operation risk scores for new network operations and to cause those scores to be reflected in the graph database 413. The network operation risk score service 501 may interface with the real-time API 425 and/or the batch API 433 of the network operation processing system 499 to submit records for scoring, receive resulting network operation risk scores, and associate the resulting scores with corresponding relationships in the graph database 413. In some embodiments, the network operation risk score service 501 may operate as an orchestrating service in the internal services 419 layer, allowing upstream business logic or operational systems to request scoring for a prospective or newly observed network operation before or after completion of the network operation.

The network operation risk score service 501 may be configured to receive network operation data identifying one or more entities as a source of a transfer or a destination of the transfer of one or more networked items. Based on the network operation data, the network operation risk score service 501 can determine whether the graph database 413 already stores nodes corresponding to the participating entities and whether an existing edge already represents the relevant type of relationship. If the entities already exist, the network operation risk score service 501 can cause a new edge to be generated between the corresponding nodes or can update an existing edge data structure with a new network operation instance and the associated network operation risk score. If one of the entities does not already exist, the network operation risk score service 501 can cause a new node to be created in the graph database 413 together with a new edge attached to the node for the entity. In some embodiments, the new edge is attached to the node for the entity responsive to the network operation data identifying the entity as the source of the transfer or the destination of the transfer

The network operation risk score service 501 may further support dynamic updates of entity-level risk in a live graph environment. For example, because the network operation risk score service 501 can continuously receive records for new network operations, the service can repeatedly generate or obtain new network operation risk scores and update the graph database 413 without requiring a full retraining or reconstruction of the underlying graph. The processing of new records for new network operations by the network operation risk score service 501 can facilitate a continuously updating graph with edge-level risk scores.

In some embodiments, the system 400 includes the entity risk API 503. The entity risk API 503 may provide an interface for submitting requests to determine the risk score for an entity represented within the graph database 413. The entity risk API 503 may accept requests from internal services 419, client devices, administrative tools, user interfaces, investigation workflows, or other applications that require an entity-level assessment derived from graph context. For example, a request to the entity risk API 503 may identify a particular company, person, facility, user, or other entity node. The entity risk API 503 may accept optional parameters for entity risk determination, including filtering parameters that constrain (e.g., determine, control, govern, etc.) which relationships should be used for the risk determination.

In some embodiments, the entity risk API 503 can request data related to the entity from the graph database 413. The requested data may include all or a subset of the relationships connected to the entity and their corresponding network operation risk scores. For example, the entity risk API 503 may identify one or more edges between the node and one or more nodes connected to the node in the network graph data structure. The entity risk API 503 may also request one or more attributes of the entity from the node of the entity in the network graph data structure. Non-limiting examples of such attributes include location, region, owner, function, type, role, industry, identifiers, and other metadata stored in node field-value pairs as described for graph nodes elsewhere in this disclosure.

The entity risk API 503 may support filtering, scoping, and query refinement prior to downstream scoring. For example, the entity risk API 503 may filter the relationships by category of relationship, type of related entity, directionality of the relationship, recency, volume, importance, or risk characteristics. In some embodiments, the entity risk API 503 requests only a subset of edges matching specified criteria, such as shipment relationships, ownership relationships, facility-transfer relationships, or communications relationships. The entity risk API 503 may thereby retrieve data that is more targeted to a requested use case, such as compliance screening, business interruption analysis, geopolitical exposure analysis, or other categories for which a risk score, suspicion level, or degree of compromise can be determined. The entity risk API 503 can support flexible entity-level assessment while maintaining a common scoring architecture.

In some embodiments, the entity risk API 503 may also return the entity risk score for reporting and can provide structured response fields using a particular (e.g., predefined) output schema. For example, a response may include an entity identifier, a calculated entity risk score, a categorical disposition, a confidence value, and explanatory information such as contributing edge scores, summary statistics, or the most influential connected nodes.

In some embodiments, the system 400 includes the risk score aggregator 505. The risk score aggregator 505 may be configured to aggregate network operation risk scores obtained from edges connected to a node associated with an entity. The risk score aggregator 505 may receive edge-level scores from the graph database 413, either directly or through the entity risk API 503, and can generate a composite network operation risk score for the entity. The composite network operation risk score can summarize the risk represented by historical or current network operations associated with the entity. The composite network operation risk score may include multiple risk scores related to the entity and/or multiple summary statistics for the risk scores related to the entity.

The risk score aggregator 505 may implement any of a variety of aggregation techniques. For example, the risk score aggregator 505 may determine an average of the network operation risk scores, a weighted average, a sum, a rank-based selection, or another function. For example, the risk score aggregator 505 may generate weights for the network operation risk scores based on the frequency with which a particular edge in the graph database 413 is traversed (e.g., a particular network operation is performed). The risk score aggregator 505 may keep a count associated with network operations and increment the count each time another network operation is performed that traverses an edge in the graph database 413.

In some embodiments, the composite network operation risk score is adjusted recursively as new network operations are performed (and network operation risk scores are calculated). For example, the risk score aggregator 505 may increase or decrease the composite network operation risk score by an amount each time a network operation is performed. The amount by which the composite network operation risk score is increased or decreased may be based on the entity risk score of the other entity participating in the network operation with the entity for which the composite risk score is being calculated (e.g., based on an entity represented by a complementary node on the opposite side of the edge created for the new network operation). Weights and/or adjustment amounts may be based on the frequency or recency of network operations, as well as characteristics of the other participating entity (e.g., complementary node). For example, the adjustment may be based on whether the complementary node itself has a higher risk score, is compromised, is located in a sensitive region, or is associated with a restricted entity type. In some embodiments, more recent operations, higher-volume operations, or repeated operations with the same complementary node may receive greater weight in the adjustment.

The risk score aggregator 505 may also sort or otherwise organize multiple risk scores for input to the entity risk scoring model 507. For example, rather than only outputting a single scalar average, the risk score aggregator 505 may provide the top five risk scores, the top ten risk scores, or another set of risk scores. In some embodiments, the risk score aggregator 505 may output a number of network operation risk scores as well as a number of statistics related to the network operation risk scores. For example, the risk score aggregator 505 may output a set of percentile values, a median, a variance, a standard deviation, an average, or another statistical characterization of the distribution of edge risk around the entity. In some embodiments, these outputs can preserve more of the structure of the entity's local risk neighborhood than a simple average. Advantageously, the additional statistics may improve the ability of the entity risk scoring model 507 to distinguish between compromised and uncompromised entities, for example, between an entity with many moderately risky relationships and an entity with one or two extremely risky relationships.

In some embodiments, the system 400 includes the entity risk scoring model 507. The entity risk scoring model 507 may be any type of machine learning model, such as a neural network, a transformer model, a perceptron machine, a gradient boosting model, a support vector machine, a random forest, or another model architecture described elsewhere in this disclosure. The entity risk scoring model 507 may be configured to execute using one or more attributes of the entity and the composite network operation risk score to generate an entity risk score for the entity. The entity risk scoring model 507 can accept as input the outputs of the risk score aggregator 505 together with node-level attributes retrieved from the graph database 413. In some embodiments, the entity risk scoring model 507 includes or queries the model endpoint 441. The entity risk scoring model 507 may also include portions of the model endpoint 441. For example, the entity risk scoring model 507 may perform a contact check, an entity check, a goods check, and/or a geospatial check as described with reference to FIG. 4B. As another example, the entity risk scoring model 507 may also include one or more of the scoring models from the sequence 406.

The entity risk scoring model 507 may be configured to learn relationships between structural graph exposure and intrinsic entity properties. For example, the entity risk scoring model 507 may determine that identical composite network operation risk scores should yield different entity risk scores depending on whether the entity is a facility, a person, a logistics intermediary, a regulated party, a financial actor, or a communications endpoint. Similarly, the entity risk scoring model 507 may use attributes such as location, region, owner, function, industry, or operational role to calibrate the significance of connected edge risk. Thus, two nodes with the same edge-level profile may receive different entity risk scores because their node attributes indicate different operational contexts or baseline thresholds.

The entity risk scoring model 507 may be re-executed as the graph database 413 changes. For example, responsive to generating the new edge for the new network operation, the system can update the composite network operation risk score for an entity or node representing an entity based on the new network operation risk score and re-execute the model using the one or more attributes of the entity and the updated composite network operation risk score to generate an updated entity risk score for the entity. For example, a user can use the entity risk API 503 to subscribe to updates to the entity risk score for a node. Each time there is an update to an entity or a relationship for the entity (e.g., a new edge connected with the node representing the entity), the internal services 419 may trigger the process of aggregation (e.g., by the risk score aggregator 505) and recalculation of the entity risk score by the entity risk scoring model 507.

The entity risk scoring model 507 may provide outputs to the entity risk API 503 for reporting and to internal services 419 for downstream processing. In some embodiments, responsive to determining the entity risk score exceeds a threshold or multiple progressive thresholds, the internal services 419 may generate an alert for the entity, initiate an investigation, restrict future network operations involving the entity, block network operations from the entity, or cause the entity to be taken off the network. In some implementations, this can include identifying a second new network operation involving the compromised network node and restricting the second new network operation responsive to determining the updated entity risk score for the entity exceeds the threshold. In some cases, restricting the second new network operation may include transmitting a control signal to a network switch or other system component to isolate the compromised network node from further network communications.

The internal services 419 may use a progressive set of multiple thresholds with which to compare the entity risk score. For example, if a first threshold is exceeded, the internal services 419 may generate an alert; if a second (e.g., higher) threshold is exceeded, an investigation may be initiated to determine the level of compromise of the entity. The internal services 419 may initiate a number of automated actions based on the entity risk score and the thresholds. In some embodiments, after an entity is identified as compromised, future network operation risk scores originating from and/or destined to the compromised entity may have an increased network operation risk scores. For example, a list of compromised entities may be stored and used when executing the model endpoint 441 (e.g., any of the checks therein).

FIG. 5A also shows a sequence of operations and/or data flows that can be performed by the system 400 to calculate an entity risk score, according to some embodiments. In some embodiments, operation 510 includes transmitting a request from the network operation risk score service 501 to the real-time API 425 or the batch API 433 of the network operation processing system 499. For example, operation 510 may include the network operation risk score service 501 receiving network operation data for a new network operation of an entity and routing that network operation data to an appropriate scoring endpoint based on urgency, volume, or service-level requirements. In some embodiments, the request may identify the source entity, destination entity, one or more networked items, and descriptive or contextual metadata for the new network operation so that the network operation processing system 499 can generate a new network operation risk score using the techniques described herein.

The operation 510 may also include selecting between real-time and batch processing modes. For example, the network operation risk score service 501 may direct a single high-priority or time-sensitive operation to the real-time API 425 while directing a larger collection of lower-immediacy operations to the batch API 433. By doing so, the network operation risk score service 501 can use the APIs to determine a risk score for new network operations while preserving the operational distinctions between the endpoint types already described for the network operation processing system 499.

In some embodiments, operation 512 can include updating the graph database 413 with the result of the network operation scoring process. For example, responsive to receiving a network operation risk score from the real-time API 425 or the batch API 433, the network operation processing system 499 can generate, based on the network operation data, a new edge for the new network operation, including a new network operation risk score for the new network operation. If the new network operation reflects a new relationship between two entities already represented in the graph database 413, the operation 512 may include adding the edge between the corresponding nodes. If the new network operation introduces a previously unseen entity, the operation 512 may include creating a new node and attaching the new edge to the node for the entity. The operation 512 may further include storing or updating edge attributes in the graph database 413. For example, the edge may store the network operation risk score itself, timestamps, item descriptions, source and destination identifiers, transport metadata, or other explanatory data used to support future entity-level or operation-level analysis. The edge may update the risk score for the edge based on the network operation's risk score for the new network operation. The operations 510 and 512 may be used to keep the graph database 413 up to date in order to generate entity risk scores. In some embodiments, an update of the graph database 413 (e.g., by the operation 512) can trigger determination of the entity risk score for any entity for which a connected relationship was updated.

The operations 520-526 illustrate the path of data flow as a request for determining the entity risk score is received by the entity risk API 503, according to some embodiments. In some embodiments, operation 520 can include transmitting a request from the entity risk API 503 to the graph database 413 to retrieve data for a selected entity. For example, the entity risk API 503 may receive a request including an identification of a node associated with an entity and may query the graph database 413 to identify one or more attributes of the entity from the node of the entity in the network graph data structure. The same operation may also include identifying one or more edges between the node and one or more nodes connected to the identified node, each of the one or more edges including a network operation risk score. As described above, the request transmitted during the operation 520 may include any desired filtering or scoping of the data. For example, the entity risk API 503 may request all connected relationships or only a subset of relationships filtered by category, type of related entity, recency, risk level, operational role, or directionality. The operation 520 may thereby enable downstream components to operate on the full neighborhood of the entity or on a targeted portion of that neighborhood depending on the use case.

In some embodiments, operation 522 can include distributing data to downstream scoring components from the graph database 413. For example, the graph database 413 can respond with node attributes for the requested entity and with one or more corresponding edge-level network operation risk scores for relationships connected to the entity. In some embodiments, network operation risk scores may be directed to the risk score aggregator 505 for preparation (e.g., aggregation, organization, etc.) for use as input by the entity risk scoring model 507, whereas attributes for the entity may be directed to the entity risk scoring model 507.

In some embodiments, operation 524 can include transmitting aggregated relationship risk information from the risk score aggregator 505 to the entity risk scoring model 507. For example, after receiving one or more edge-level network operation risk scores from the graph database 413, the risk score aggregator 505 can aggregate the network operation risk score of each of the one or more edges to generate a composite network operation risk score. The operation 524 may include passing that composite network operation risk score (e.g., a statistic, multiple risk score statistics, the top-k network operation risk scores associated with the entity by an edge, etc.) to the entity risk scoring model 507.

In some embodiments, operation 526 can include outputting the entity risk score from the entity risk scoring model 507 to the entity risk API 503. For example, after executing the model using the one or more attributes of the entity and the composite network operation risk score, the entity risk scoring model 507 can provide the entity risk score to the entity risk API 503 for reporting to a requesting system, user interface, or internal workflow. The returned information may include the entity risk score itself and may also include supporting explanation data, confidence values, threshold comparisons, or indicators of contributing risk factors. The operation 526 may cause a responsive action by internal services 419. For example, responsive to determining the updated entity risk score for the entity exceeds a threshold, the entity risk API 503 or another component of internal services 419 may generate an alert identifying the node as a compromised network node.

FIG. 5B illustrates example flowcharts of processes 530 and 550 for compromised entity operation detection, according to some embodiments. A data processing system (e.g., the system 400) can perform the processes 530 and 550 to detect compromised network entities. The processes 530 and 550 are shown operating in parallel, where a first process can continuously update a composite network operation risk score for an entity as new network operation data is received and reflected in a network graph data structure, while a second process can use the most up-to-date composite network operation risk score to calculate or recalculate an entity risk score and determine whether the entity should be identified as a compromised network node.

In some embodiments, the parallel arrangement illustrated in FIG. 5B can facilitate maintaining a live or near-real-time entity-level risk detection without requiring a complete re-computation of all graph-derived metrics for each request. For example, process 530 can operate as an updating path that ingests newly observed network operation data, identifies the corresponding node and connected edges, generates or associates a new network operation risk score with a new edge, and updates the composite network operation risk score for the entity. In parallel, process 550 can operate as a scoring and decision path that receives requests to calculate entity risk, retrieves one or more attributes of the entity, and executes a model using those attributes together with the most recently available composite network operation risk score to determine whether the entity risk score exceeds a threshold.

At operation 532, network operation data for a new network operation of the entity is received. The operation 532 may include receiving structured or semi-structured network operation data identifying an entity as a source of a transfer, a destination of a transfer, or another participant in a network operation. For example, the operation 532 may include receiving the data from an internal service, an upstream application, the real-time API 425, the batch API 433, or another component that provides newly observed operation records. The operation 532 may include parsing the incoming record to identify participating entities, transferred items, timestamps, route information, and descriptive metadata that can be used to determine how the new network operation should be represented in the network graph data structure. The outcome of the operation 532 may include making the new network operation available for graph-based association with an entity node and for downstream updating of graph-connected risk data. In some embodiments, the operation 532 is performed by the network operation risk score service 501.

At operation 534, a node associated with an entity in a network graph data structure representing types of relationships between entities represented by the network of nodes may be identified. The identified node may correspond to the entity participating in the new network operation. For example, the operation 534 may include performing entity resolution using one or more identifiers such as a name, address, account identifier, facility identifier, or other metadata from the received network operation data. In some embodiments, the operation 534 includes matching the incoming entity data to an existing node using text similarity, semantic similarity, rules-based matching, or combinations thereof, and may include allocating a new node if a suitable match is not found. The outcome of the operation 534 may include associating the new network operation with a graph node that can be used to identify connected relationships and update entity-level risk context. In some embodiments, the operation 534 is performed by the network operation risk score service 501.

At operation 536, one or more edges between the node and one or more nodes connected to the node in the network graph data structure may be identified. Each of the one or more edges may include a network operation risk score. The operation 536 may include querying the graph database 413 to identify relationships already connected to the entity node. The one or more edge data structures that store or reference network operation risk scores may correspond to prior operations involving the entity and one or more complementary nodes. In some embodiments, the operation 536 includes filtering the identified edges based on recency, type of relationship, operational role, or other criteria, while still preserving one or more risk values that characterize the entity's local graph neighborhood. The outcome of the operation 536 may include identifying the set of graph-connected risk-bearing edges that are to be used to compute a composite network operation risk score for the entity. For example, the operation 536 may be performed by the network operation risk score service 501.

At operation 538, the network operation risk scores of each of the one or more edges may be aggregated to generate a composite network operation risk score. The operation 538 may include combining the edge-level network operation risk scores identified for the entity node into a composite network operation risk score that summarizes graph-connected operational risk for the entity. The operation 538 may include averaging, weighting, summing, ranking, or otherwise combining the edge-level scores. In some embodiments, the operation 538 may include weighting one or more edge scores based on recency, frequency of interaction, type of related node, prior compromise indicators, or other characteristics of the complementary nodes or edge relationships. The outcome of the operation 538 may include generating a composite risk measure that can be updated over time and supplied to entity-level scoring models as a graph-derived feature. The composite network operation risk score may include multiple statistics (e.g., average, variance, etc.) and/or multiple network operation risk scores (e.g., top ten, top five, etc.). For example, the operation 538 may be performed by the risk score aggregator 505.

At operation 540, a new edge for the new network operation, including a new network operation risk score for the new network operation, may be generated based on the network operation data. The new relationship may be generated in the graph database 413 and correspond to the newly received network operation. The operation 540 may include causing a new edge data structure to be created between the identified entity node and a complementary node associated with another participant in the network operation. Where the complementary node for a second entity does not exist in the graph database 413, it may be generated. In some embodiments, the operation 540 may include obtaining or generating a new network operation risk score for the new network operation using the compromised network operation detection techniques described herein, and storing that score as part of the new edge or in association with the edge. The outcome of the operation 540 may include updating the network graph data structure to reflect the latest operation and its risk contribution within the graph. In some embodiments, the operation 540 is performed by the network operation risk score service 501.

At operation 542, the composite network operation risk score may be updated based on the new network operation risk score. The operation 542 may include recalculating, revising, or incrementally adjusting the previously generated composite network operation risk score to account for the new edge and its associated network operation risk score. The operation 542 may include increasing or decreasing the composite network operation risk score by a weighted amount determined from the newly added relationship, the complementary node opposite the entity node, or one or more aggregation rules. In some embodiments, the operation 542 includes updating a stored composite network operation risk score in a data structure associated with the entity or making the revised composite score available to parallel scoring services. The outcome of the operation 542 may include maintaining a most-up-to-date composite network operation risk score that can be used by process 550 when calculating entity risk. In some embodiments, the operation 542 may be performed by the risk score aggregator 505.

The process 550 can operate as a scoring and decision path that receives requests to calculate entity risk, retrieves one or more attributes of the entity, and executes a model using the one or more attributes together with the most recently available composite network operation risk score from the process 530. At operation 552, a request to calculate an entity risk score for the entity may be received. The operation 552 may include receiving a request through the entity risk API 503, internal services 419, an administrative interface, an investigation workflow, or another application requesting a graph-informed risk determination for an entity. The operation 552 may include identifying the target entity or node and initiating retrieval of graph-stored attributes and the most recently updated composite network operation risk score. In some embodiments, the operation 552 may be triggered asynchronously in response to a graph update or synchronously in response to an explicit API call. The outcome of the operation 552 may include initiating an entity-level scoring flow that uses current graph-derived risk context.

At operation 554, one or more attributes of the entity from the node of the entity in the network graph data structure may be identified. The operation 554 may include querying the node corresponding to the entity for which the entity risk score is to be calculated. One or more stored attributes of the entity may be retrieved for scoring. The operation 554 may include identifying and/or retrieving node field-value pairs such as name, location, region, owner, type, role, function, industry, identifiers, or other metadata associated with the entity. In some embodiments, the operation 554 includes preparing the attributes for model input by normalizing values, encoding categorical attributes, generating embeddings from descriptive values, or selecting a subset of relevant features. The outcome of the operation 554 may include producing entity-specific contextual data for combination with the most recent composite network operation risk score. The operation 554 may be performed by the entity risk API 503 and/or the graph database 413.

At operation 556, a model may be executed using the one or more attributes of the entity and the composite network operation risk score to generate an entity risk score for the entity. The operation 556 may include executing a machine learning model, rules-based model, or hybrid model using as inputs the entity attributes identified from the node and the most recently updated composite network operation risk score generated in process 530. The operation 556 may include generating an entity risk score that reflects both the intrinsic characteristics of the entity and the graph-derived composite network operation risk score or scores. The outcome of operation 556 may include producing an entity risk score to be used for threshold comparison and downstream mitigation decisions. The operation 556 may be performed by the entity risk scoring model 507.

At operation 558, the entity risk score is compared to a threshold. The operation 558 may include comparing the generated entity risk score against a threshold to determine whether the entity should be treated as a compromised network node. The operation 558 may include applying one or more static or dynamic threshold values. For example, the threshold may be adjusted based on operational parameters, node type, or current network conditions. Where the threshold is not exceeded, the flow may return to the operation 552 and continue to monitor for new requests and/or changes to the graph database 413 that would trigger another calculation. Alternatively, when the entity risk score exceeds the threshold, one or more automated actions may be triggered by proceeding to the operation 560. The operation 558 may be performed by the internal services 419.

At operation 560, an alert identifying the node as a compromised network node may be generated in response to the entity risk score exceeding the threshold. The operation 560 may include generating an alert record, notification, or output message identifying the entity node as compromised responsive to determining that the entity risk score exceeds the threshold. The operation 560 may include storing the alert in a database, transmitting the alert to an internal service or client system, and associating the alert with explanatory information such as the entity risk score, contributing factors, or relevant connected relationships. In some embodiments, the operation 560 may include triggering one or more automated actions, such as escalating the entity for investigation, flagging future operations involving the entity, or preparing downstream restrictions. For example, the operation 558 may include comparing the entity risk score to progressively larger thresholds to trigger performance of progressive automated actions in the operation 560. The operation 560 may be performed by the entity risk API 503 or the internal services 419.

FIG. 5C illustrates an example flowchart of a process 570 for compromised entity detection, in accordance with some embodiments. A data processing system (e.g., the system 400) can perform the process 570 to detect compromised network entities. The process 570 is shown to identify an entity node and associated graph-connected edge risk scores, generate a composite network operation risk score using the network operations related to the entity (e.g., on edges connected to the entity), and update that entity risk score in response to newly received network operation data. The composite risk score may be used to identify entities whose risk score exceeds a threshold and to act upon the risk. The process 570 can include any number of operations or additional operations, and the operations may be performed in any order.

At operation 572, a node associated with an entity in a network graph data structure may be identified. The graph data structure represents types of relationships between entities represented by the network of nodes. The operation 572 may include identifying a node in the graph database 413 that corresponds to a particular entity for which risk is to be determined. For example, the operation 572 may include using an entity identifier provided in a request, a stored mapping, or an entity resolution process to locate the node. In some embodiments, the operation 572 may include retrieving the node from a graph data structure. The outcome of the operation 572 may include establishing the graph anchor point (e.g., starting point, base node, etc.) from which connected edge-level network operation risk scores and node attributes can be collected. The operation 572 may be performed by the entity risk API 503.

At operation 574, one or more edges between the node and one or more nodes connected to the node in the network graph data structure may be identified. Each of the one or more edges may include a network operation risk score that indicates a risk for the network operation between the node and a complementary node at the opposite end of the edge. The operation 574 may include traversing the graph database 413 from the identified entity node to connected nodes and retrieving one or more edges that store or reference network operation risk scores. The operation 574 may include identifying edges and, in some embodiments, selected categories of edges corresponding to relevant relationship types, risk scores, etc. The operation 574 may further include filtering the edges according to directionality, recency, relationship type, or other constraints for use in entity-level risk computation. The outcome of the operation 574 may include collecting operation-level risk values. For example, the collected network operation risk scores for connected edges may characterize the entity's surrounding operational exposure. The operation 574 may be performed by the entity risk API 503.

At operation 576, one or more attributes of the entity from the node of the entity in the network graph data structure may be identified. The operation 576 may include retrieving one or more attributes from the entity node, such as a location, region, owner, function, type, identifier, or other node metadata. The one or more attributes may be encoded or otherwise prepared for use by an entity risk scoring model. For example, text-based attributes (e.g., descriptions, etc.) may be converted into embeddings. In some embodiments, the operation 576 includes selecting a subset of attributes most predictive for compromised entity detection. The outcome of the operation 576 may include preparing entity-specific contextual inputs that can be used with graph-derived risk information. The operation 576 may be performed by the entity risk API 503.

At operation 578, the network operation risk score of each of the one or more edges is aggregated to generate a composite network operation risk score. The operation 578 may include combining the network operation risk scores from the identified edges into a composite network operation risk score for the entity. The operation 578 may include averaging, weighting, summing, ranking, or otherwise aggregating the edge-level scores to produce a graph-derived summary risk value. The operation 578 may include weighting scores according to recency, frequency, complementary node characteristics (e.g., nodes connected by graph edges), or other graph-based factors. The outcome of the operation 578 may include producing a composite network operation risk score that can represent various dimensions of the accumulated (e.g., aggregated) risk for the entity, for example, by summary statistics of the connected network operation risk scores and/or a sampling of the network operation risk scores (e.g., the top 5 scores in a sorted order, a random sampling of scores, all scores, etc.). The operation 578 may be performed by the risk score aggregator 505.

In some embodiments, aggregating the network operation risk score of each of the one or more edges to generate a composite network operation risk score can include generating, for each edge of the one or more edges, a corresponding network operation risk score by querying the edge to identify a source node of the edge, a destination node of the edge, and an item description of a networked item corresponding to a network operation of the edge. The operation 578 may include executing an embedding model using the item description of the networked item corresponding to the network operation of the edge to generate an embedding representing the networked item, and executing one or more models using the embedding representing the networked item and identifications of the source node of the edge and the destination node of the edge to generate the network operation risk score for the edge. For example, the operation 578 may include performing the process 408 or executing a model endpoint 441 to calculate the network operation risk score for the edges of the graph database 413 (e.g., the edges connected to the node of the entity). The operation may include deriving edge-level scores on demand or refreshing stored edge-level scores prior to aggregation so that the composite network operation risk score reflects current operation-level assessment logic. After the edge-level network operation risk scores have been determined or retrieved for the connected edges, the composite network operation risk score can be generated. The outcome may include the composite network operation risk score built from edge-level scores that themselves are generated from item description embeddings and graph-aware source and destination context. Determination of the edge-level network operation risk scores may be performed by the network operation processing system 499 (e.g., by way of the real-time API 425 and/or the batch API 433).

At operation 580, a model (e.g., a machine learning model, etc.) is executed using the one or more attributes of the entity and the composite network operation risk score to generate an entity risk score for the entity. The operation 580 may include executing a model that accepts as input the entity attributes and the composite network operation risk score to generate an entity risk score (e.g., one or more statistics related to the distribution of the edge-level network operation risk scores and/or one or more individual edge-level network operation risk scores). The operation 580 may include using a machine learning model trained to distinguish compromised entities from uncompromised entities based on graph-connected exposure and node-level (e.g., entity-level) context. In some embodiments, the operation 580 may include producing additional values such as confidence metrics, explanation values, or feature contribution values. For example, the machine learning model may output the features that caused an elevated entity risk score. In some embodiments, the outcome of the operation 580 may include generating an entity risk score that can be used as a baseline score before incorporation of newly received operation data (e.g., for determining the change in entity risk caused by a new network operation). Additionally, the entity risk score may be compared to a threshold value for triggering one or more automated actions. The operation 580 may be performed by the entity risk scoring model 507.

In some implementations, the data processing system can train the entity risk model in real-time. For example, the data processing system can generate, receive, or identify, a set of training data that includes data for individual nodes including entity attributes, composite network operation risk scores, and/or any other data regarding nodes. The data processing system can include labels indicating whether the nodes are compromised or not. The data processing system can use the labels with the data for the individual nodes to train the entity risk model, such as by using a loss function and backward-propagation techniques. The data processing system can iteratively train the entity risk model over time. In some cases, the data processing system can update the respective risk for nodes in the network graph data structure for each training session (e.g., of one or more lets of training data including data and labels for individual nodes). The data processing system can generate risk scores for nodes one at a time such that the data processing system can take each update into account when performing the updating and not having to generate scores for all of the nodes of the network graph data structure, which would otherwise be extremely computationally expensive given the dependencies of the scores for the respective nodes on each other.

At operation 582, network operation data for a new network operation of the entity may be received. The new network operation data may identify the entity as a source or a destination of a transfer involving one or more networked items. The operation 582 may include receiving the data from internal services, an upstream operational workflow, a scoring service, or another subsystem monitoring network activity. In some embodiments, the operation 582 may include identifying whether the new network operation is connected to the entity node and should trigger updating of the composite network operation risk score and re-execution of the entity risk model. The operation 582 may include introducing newly observed operational behavior into the entity-level risk determination pipeline. The operation 582 may be performed by the network operation risk score service 501 or other services of the internal services 419 or system 400.

At operation 584, a new edge for the new network operation is generated based on the network operation data. Generating the new edge may include generating a new network operation risk score for the new network operation. For example, the operation 584 may include activating the real-time API 425 or the batch API 433 to obtain a new network operation risk score for the network operation. In some embodiments, the operation 584 may include connecting (e.g., relating, etc.) the new edge to the entity node and to a complementary node corresponding to another participant in the network operation. For example, the operation 584 may include storing timestamps, item information, and additional operation metadata. The outcome of the operation 584 may include updating the graph data structure to reflect the new relationship and its associated operational risk. The operation 584 may be performed by the network operation risk score service 501.

At operation 586, the composite network operation risk score may be updated based on the new network operation risk score. The operation 586 may include recalculating or incrementally adjusting the composite network operation risk score to incorporate the risk represented by the newly created edge. The operation 586 may include increasing or decreasing the composite score according to an aggregation rule, a weighting function, or a relationship-sensitive update procedure. In some embodiments, the operation 586 may include considering the complementary node opposite the entity node, the type of relationship represented by the new edge, and the relative significance of the new network operation. The operation 586 may be performed by the risk score aggregator 505. For example, the risk score aggregator 505 may incorporate the new risk score into the inputs for the entity risk scoring model 507, or the risk score aggregator 505 may recalculate the inputs for the entity risk scoring model 507 by performing a recalculation based on previously stored network operation risk scores.

In some embodiments, updating the composite network operation risk score can include increasing or decreasing the composite network operation risk score by a weighted amount. For example, the weighting may be based at least in part on, or determined using, a complementary node of the new edge (e.g., the edge added during the operation 584), opposite the node. The operation may include selecting a weight based on whether the complementary node is itself high risk, belongs to a sensitive class of entities, is frequently connected to compromised operations, or is otherwise indicative of elevated risk. For example, the contribution of the new edge may depend not only on its own operation-level score but also on graph context associated with the node at the opposite end of the edge.

In some embodiments, responsive to determining that the updated entity risk score for the entity exceeds the threshold, a set of nodes connected to the node of the entity by one or more edges may be identified, and entity risk scores for each of the set of nodes may be adjusted based on the determination that the updated entity risk score for the entity exceeds the threshold, as part of a propagation operation associated with updating graph risk state. The operation may include traversing outward from the compromised entity node and propagating risk adjustments to neighboring nodes so that the graph reflects proximity-based exposure. The outcome may include updating risk scores not only for the entity itself but also for connected entities that may warrant heightened scrutiny.

In some embodiments, adjusting the entity risk scores for each of the set of nodes can include, for each node of the set of nodes, incrementing a counter for each edge between the compromised network node and the node and adjusting the entity risk score for the node of the set of nodes by a weighted factor according to the incremented counter. For example, the operation 586 may use the frequency or multiplicity of graph connections as a basis for scaling propagated risk. Nodes with repeated or denser connectivity to the compromised node may receive larger adjustments.

In some embodiments, adjusting entity risk scores for each of the set of nodes based on the updated entity risk score can include performing a broader neighbor-adjustment operation regardless of whether the threshold for the entity has yet been exceeded. The operation may include using the updated entity risk score itself as a signal for recalibrating risk scores of connected nodes in the graph. For example, the change in the risk score of a node for the entity can be propagated along the edges representing network operations using a decaying weight such that those nodes directly connected to the updated entity receive a first percent of the change and nodes connected through two edges receive a second percent of the change (e.g., the square of the first percent, etc.).

At operation 588, the model is re-executed using the one or more attributes of the entity and the updated composite network operation risk score to generate an updated entity risk score for the entity. The operation 588 may include executing the same or similar entity risk scoring model that was used at operation 580, but with the updated composite network operation risk score generated at operation 586. The operation 588 may include recalculating the entity risk score so that the model output reflects the newly incorporated graph update. In some embodiments, the operation 588 may include generating explanation data or confidence information associated with the updated score. The operation 588 may be performed by the entity risk scoring model 507.

At operation 590, the updated entity risk score is compared to one or more thresholds. For example, the operation 590 may include comparing the updated entity risk score to a threshold to determine whether the entity should now be treated as a compromised network node and/or whether an automated action should be performed. The operation 590 may include using a baseline threshold, a dynamically adjusted threshold, or a threshold derived from operational conditions. When the updated entity risk score does not exceed any thresholds, the flow may return to continue to monitor subsequent network operations involving the entity, thereby facilitating updates in the entity risk score as new operations are performed. Where the threshold is exceeded, one or more automated actions may be performed. For example, at operation 592, an alert identifying the node as a compromised network node may be generated.

In some embodiments, determining the threshold can include retrieving a baseline threshold value associated with a type of the node of the entity, adjusting the baseline threshold value in real time based on at least one measured operational parameter from the computing device network, the at least one measured operational parameter including a frequency of network operations performed within a defined time period ending at a current time, and storing the adjusted threshold value as the threshold for comparison with the updated entity risk score. The operation may include making threshold selection sensitive to the operational environment so that high-volume or rapidly changing network conditions can influence how aggressively compromised entities are identified.

Additional progressive actions may be performed (e.g., as the entity risk score increases and/or exceeds new thresholds). In some embodiments, future network operations involving the compromised network node are restricted (e.g., not performed or otherwise affected). Performing the automated actions may include monitoring subsequent requested or observed network operations involving the compromised node, detecting a second new network operation associated with that node, and automatically applying a restriction, hold, block, or review requirement based on the already determined elevated entity risk score. The outcome may include preventing additional risky activity from being completed after the node has been identified as compromised. The operation 592 may be performed by the internal services 419.

In some embodiments, the risk scores for nodes can indicate a level of risk of a sub-graph data structure including the respective nodes. For example, in some cases, the nodes themselves may not intentionally or purposefully perform compromised network operations, but rather be a part of a sub-graph data structure in which another node performs a compromised network operation that propagates through the respective nodes. In such cases, a data processing system can generate the scores for the nodes as described herein (e.g., based at least on the network operation risk scores of the edges connected with the nodes), based on each of the edges of the sub-graph data structure of the node, and/or based on one or more tiers of edges connected with the respective nodes, in some cases in addition to any other data as described herein. The data processing system can generate such scores for each node of the sub-graph data structure. In some cases, the data processing system can generate a composite score for the sub-graph data structure based on or as a function of the scores of the nodes of the sub-graph data structure and/or any other data of the nodes and/or edges. The data processing system can append the composite score to the sub-graph data structure for further analysis and/or compare the composite score a threshold. The data processing system can flag the sub-graph data structure with a risky flag responsive to determining the composite score exceeds or otherwise satisfies the threshold. In some cases, the data processing system can iteratively regenerate the composite score for each new edge and/or newly generate score for a node of the sub-graph data structure. In doing so, the data processing system can automatically detect compromised sub-graph data structures in an isolated manner and without processing the data of the entire network graph data structure.

Implementing this method provides several technical benefits for detecting compromised network nodes in a computing device network. By representing entities and their relationships in a network graph data structure, the system can capture both node-specific attributes and edge-based interaction risk in a form that is computationally efficient and configured for identifying compromise patterns that may not be visible from isolated event analysis. Aggregating network operation risk scores across edges into a composite network operation risk score facilitates the processors to quantify the cumulative effect of multiple related operations, improving detection accuracy for lateral movement, privilege abuse, or coordinated anomalous activity. The ability to generate a new edge from incoming network operation data, update the composite score in response, and re-execute the model produces real-time risk reassessment without rebuilding the entire graph or recomputing all prior activity, thereby reducing processing overhead and improving responsiveness. Combining entity attributes with dynamically updated relational risk data in the model further enhances precision and lowers false positives relative to static rule-based systems. As a result, the systems and methods described herein can improve the functioning of network security monitoring systems by enabling faster, less resource intensive, more scalable, and more context-aware identification of compromised network nodes.

In some embodiments, restricting the second new network operation can include transmitting a control signal to a network switch to isolate the compromised network node from further network communications. The operation may include converting the compromised-node determination into a machine control action directed to network infrastructure. For example, the action may be directed towards a switch, gateway, router, or other network control component capable of reducing, interrupting, or isolating communications associated with the compromised node. Other automated actions may also be initiated based on the entity risk score. For example, an investigation may be performed, sanctions may be entered (e.g., loss of transport rights, etc.), or the entity may be removed from the network.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “of” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

1. A method for detecting compromised network nodes in a computing device network based on edges between nodes of the computing device network, comprising:
identifying, by one or more processors, a node of a network graph data structure and associated with an entity, the network graph data structure storing a network of nodes and edges between the network of nodes digitally representing types of relationships between entities represented by the network of nodes;
identifying, by the one or more processors, one or more attributes of the entity from the node of the entity in the network graph data structure;
identifying, by the one or more processors, one or more edges between the node of the entity and one or more nodes connected with the node of the entity in the network graph data structure, each edge of the one or more edges comprising a network operation risk score;
aggregating, by the one or more processors, the network operation risk score of each edge of the one or more edges to generate a composite network operation risk score;
executing, by the one or more processors, a model using the one or more attributes of the entity and the composite network operation risk score to generate an entity risk score for the entity;
receiving, by the one or more processors, network operation data for a new network operation of the entity;
generating, by the one or more processors based on the network operation data, a new edge for the new network operation comprising a new network operation risk score for the new network operation;
responsive to generating the new edge for the new network operation, updating, by the one or more processors, the composite network operation risk score based on the new network operation risk score;
re-executing, by the one or more processors, the model using the one or more attributes of the entity and the updated composite network operation risk score to generate an updated entity risk score for the entity; and
responsive to determining the updated entity risk score for the entity exceeds a threshold, generating, by the one or more processors, an alert identifying the node of the entity as a compromised network node.

2. The method of claim 1, further comprising:
identifying, by the one or more processors, a second new network operation involving the compromised network node; and
restricting, by the one or more processors, the second new network operation responsive to the determining the updated entity risk score for the entity exceeds the threshold.

3. The method of claim 2, wherein restricting the second new network operation comprises:
transmitting, by the one or more processors, a control signal to a network switch to isolate the compromised network node from further network communications.

4. The method of claim 1, further comprising generating the network operation risk score for each edge of the one or more edges by, for each edge of the one or more edges:
querying, by the one or more processors, the edge to identify a source node of the edge, a destination node of the edge, and an item description of a networked item corresponding to a network operation of the edge;
executing, by the one or more processors, an embedding model using the item description of the networked item corresponding to the network operation of the edge to generate an embedding representing the networked item; and
executing, by the one or more processors, one or more models using the embedding representing the networked item and identifications of the source node of the edge and the destination node of the edge to generate the network operation risk score for the edge.

5. The method of claim 1, wherein receiving the network operation data for the new network operation of the entity comprises:
receiving, by the one or more processors, the network operation data identifying the entity as a source of a transfer or a destination of the transfer of a second networked item;
generating, by the one or more processors, the new edge attached to the node of the entity for the entity responsive to the network operation data identifying the entity as the source of the transfer or the destination of the transfer of the second networked item; and
triggering, by the one or more processors, the updating of the composite network operation risk score of the entity responsive to determining the new edge is attached to the node of the entity.

6. The method of claim 1, wherein updating the composite network operation risk score comprises:
increasing or decreasing, by the one or more processors, the composite network operation risk score by a weighted amount determined at least by a complementary node of the new edge opposite the node of the entity.

7. The method of claim 1, further comprising:
responsive to determining the updated entity risk score for the entity exceeds the threshold, identifying a set of nodes connected with the node of the entity by one or more edges; and
adjusting, by the one or more processors, entity risk scores for each node of the set of nodes based on the determining the updated entity risk score for the entity exceeds the threshold.

8. The method of claim 7, wherein adjusting the entity risk scores for each node of the set of nodes comprises, for each node of the set of nodes:
incrementing, by the one or more processors, a counter for each edge between the compromised network node and the node of the set of nodes; and
adjusting, by the one or more processors, the entity risk score for the node of the set of nodes by a weighted factor according to a count of the incremented counter.

9. The method of claim 1, further comprising:
responsive to determining the updated entity risk score, identifying a set of nodes connected with the node of the entity by one or more edges; and
adjusting, by the one or more processors, entity risk scores for each node of the set of nodes based on the updated entity risk score.

10. The method of claim 1, further comprising determining the threshold, by:
retrieving, by the one or more processors, a baseline threshold value associated with a type of the node of the entity;
adjusting, by the one or more processors, the baseline threshold value in real time based on at least one measured operational parameter from the computing device network, the at least one measured operational parameter including a frequency of network operations performed within a defined time period ending at a current time; and
storing, by the one or more processors, the adjusted threshold value as the threshold for comparison with the updated entity risk score.

11. A system for detecting compromised nodes in a computing device network based on edges between nodes of the computing device network, comprising:
one or more processors; and
one or more non-transitory computer-readable media storing instructions that, when executed by the one or more processors, cause the system to:
identify a node of a network graph data structure and associated with an entity, the network graph data structure storing a network of nodes and edges between the network of nodes digitally representing types of relationships between entities represented by the network of nodes;
identify one or more attributes of the entity from the node of the entity in the network graph data structure;
identify one or more edges between the node of the entity and one or more nodes connected with the node of the entity in the network graph data structure, each edge of the one or more edges comprising a network operation risk score;
aggregate the network operation risk score of each edge of the one or more edges to generate a composite network operation risk score;
execute a model using the one or more attributes of the entity and the composite network operation risk score to generate an entity risk score for the entity;
receive network operation data for a new network operation of the entity;
generate, based on the network operation data, a new edge for the new network operation comprising a new network operation risk score for the new network operation;
responsive to generating the new edge for the new network operation, update the composite network operation risk score based on the new network operation risk score;
re-execute the model using the one or more attributes of the entity and the updated composite network operation risk score to generate an updated entity risk score for the entity; and
responsive to determining the updated entity risk score for the entity exceeds a threshold, generate an alert identifying the node of the entity as a compromised network node.

12. The system of claim 11, wherein the instructions also cause the system to:
identify, by the one or more processors, a second new network operation involving the compromised network node; and
restrict, by the one or more processors, the second new network operation responsive to the determining the updated entity risk score for the entity exceeds the threshold.

13. The system of claim 12, wherein restricting the second new network operation comprises:
transmitting a control signal to a network switch to isolate the compromised network node from further network communications.

14. The system of claim 11, wherein the instructions also cause the system to generate the network operation risk score for each edge of the one or more edges by, for each edge of the one or more edges:
querying the edge to identify a source node of the edge, a destination node of the edge, and an item description of a networked item corresponding to a network operation of the edge;
executing an embedding model using the item description of the networked item corresponding to the network operation of the edge to generate an embedding representing the networked item; and
executing one or more models using the embedding representing the networked item and identifications of the source node of the edge and the destination node of the edge to generate the network operation risk score for the edge.

15. The system of claim 11, wherein receiving the network operation data for the new network operation of the entity comprises:
receiving the network operation data identifying the entity as a source of a transfer or a destination of the transfer of a second networked item;
generating the new edge attached to the node of the entity responsive to the network operation data identifying the entity as the source of the transfer or the destination of the transfer of the second networked item; and
triggering the updating of the composite network operation risk score of the entity responsive to determining the new edge is attached to the node of the entity.

16. The system of claim 11, wherein updating the composite network operation risk score comprises:
increasing or decreasing the composite network operation risk score by a weighted amount determined at least by a complementary node of the new edge opposite the node of the entity.

17. The system of claim 11, wherein the instructions also cause the system to:
responsive to determining the updated entity risk score for the entity exceeds the threshold, identify a set of nodes connected with the node of the entity by one or more edges; and
adjust entity risk scores for each node of the set of nodes based on the determining the updated entity risk score for the entity exceeds the threshold.

18. The system of claim 17, wherein adjusting the entity risk scores for each node of the set of nodes comprises, for each node of the set of nodes:
incrementing a counter for each edge between the compromised network node and the node of the set of nodes; and
adjusting the entity risk score for the node of the set of nodes by a weighted factor according to a count of the incremented counter.

19. A non-transitory computer-readable storage medium storing instructions that, when executed by one or more processors, cause the one or more processors to perform operations comprising:
identifying a node of a network graph data structure and associated with an entity, the network graph data structure storing a network of nodes and edges between the network of nodes digitally representing types of relationships between entities represented by the network of nodes;
identifying one or more attributes of the entity from the node of the entity in the network graph data structure;
identifying one or more edges between the node of the entity and one or more nodes connected with the node of the entity in the network graph data structure, each edge of the one or more edges comprising a network operation risk score;
aggregating the network operation risk score of each edge of the one or more edges to generate a composite network operation risk score;
executing a model using the one or more attributes of the entity and the composite network operation risk score to generate an entity risk score for the entity;
receiving network operation data for a new network operation of the entity;
generating, based on the network operation data, a new edge for the new network operation comprising a new network operation risk score for the new network operation;
responsive to generating the new edge for the new network operation, updating the composite network operation risk score based on the new network operation risk score;
re-executing the model using the one or more attributes of the entity and the updated composite network operation risk score to generate an updated entity risk score for the entity; and
responsive to determining the updated entity risk score for the entity exceeds a threshold, generating an alert identifying the node of the entity as a compromised network node.

20. The non-transitory computer-readable storage medium of claim 19, wherein the operations further comprise:
identifying a second new network operation involving the compromised network node; and
restricting the second new network operation responsive to the determining the updated entity risk score for the entity exceeds the threshold.
